(19) United States
(12) Patent Application Publication
(10) Pub. No.: US 2023/0028934 A1
(43) Pub. Date: Jan. 26, 2023

(54) METHODS AND DECENTRALIZED SYSTEMS THAT EMPLOY DISTRIBUTED MACHINE LEARNING TO AUTOMATICALLY INSTANTIATE AND MANAGE DISTRIBUTED APPLICATIONS

(71) Applicant: VMWARE, INC., Palo Alto, CA (US)

(72) Inventors: VAMSHIK SHETTY, Udupi (IN); Madan Mohan Singhal, Pune (IN); Seena Ann Sabu, Nagpur (IN)

(21) Appl. No.: 17/458,618

(22) Filed: Aug. 27, 2021

(30) Foreign Application Priority Data
Jul. 13, 2021 (IN) 202141031416

(51) Int. Cl. H04L 29/08; G06K 9/62; G06N 5/04; G06F 9/50

(52) U.S. Cl. CPC H04L 67/32; G06K 9/6262; G06N 5/045; G06F 9/5055

(57) ABSTRACT

The current document is directed to methods and systems that automatically instantiate complex distributed applications by deploying distributed-application instances across the computational resources of one or more distributed computer systems and that automatically manage instantiated distributed applications. Automatic deployment of multiple instances of a distributed application across computational resources, such as distribution of microservices of a microservice-based application across one or more distributed computer systems, and scaling of instantiated distributed applications are computationally difficult optimization problems that are not amenable to traditional centralized approaches. The current document discloses decentralized, distributed automated methods and systems that instantiate and manage distributed applications. Reinforcement-learning-based agents are installed within the computational resources of one or more distributed computer systems. Distributed-application instances are initially distributed to one or more agents. The agents then exchange distributed-application instances among themselves in order to locally optimize the set of distributed-application instances that they each manage.

### TECHNICAL FIELD

The current document is directed to distributed-computer-systems and, in particular, to methods and subsystems within distributed computer systems that automatically instantiate distributed applications by deploying distributed-application instances across computational resources and that manage instantiated distributed applications.

### BACKGROUND

During the past seven decades, electronic computing has evolved from primitive, vacuum-tube-based computer systems, initially developed during the 1940s, to modern electronic computing systems in which large numbers of multi-processor servers, work stations, and other individual computing systems are networked together with large-capacity data-storage devices and other electronic devices to produce geographically distributed computing systems with hundreds of thousands, millions, or more components that provide enormous computational bandwidths and data-storage capacities. These large, distributed computing systems are made possible by advances in computer networking, distributed operating systems and applications, data-storage appliances, computer hardware, and software technologies. The advent of distributed computer systems has provided a computational platform for increasingly complex distributed applications, including service-oriented applications. Distributed applications, including service-oriented applications and microservices-based applications, provide many advantages, including efficient scaling to respond to changes in workload, efficient functionality compartmentalization that, in turn, provides development and management efficiencies, flexible response to system component failures, straightforward incorporation of existing functionalities, and straightforward expansion of functionalities and interfaces with minimal interdependencies between different types of distributed-application instances. As new distributed-computing technologies are developed, and as general hardware and software technologies continue to advance, the current trend towards ever-larger and more complex distributed computing systems appears likely to continue well into the future.

As the complexity of distributed computing systems has increased, the management and administration of distributed computing systems and distributed applications has, in turn, become increasingly complex, involving greater computational overheads and significant inefficiencies and deficiencies. In fact, many desired management-and-administration functionalities are becoming sufficiently complex to render traditional approaches to the design and implementation of automated management and administration subsystems impractical, from a time and cost standpoint, and even from a feasibility standpoint. Therefore, designers and developers of distributed computer systems and distributed applications continue to seek new approaches to implementing automated management-and-administration facilities and functionalities.

### SUMMARY

The current document is directed to methods and systems that automatically instantiate complex distributed applications by deploying distributed-application instances across the computational resources of one or more distributed computer systems and that automatically manage instantiated distributed applications. Automatic deployment of multiple instances of a distributed application across computational resources, such as distribution of microservices of a microservice-based application across one or more distributed computer systems, and scaling of instantiated distributed applications are computationally difficult optimization problems that are not amenable to traditional centralized approaches. The current document discloses decentralized, distributed automated methods and systems that instantiate and manage distributed applications. Reinforcement-learning-based agents are installed within the computational resources of one or more distributed computer systems. Distributed-application instances are initially distributed to one or more agents. The agents then exchange distributed-application instances among themselves in order to locally optimize the set of distributed-application instances that they each manage.

### BRIEF DESCRIPTION OF THE DRAWINGS

FIG. 1 provides a general architectural diagram for various types of computers.

FIG. 2 illustrates an Internet-connected distributed computing system.

FIG. 3 illustrates cloud computing.

FIG. 4 illustrates generalized hardware and software components of a general-purpose computer system, such as a general-purpose computer system having an architecture similar to that shown in FIG. 1.

FIGS. 5A-D illustrate two types of virtual machine and virtual-machine execution environments.

FIG. 6 illustrates an OVF package.

FIG. 7 illustrates virtual data centers provided as an abstraction of underlying physical-data-center hardware components.

FIG. 8 illustrates virtual-machine components of a VI-management-server and physical servers of a physical data center above which a virtual-data-center interface is provided by the VI-management-server.

FIG. 9 illustrates a cloud-director level of abstraction.

FIG. 10 illustrates virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds.

FIG. 11 illustrates fundamental components of a feed-forward neural network.

FIG. 12 illustrates a small, example feed-forward neural network.

FIG. 13 provides a concise pseudocode illustration of the implementation of a simple feed-forward neural network.

FIG. 14 illustrates back propagation of errors through the neural network during training.

FIGS. 15A-B show the details of the weight-adjustment calculations carried out during back propagation.

FIG. 16A-B illustrate neural-network training as an example of machine-learning-based-subsystem training.

FIG. 17 illustrates two of many different types of neural networks.

FIG. 18 provides an illustration of the general characteristics and operation of a reinforcement-learning control system.

FIG. 19 illustrates certain details of one class of reinforcement-learning system.

FIG. 20 illustrates learning of a near-optimal or optimal policy by a reinforcement-learning agent.

FIG. 21 illustrates one type of reinforcement-learning system the falls within a class of reinforcement-learning systems referred to as “actor-critic” systems.

FIGS. 22A-G illustrate aspects of the problem domain addressed by the methods and systems disclosed in the current document.

FIG. 23 provides a control-flow diagram for a hypothetical optimal distributed-application instantiation method.

FIGS. 24A-B illustrates the number of possible mappings of m distributed-application instances to n computational resources.

FIGS. 25A-B illustrate a few the many different parameters, characteristics, and constraints that might need to be considered when deciding to which computational resource to deploy a particular distributed-application instance.

FIG. 26 provides a control-flow diagram that illustrates a rule-based approach to distributed-applications instantiation.

FIGS. 27A-B illustrates fundamental problems with the rule-based approach to distributed-application instantiation.

FIGS. 28A-G illustrates the general characteristics and operation of the currently disclosed distributed-application instantiation and management subsystem and methods incorporated within that system.

FIGS. 29A-B illustrate certain of the information maintained by the latent server with regard to an instantiated distributed application.

FIG. 30 provides an indication of one implementation of the latent-server component of the currently disclosed distributed-application instantiation and management subsystem.

FIGS. 31A-E provide control-flow diagrams that illustrate operational characteristics of the latent server.

FIG. 32 illustrates certain components of the agent supervisor.

FIGS. 33A-E provide control-flow diagrams that illustrate one implementation and operation of the agent supervisor.

FIG. 34 illustrates certain of the components of an agent.

FIGS. 35A-E provides control-flow diagrams that illustrate the implementation and operation of agents.

### DETAILED DESCRIPTION

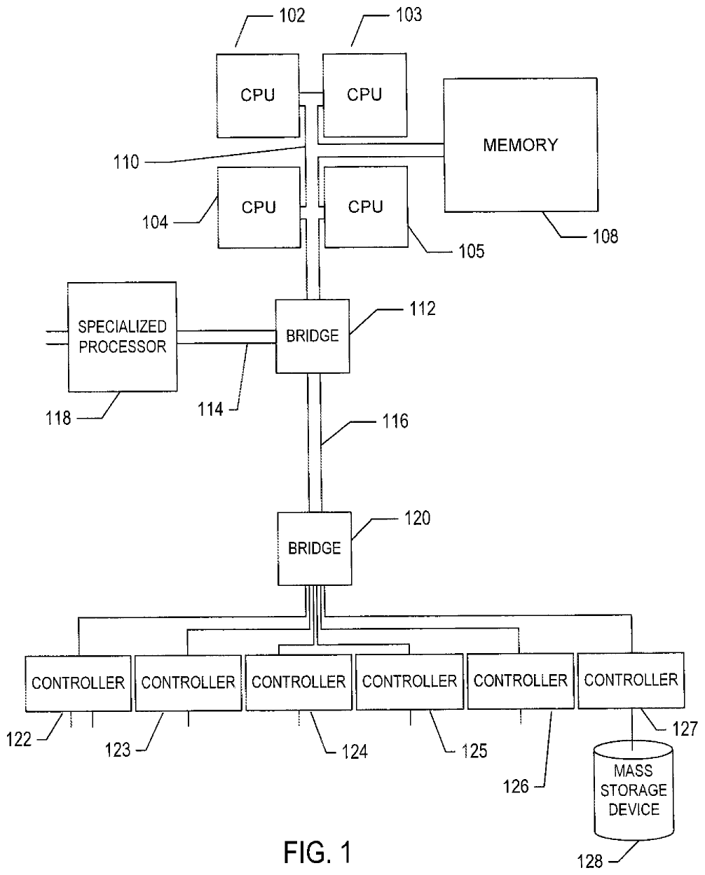

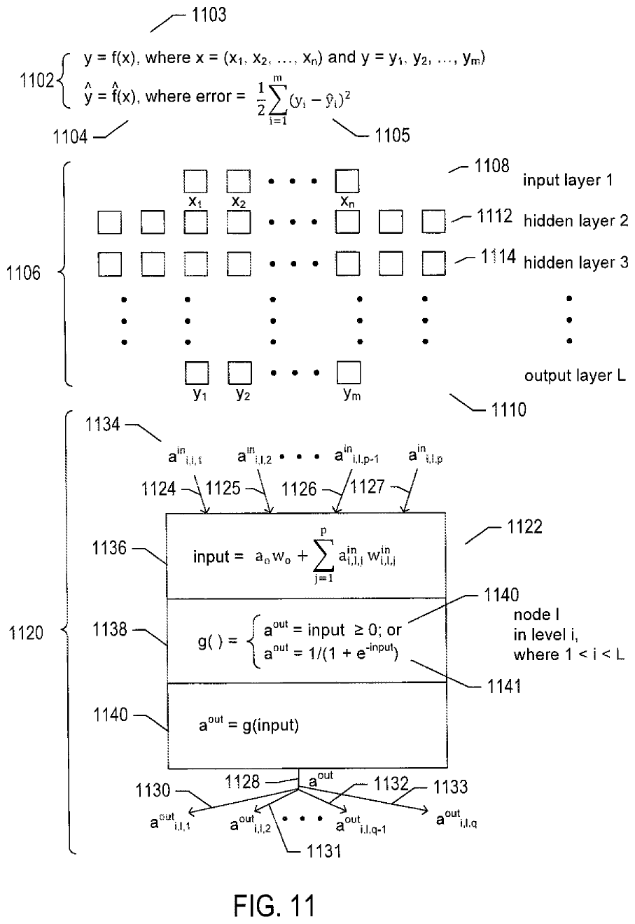

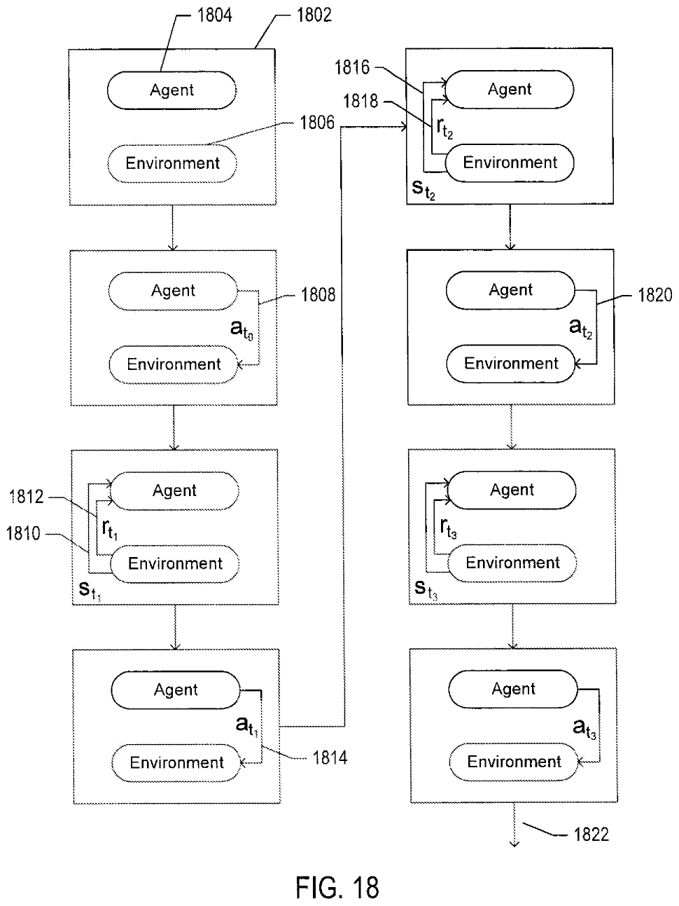

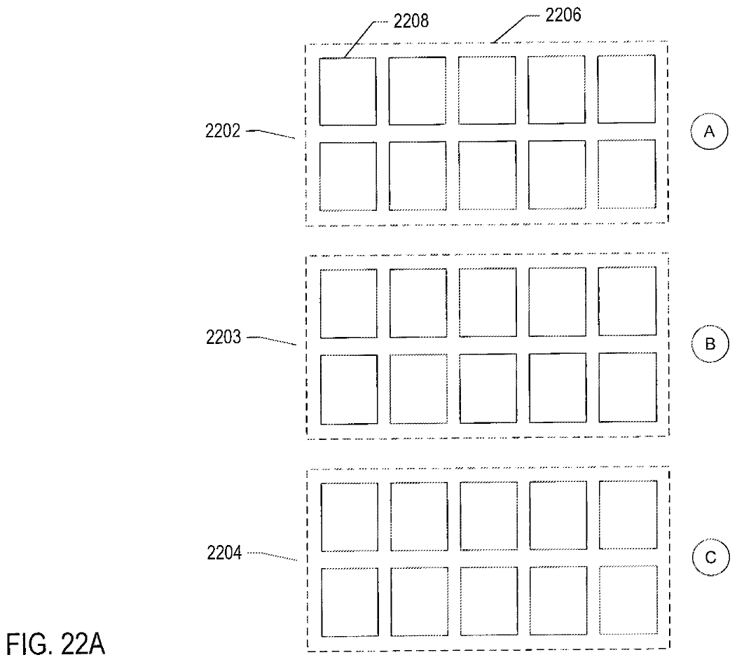

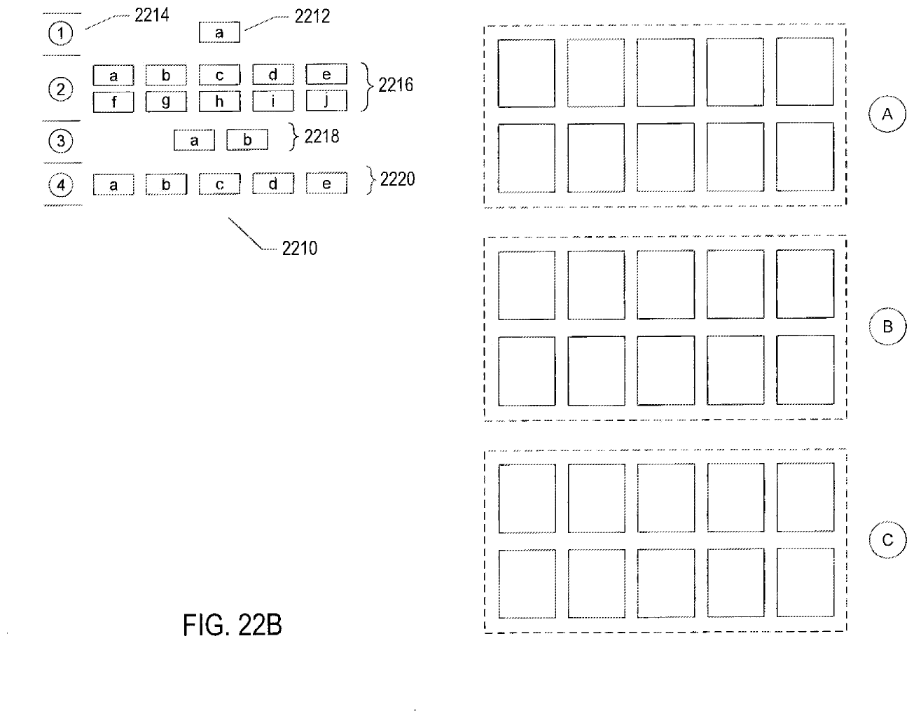

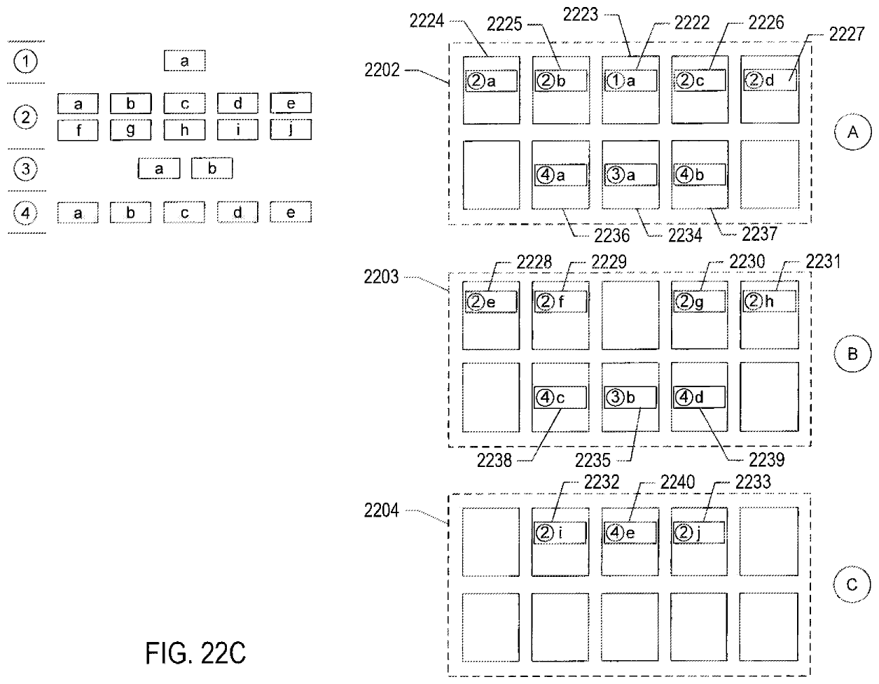

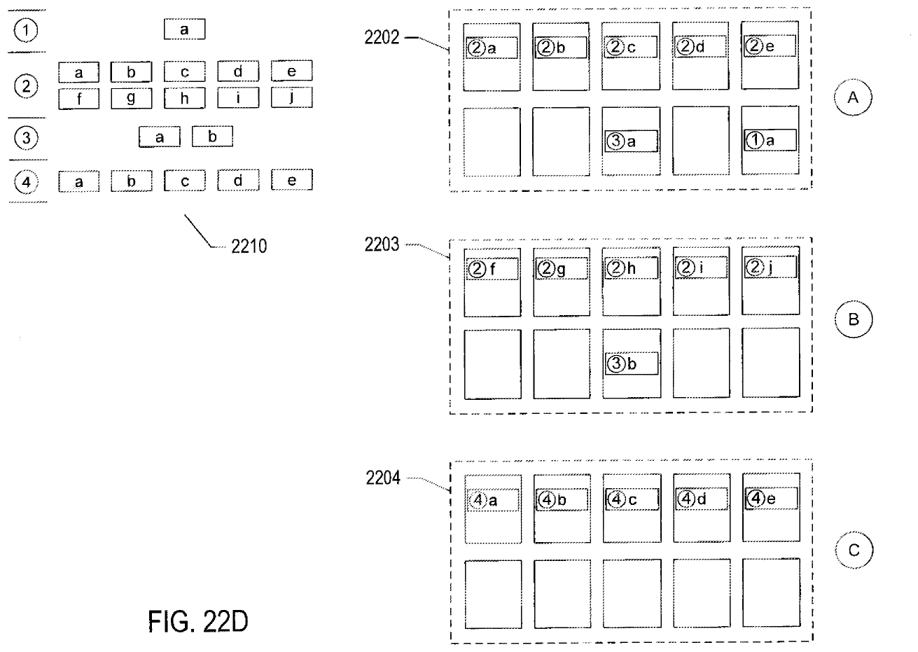

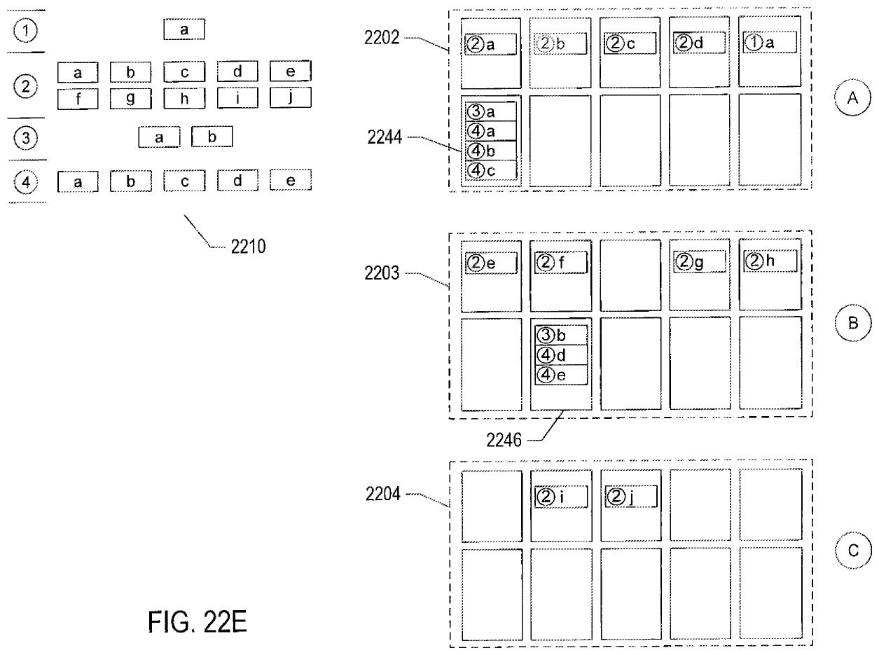

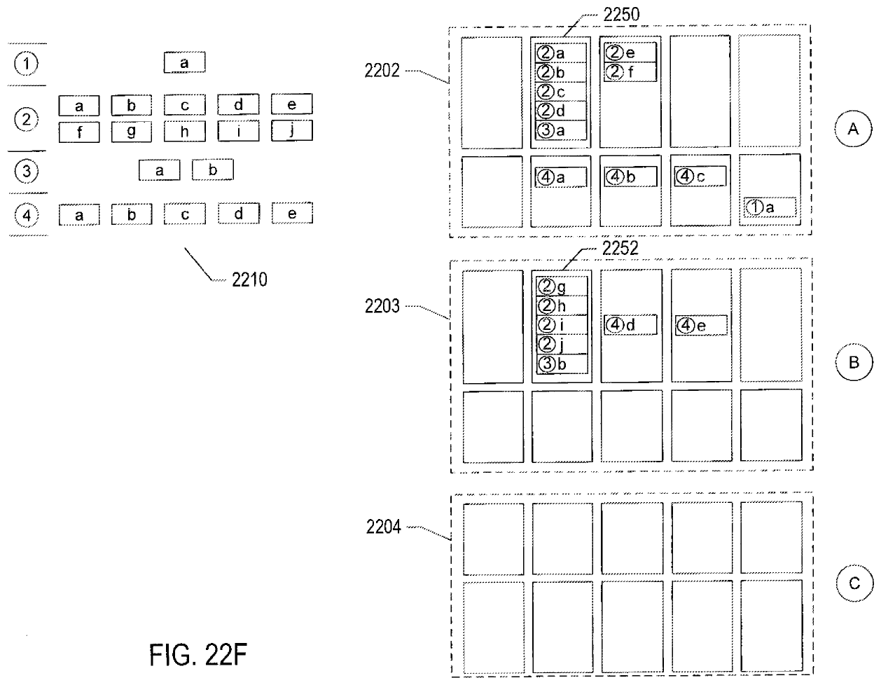

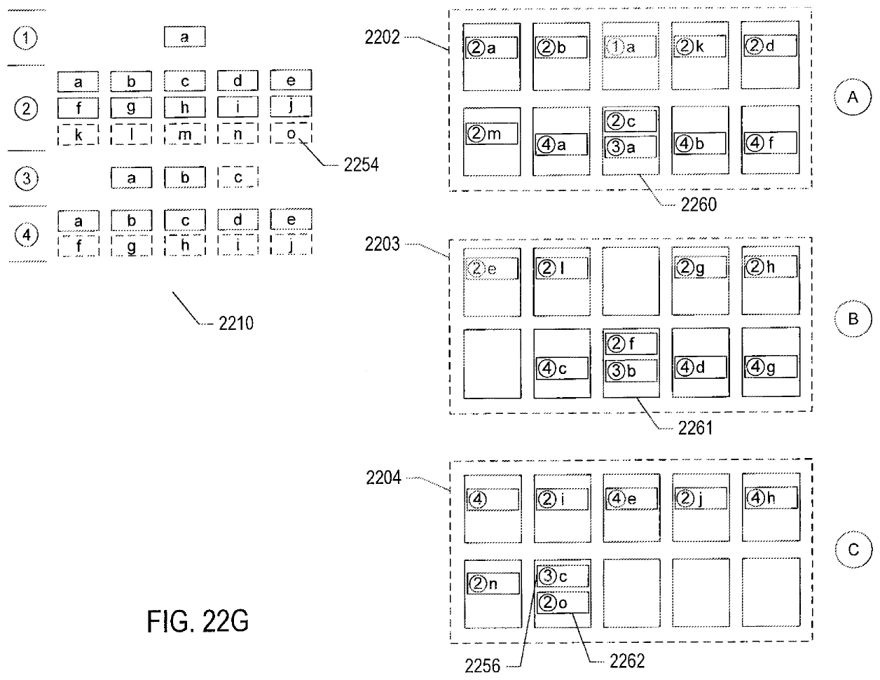

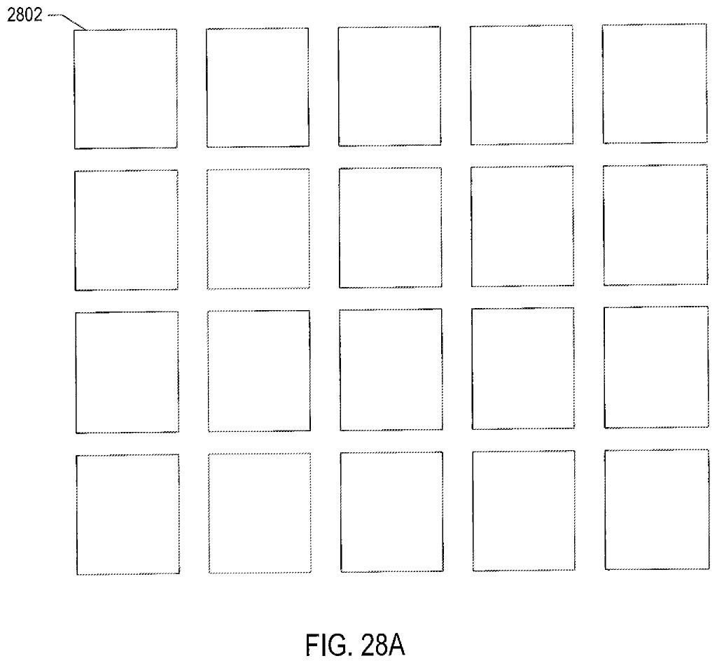

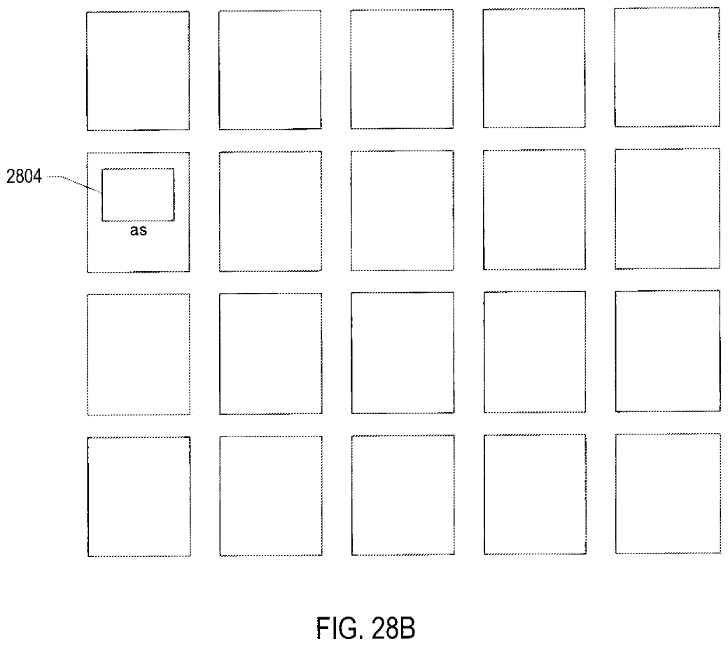

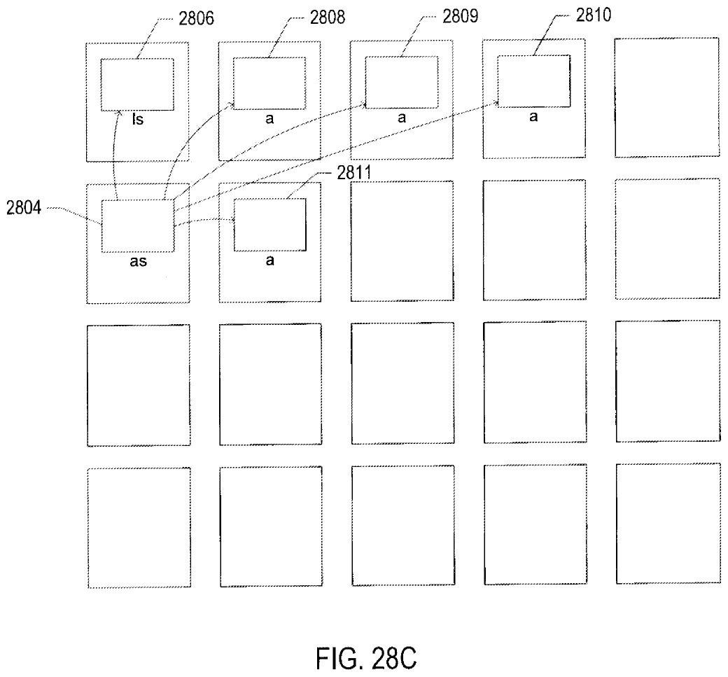

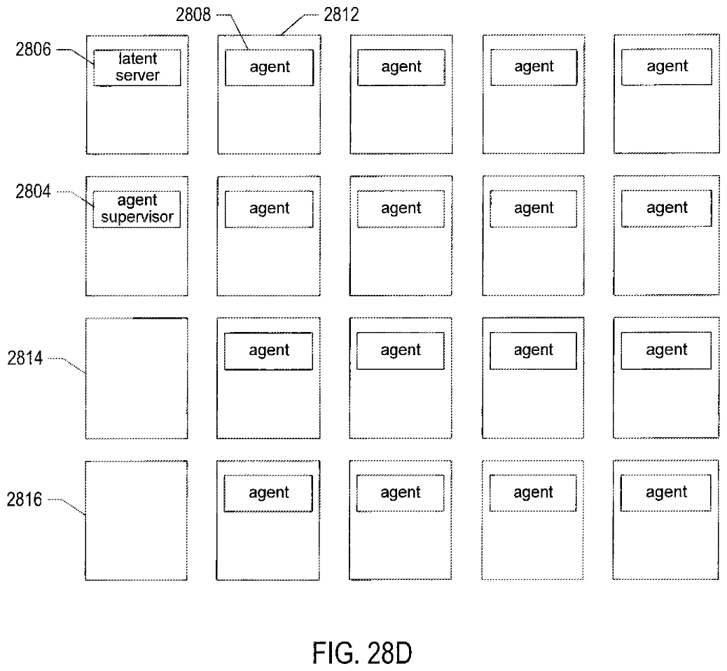

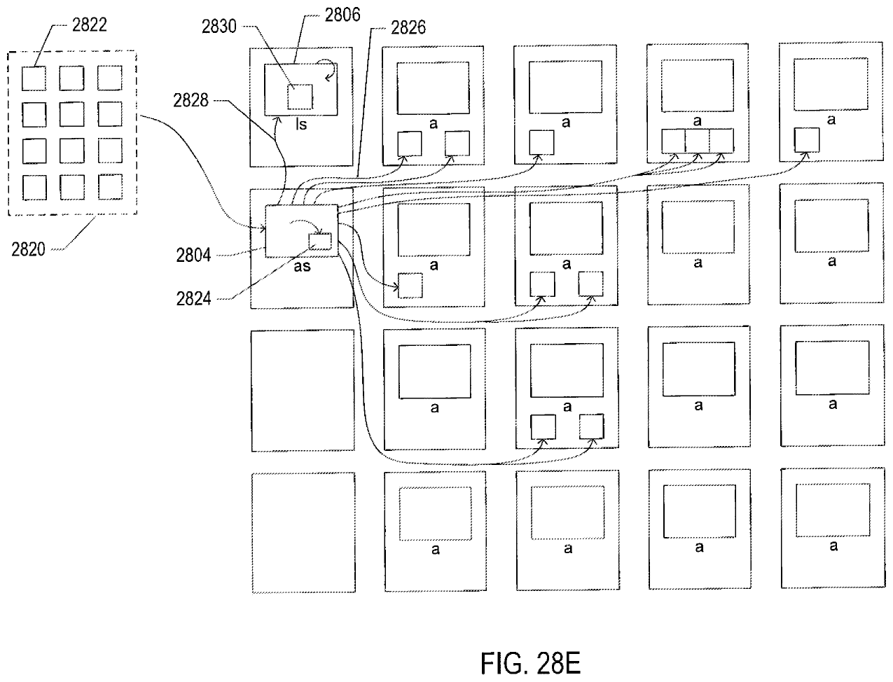

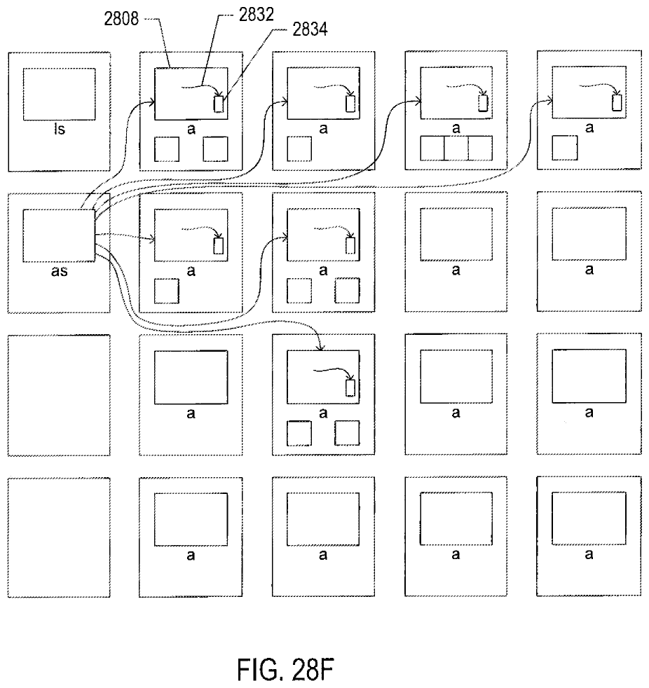

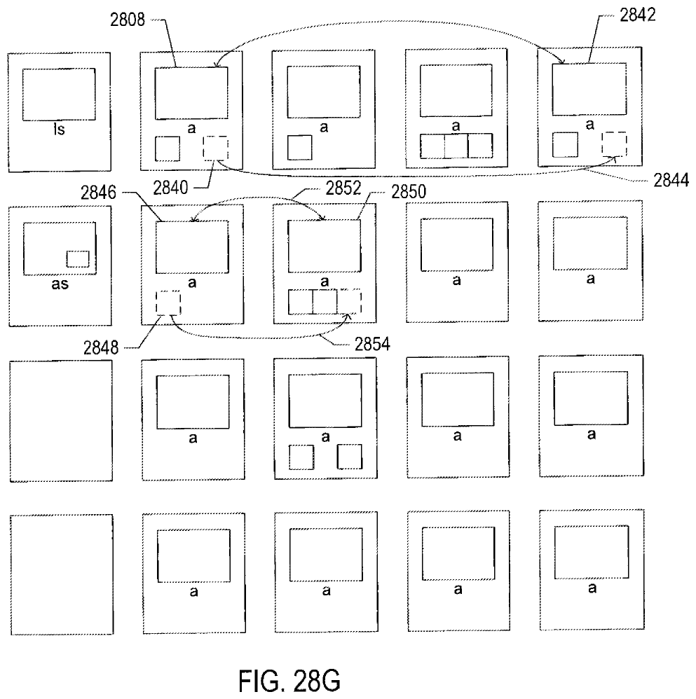

The current document is directed to methods and systems that automatically instantiate complex distributed applications by deploying distributed-application instances across the computational resources of one or more distributed computer systems and that automatically manage instantiated distributed applications. In a first subsection, below, a detailed description of computer hardware, complex computational systems, and virtualization is provided with reference to FIGS. 1-10. In a second subsection, neural networks are discussed with reference to FIGS. 11-17. In a third subsection, reinforcement-learning is discussed with reference to FIGS. 18-21. In a fourth subsection, problems with traditional approached to distributed-application instantiation and management are discussed with reference to FIGS. 22A-27B. Finally, in a fifth subsection, the currently disclosed methods and systems are discussed with reference to FIGS. 28A-35E.

### Computer Hardware, Complex Computational Systems, and Virtualization

The term “abstraction” is not, in any way, intended to mean or suggest an abstract idea or concept. Computational abstractions are tangible, physical interfaces that are implemented, ultimately, using physical computer hardware, data-storage devices, and communications systems. Instead, the term “abstraction” refers, in the current discussion, to a logical level of functionality encapsulated within one or more concrete, tangible, physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces. There is a tendency among those unfamiliar with modern technology and science to misinterpret the terms “abstract” and “abstraction,” when used to describe certain aspects of modern computing. For example, one frequently encounters assertions that, because a computational system is described in terms of abstractions, functional layers, and interfaces, the computational system is somehow different from a physical machine or device. Such allegations are unfounded. One only needs to disconnect a computer system or group of computer systems from their respective power supplies to appreciate the physical, machine nature of complex computer technologies. One also frequently encounters statements that characterize a computational technology as being “only software,” and thus not a machine or device. Software is essentially a sequence of encoded symbols, such as a printout of a computer program or digitally encoded computer instructions sequentially stored in a file on an optical disk or within an electromechanical mass-storage device. Software alone can do nothing. It is only when encoded computer instructions are loaded into an electronic memory within a computer system and executed on a physical processor that so-called “software implemented” functionality is provided. The digitally encoded computer instructions are an essential and physical control component of processor-controlled machines and devices, no less essential and physical than a cam-shaft control system in an internal-combustion engine. Multi-cloud aggregations, cloud-computing services, virtual-machine containers and virtual machines, communications interfaces, and many of the other topics discussed below are tangible, physical components of physical, electro-optical-mechanical computer systems.

FIG. 1 provides a general architectural diagram for various types of computers. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational resources. It should be noted that computer-readable data-storage devices include optical and electromagnetic disk, electronic memories, and other physical data-storage devices. Those familiar with modern science and technology appreciate that electromagnetic radiation and propagating signals do not store data for subsequent retrieval and can transiently “store” only a byte or less of information per mile, far less information than needed to encode even the simplest of routines.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of servers and workstations, and higher-end mainframe computers, but may also include a plethora of various types of special-purpose computing devices, including data-storage systems, communications routers, network nodes, tablet computers, and mobile telephones.

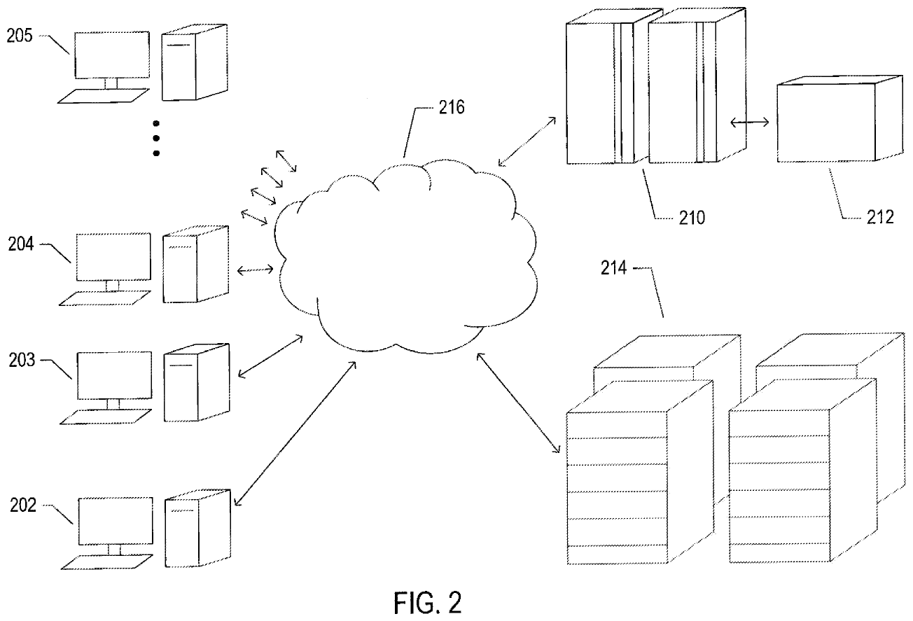

FIG. 2 illustrates an Internet-connected distributed computing system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted servers or blade servers all interconnected through various communications and networking systems that together comprise the Internet 216. Such distributed computing systems provide diverse arrays of functionalities. For example, a PC user sitting in a home office may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web servers, back-end computer systems, and data-storage systems for serving web pages to remote customers, receiving orders through the web-page interface, processing the orders, tracking completed orders, and other myriad different tasks associated with an e-commerce enterprise.

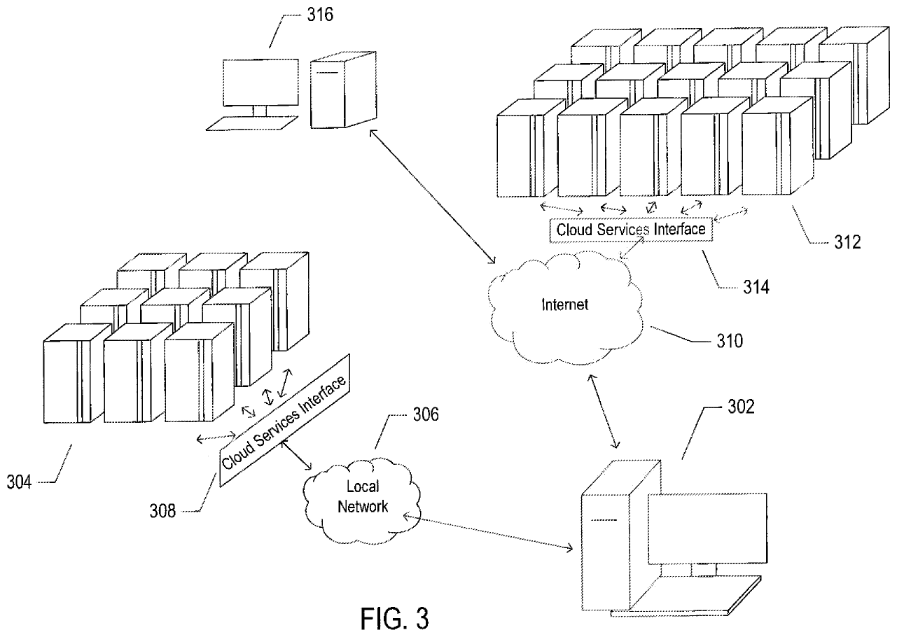

FIG. 3 illustrates cloud computing. In the recently developed cloud-computing paradigm, computing cycles and data-storage facilities are provided to organizations and individuals by cloud-computing providers. In addition, larger organizations may elect to establish private cloud-computing facilities. In addition to, or instead of, subscribing to computing services provided by public cloud-computing service providers. In FIG. 3, a system administrator for an organization, using a PC 302, accesses the organization's private cloud 304 through a local network 306 and private-cloud interface 308 and also accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the resources to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

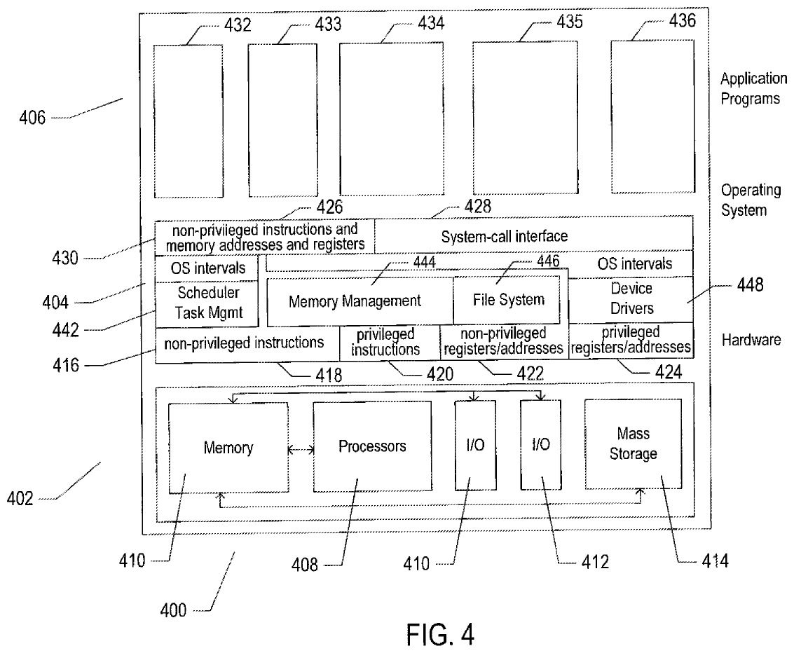

FIG. 4 illustrates generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor resources and other system resources with other application programs and higher-level computational entities. The device drivers abstract details of hardware-component operation, allowing application programs to employ the system-call interface for transmitting and receiving data to and from communications networks, mass-storage devices, and other 1/O devices and subsystems. The file system 436 facilitates abstraction of mass-storage-device and memory resources as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems and can therefore be executed within only a subset of the various different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computing system for high-availability, fault-tolerance, and load-balancing purposes. The problems are even greater in heterogeneous distributed computing systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

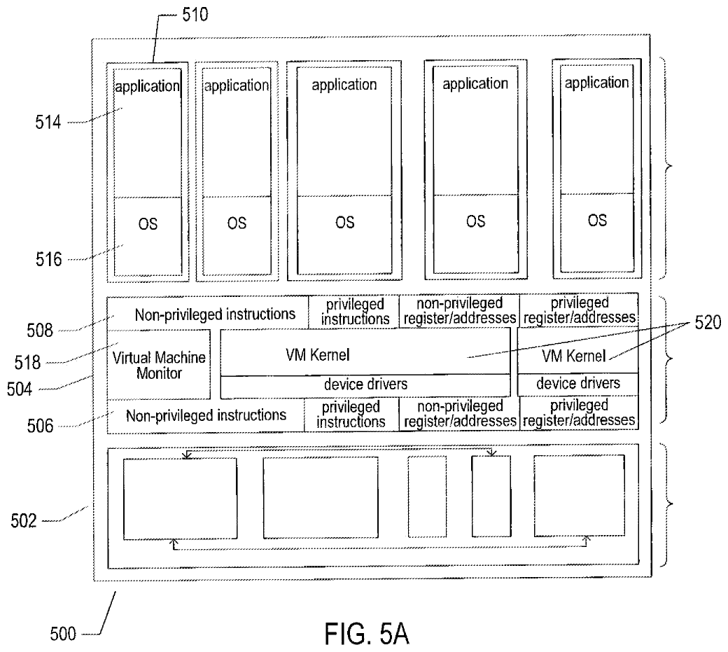

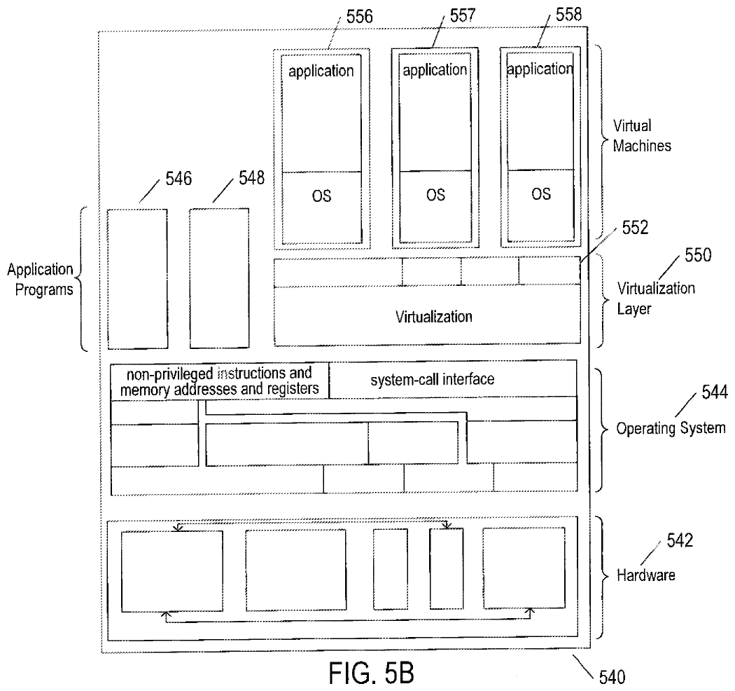

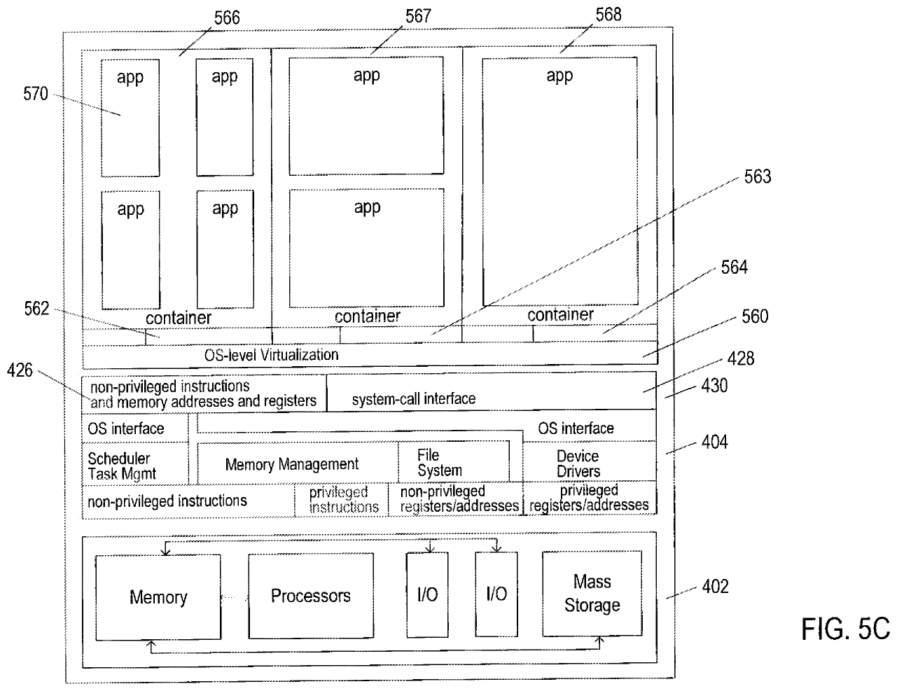

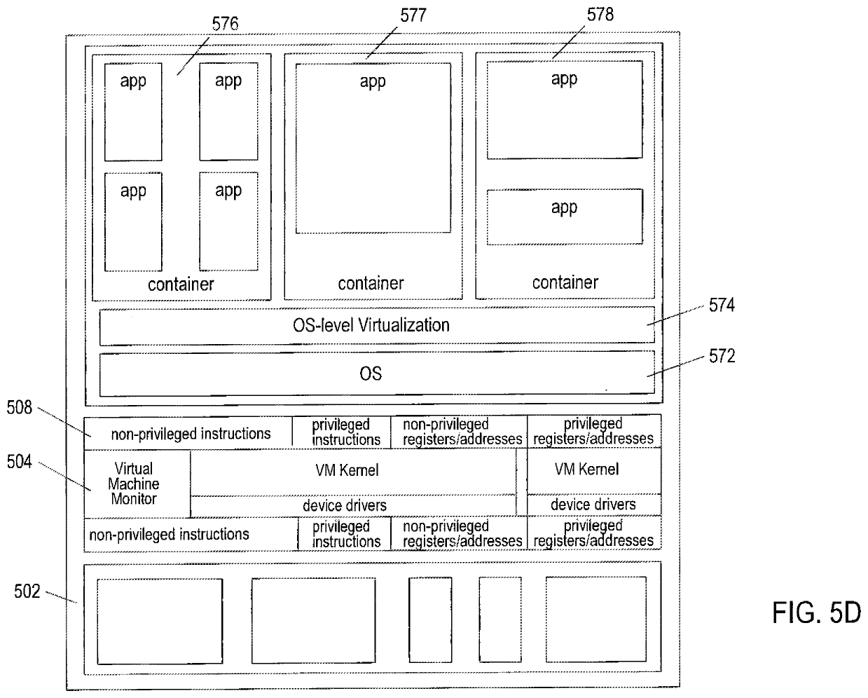

For all of these reasons, a higher level of abstraction, referred to as the “virtual machine,” has been developed and evolved to further abstract computer hardware in order to address many difficulties and challenges associated with traditional computing systems, including the compatibility issues discussed above. FIGS. 5A-D illustrate several types of virtual machine and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment illustrated in FIG. 5A features a virtualization layer 504 that interfaces through a virtualization-layer/hardware-layer interface 506, equivalent to interface 416 in FIG. 4, to the hardware. The virtualization layer provides a hardware-like interface 508 to a number of virtual machines, such as virtual machine 510, executing above the virtualization layer in a virtual-machine layer 512. Each virtual machine includes one or more application programs or other higher-level computational entities packaged together with an operating system, referred to as a “guest operating system,” such as application 514 and guest operating system 516 packaged together within virtual machine 510. Each virtual machine is thus equivalent to the operating-system layer 404 and application-program layer 406 in the general-purpose computer system shown in FIG. 4. Each guest operating system within a virtual machine interfaces to the virtualization-layer interface 508 rather than to the actual hardware interface 506. The virtualization layer partitions hardware resources into abstract virtual-hardware layers to which each guest operating system within a virtual machine interfaces. The guest operating systems within the virtual machines, in general, are unaware of the virtualization layer and operate as if they were directly accessing a true hardware interface. The virtualization layer ensures that each of the virtual machines currently executing within the virtual environment receive a fair allocation of underlying hardware resources and that all virtual machines receive sufficient resources to progress in execution. The virtualization-layer interface 508 may differ for different guest operating systems. For example, the virtualization layer is generally able to provide virtual hardware interfaces for a variety of different types of computer hardware. This allows, as one example, a virtual machine that includes a guest operating system designed for a particular computer architecture to run on hardware of a different architecture. The number virtual machines need not be equal to the number of physical processors or even a multiple of the number of processors.

The virtualization layer includes a virtual-machine-monitor module 518 (“VMM”) that virtualizes physical processors in the hardware layer to create virtual processors on which each of the virtual machines executes. For execution efficiency, the virtualization layer attempts to allow virtual machines to directly execute non-privileged instructions and to directly access non-privileged registers and memory. However, when the guest operating system within a virtual machine accesses virtual privileged instructions, virtual privileged registers, and virtual privileged memory through the virtualization-layer interface 508, the accesses result in execution of virtualization-layer code to simulate or emulate the privileged resources. The virtualization layer additionally includes a kernel module 520 that manages memory, communications, and data-storage machine resources on behalf of executing virtual machines (“VM kernel”). The VM kernel, for example, maintains shadow page tables on each virtual machine so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer essentially schedules execution of virtual machines much like an operating system schedules execution of application programs, so that the virtual machines each execute within a complete and fully functional virtual hardware layer.

FIG. 5B illustrates a second type of virtualization. In FIG. 5B, the computer system 540 includes the same hardware layer 542 and software layer 544 as the hardware layer 402 shown in FIG. 4. Several application programs 546 and 548 are shown running in the execution environment provided by the operating system. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The virtualization-layer/hardware-layer interface 552, equivalent to interface 416 in FIG. 4, provides an execution environment for a number of virtual machines 556-558, each including one or more application programs or other higher-level computational entities packaged together with a guest operating system.

While the traditional virtual-machine-based virtualization layers, described with reference to FIGS. 5A-B, have enjoyed widespread adoption and use in a variety of different environments, from personal computers to enormous distributed computing systems, traditional virtualization technologies are associated with computational overheads. While these computational overheads have been steadily decreased, over the years, and often represent ten percent or less of the total computational bandwidth consumed by an application running in a virtualized environment, traditional virtualization technologies nonetheless involve computational costs in return for the power and flexibility that they provide. Another approach to virtualization is referred to as operating-system-level virtualization (“OSL virtualization”). FIG. 5C illustrates the OSL-virtualization approach. In FIG. 5C, as in previously discussed FIG. 4, an operating system 404 runs above the hardware 402 of a host computer. The operating system provides an interface for higher-level computational entities, the interface including a system-call interface 428 and exposure to the non-privileged instructions and memory addresses and registers 426 of the hardware layer 402. However, unlike in FIG. 5A, rather than applications running directly above the operating system, OSL virtualization involves an OS-level virtualization layer 560 that provides an operating-system interface 562-564 to each of one or more containers 566-568. The containers, in turn, provide an execution environment for one or more applications, such as application 570 running within the execution environment provided by container 566. The container can be thought of as a partition of the resources generally available to higher-level computational entities through the operating system interface 430. While a traditional virtualization layer can simulate the hardware interface expected by any of many different operating systems, OSL virtualization essentially provides a secure partition of the execution environment provided by a particular operating system. As one example, OSL virtualization provides a file system to each container, but the file system provided to the container is essentially a view of a partition of the general file system provided by the underlying operating system. In essence, OSL virtualization uses operating-system features, such as name space support, to isolate each container from the remaining containers so that the applications executing within the execution environment provided by a container are isolated from applications executing within the execution environments provided by all other containers. As a result, a container can be booted up much faster than a virtual machine, since the container uses operating-system-kernel features that are already available within the host computer. Furthermore, the containers share computational bandwidth, memory, network bandwidth, and other computational resources provided by the operating system, without resource overhead allocated to virtual machines and virtualization layers. Again, however, OSL virtualization does not provide many desirable features of traditional virtualization. As mentioned above, OSL virtualization does not provide a way to run different types of operating systems for different groups of containers within the same host system, nor does OSL-virtualization provide for live migration of containers between host computers, as does traditional virtualization technologies.

FIG. 5D illustrates an approach to combining the power and flexibility of traditional virtualization with the advantages of OSL virtualization. FIG. 5D shows a host computer similar to that shown in FIG. 5A, discussed above. The host computer includes a hardware layer 502 and a virtualization layer 504 that provides a simulated hardware interface 508 to an operating system 572. Unlike in FIG. 5A, the operating system interfaces to an OSL-virtualization layer 574 that provides container execution environments 576-578 to multiple application programs. Running containers above a guest operating system within a virtualized host computer provides many of the advantages of traditional virtualization and OSL virtualization. Containers can be quickly booted in order to provide additional execution environments and associated resources to new applications. The resources available to the guest operating system are efficiently partitioned among the containers provided by the OSL-virtualization layer 574. Many of the powerful and flexible features of the traditional virtualization technology can be applied to containers running above guest operating systems including live migration from one host computer to another, various types of high-availability and distributed resource sharing, and other such features. Containers provide share-based allocation of computational resources to groups of applications with guaranteed isolation of applications in one container from applications in the remaining containers executing above a guest operating system. Moreover, resource allocation can be modified at run time between containers. The traditional virtualization layer provides flexible and easy scaling and a simple approach to operating-system upgrades and patches. Thus, the use of OSL virtualization above traditional virtualization, as illustrated in FIG. 5D, provides much of the advantages of both a traditional virtualization layer and the advantages of OSL virtualization. Note that, although only a single guest operating system and OSL virtualization layer as shown in FIG. 5D, a single virtualized host system can run multiple different guest operating systems within multiple virtual machines, each of which supports one or more containers.

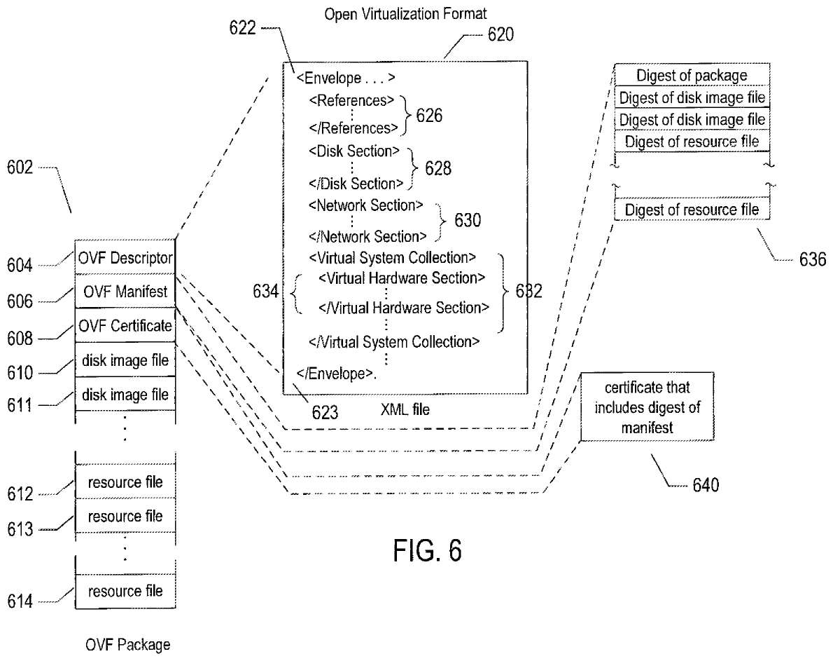

A virtual machine or virtual application, described below, is encapsulated within a data package for transmission, distribution, and loading into a virtual-execution environment. One public standard for virtual-machine encapsulation is referred to as the “open virtualization format” (“OVF”). The OVF standard specifies a format for digitally encoding a virtual machine within one or more data files. FIG. 6 illustrates an OVF package. An OVF package 602 includes an OVF descriptor 604, an OVF manifest 606, an OVF certificate 608. one or more disk-image files 610-611, and one or more resource files 612-614. The OVF package can be encoded and stored as a single file or as a set of files. The OVF descriptor 604 is an XML document 620 that includes a hierarchical set of elements, each demarcated by a beginning tag and an ending tag. The outermost, or highest-level, element is the envelope element, demarcated by tags 622 and 623. The next-level element includes a reference element 626 that includes references to all files that are part of the OVF package, a disk section 628 that contains meta information about all of the virtual disks included in the OVF package, a networks section 630 that includes meta information about all of the logical networks included in the OVF package, and a collection of virtual-machine configurations 632 which further includes hardware descriptions of each virtual machine 634. There are many additional hierarchical levels and elements within a typical OVF descriptor. The OVF descriptor is thus a self-describing XMI, file that describes the contents of an OVF package. The OVF manifest 606 is a list of cryptographic-hash-function-generated digests 636 of the entire OVF package and or the various components of the OVF package. The OVF certificate 608 is an authentication certificate 640 that includes a digest of the manifest and that is cryptographically signed. Disk image files, such as disk image file 610, are digital encodings of the contents of virtual disks and resource files 612 are digitally encoded content, such as operating-system images. A virtual machine or a collection of virtual machines encapsulated together within a virtual application can thus be digitally encoded as one or more files within an OVF package that can be transmitted, distributed, and loaded using well-known tools for transmitting, distributing, and loading files. A virtual appliance is a software service that is delivered as a complete software stack installed within one or more virtual machines that is encoded within an OVF package.

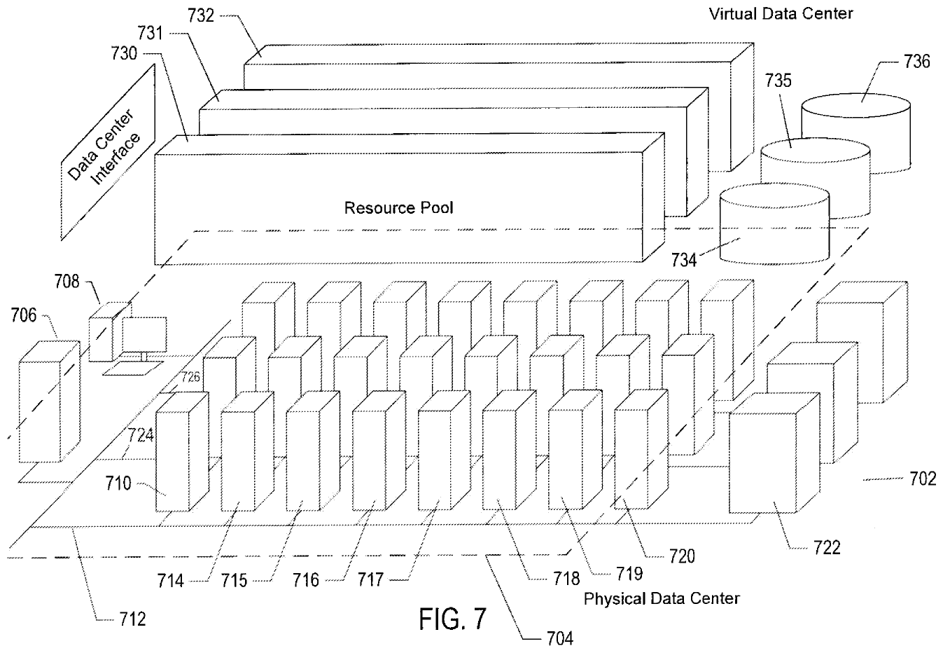

The advent of virtual machines and virtual environments has alleviated many of the difficulties and challenges associated with traditional general-purpose computing. Machine and operating-system dependencies can be significantly reduced or entirely eliminated by packaging applications and operating systems together as virtual machines and virtual appliances that execute within virtual environments provided by virtualization layers running on many different types of computer hardware. A next level of abstraction, referred to as virtual data centers which are one example of a broader virtual-infrastructure category, provide a data-center interface to virtual data centers computationally constructed within physical data centers. FIG. 7 illustrates virtual data centers provided as an abstraction of underlying physical-data-center hardware components. In FIG. 7, a physical data center 702 is shown below a virtual-interface plane 704. The physical data center consists of a virtual-infrastructure management server (“VI-management-server”) 706 and any of various different computers. such as PCs 708, on which a virtual-data-center management interface may be displayed to system administrators and other users. The physical data center additionally includes generally large numbers of server computers, such as server computer 710, that are coupled together by local area networks, such as local area network 712 that directly interconnects server computer 710 and 714-720 and a mass-storage array 722. The physical data center shown in FIG. 7 includes three local area networks 712, 724, and 726 that each directly interconnects a bank of eight servers and a mass-storage array. The individual server computers, such as server computer 710, each includes a virtualization layer and runs multiple virtual machines. Different physical data centers may include many different types of computers, networks, data-storage systems and devices connected according to many different types of connection topologies. The virtual-data-center abstraction layer 704, a logical abstraction layer shown by a plane in FIG. 7, abstracts the physical data center to a virtual data center comprising one or more resource pools, such as resource pools 730-732, one or more virtual data stores, such as virtual data stores 734-736, and one or more virtual networks. In certain implementations, the resource pools abstract banks of physical servers directly interconnected by a local area network.

The virtual-data-center management interface allows provisioning and launching of virtual machines with respect to resource pools, virtual data stores, and virtual networks, so that virtual-data-center administrators need not be concerned with the identities of physical-data-center components used to execute particular virtual machines. Furthermore, the VI-management-server includes functionality to migrate running virtual machines from one physical server to another in order to optimally or near optimally manage resource allocation, provide fault tolerance, and high availability by migrating virtual machines to most effectively utilize underlying physical hardware resources, to replace virtual machines disabled by physical hardware problems and failures, and to ensure that multiple virtual machines supporting a high-availability virtual appliance are executing on multiple physical computer systems so that the services provided by the virtual appliance are continuously accessible, even when one of the multiple virtual appliances becomes compute bound, data-access bound, suspends execution, or fails. Thus, the virtual data center layer of abstraction provides a virtual-data-center abstraction of physical data centers to simplify provisioning, launching, and maintenance of virtual machines and virtual appliances as well as to provide high-level, distributed functionalities that involve pooling the resources of individual physical servers and migrating virtual machines among physical servers to achieve load balancing, fault tolerance, and high availability.

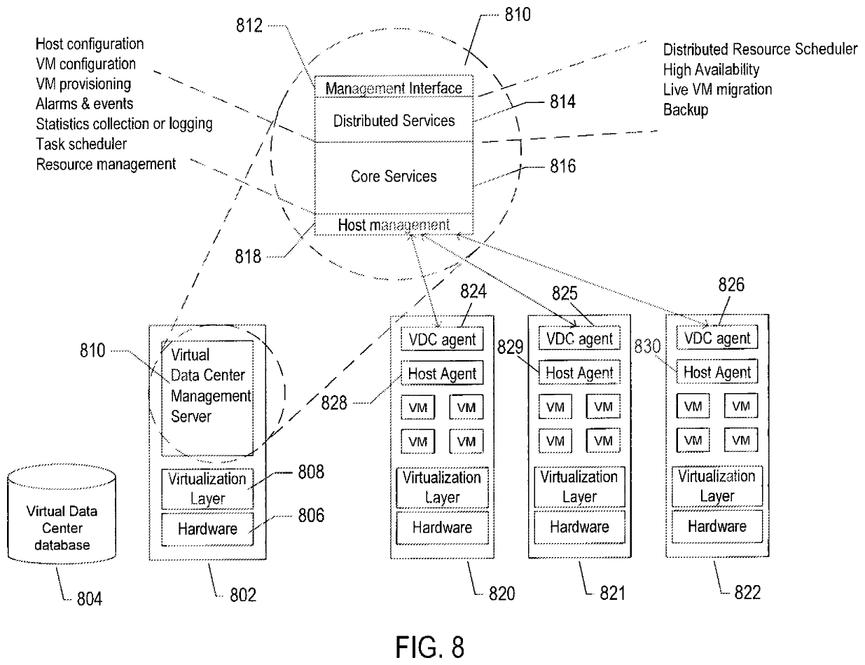

FIG. 8 illustrates virtual-machine components of a VI-management-server and physical servers of a physical data center above which a virtual-data-center interface is provided by the VI-management-server. The VI-management-server 802 and a virtual-data-center database 804 comprise the physical components of the management component of the virtual data center. The VI-management-server 802 includes a hardware layer 806 and virtualization layer 808 and runs a virtual-data-center management-server virtual machine 810 above the virtualization layer. Although shown as a single server in FIG. 8, the VI-management-server (“VI management server”) may include two or more physical server computers that support multiple VI-management-server virtual appliances. The virtual machine 810 includes a management-interface component 812, distributed services 814, core services 816, and a host-management interface 818. The management interface is accessed from any of various computers, such as the PC 708 shown in FIG. 7. The management interface allows the virtual-data-center administrator to configure a virtual data center, provision virtual machines, collect statistics and view log tiles for the virtual data center, and to carry out other, similar management tasks. The host-management interface 818 interfaces to virtual-data-center agents 824, 825, and 826 that execute as virtual machines within each of the physical servers of the physical data center that is abstracted to a virtual data center by the VI management server.

The distributed services 814 include a distributed-resource scheduler that assigns virtual machines to execute within particular physical servers and that migrates virtual machines in order to most effectively make use of computational bandwidths, data-storage capacities, and network capacities of the physical data center. The distributed services further include a high-availability service that replicates and migrates virtual machines in order to ensure that virtual machines continue to execute despite problems and failures experienced by physical hardware components. The distributed services also include a live-virtual-machine migration service that temporarily halts execution of a virtual machine, encapsulates the virtual machine in an OVF package, transmits the OVF package to a different physical server, and restarts the virtual machine on the different physical server from a virtual-machine state recorded when execution of the virtual machine was halted. The distributed services also include a distributed backup service that provides centralized virtual-machine backup and restore.

The core services provided by the VI management server include host configuration, virtual-machine configuration, virtual-machine provisioning, generation of virtual-data-center alarms and events, ongoing event logging and statistics collection, a task scheduler, and a resource-management module. Each physical server 820-822 also includes a host-agent virtual machine 828-830 through which the virtualization layer can be accessed via a virtual-infrastructure application programming interface (“API”). This interface allows a remote administrator or user to manage an individual server through the infrastructure API. The virtual-data-center agents 824-826 access virtualization-layer server information through the host agents. The virtual-data-center agents are primarily responsible for offloading certain of the virtual-data-center management-server functions specific to a particular physical server to that physical server. The virtual-data-center agents relay and enforce resource allocations made by the VI management server, relay virtual-machine provisioning and configuration-change commands to host agents, monitor and collect performance statistics, alarms, and events communicated to the virtual-data-center agents by the local host agents through the interface API, and to carry out other, similar virtual-data-management tasks.

The virtual-data-center abstraction provides a convenient and efficient level of abstraction for exposing the computational resources of a cloud-computing facility to cloud-computing-infrastructure users. A cloud-director management server exposes virtual resources of a cloud-computing facility to cloud-computing-infrastructure users. In addition, the cloud director introduces a multi-tenancy layer of abstraction, which partitions virtual data centers (“VDCs”) into tenant-associated VDCs that can each be allocated to a particular individual tenant or tenant organization, both referred to as a “tenant.” A given tenant can be provided one or more tenant-associated VDCs by a cloud director managing the multi-tenancy layer of abstraction within a cloud-computing facility. The cloud services interface (308 in FIG. 3) exposes a virtual-data-center management interface that abstracts the physical data center.

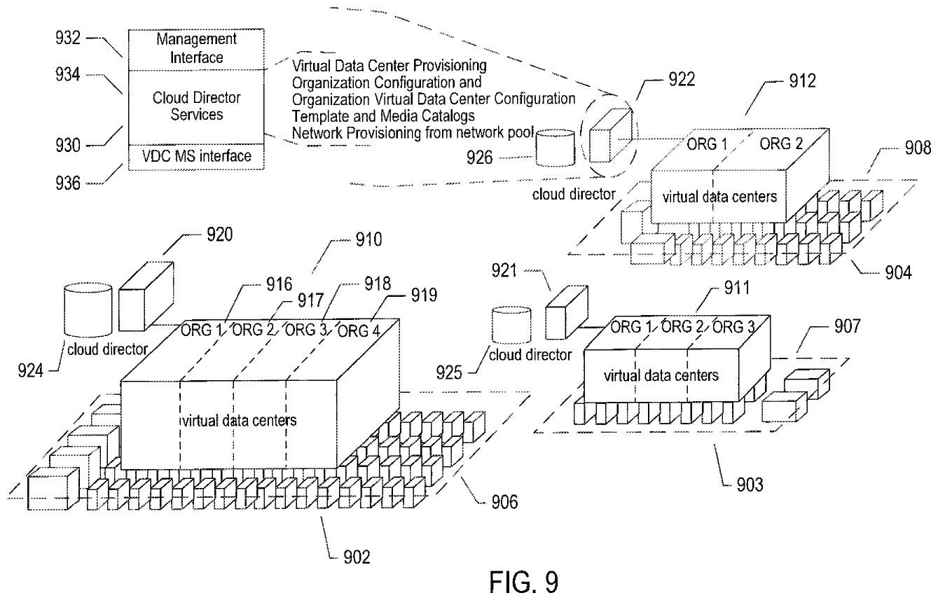

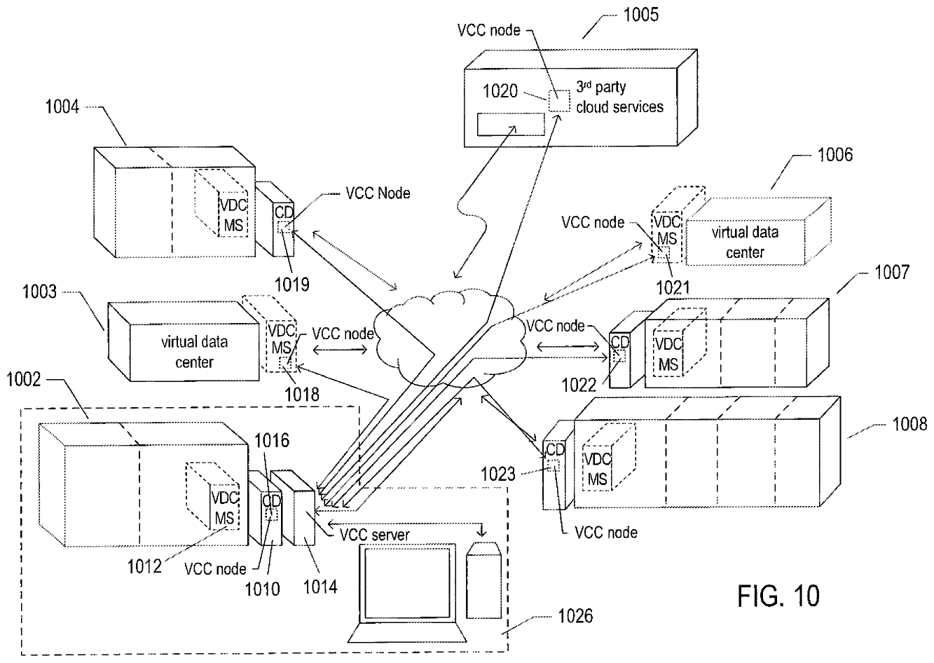

FIG. 9 illustrates a cloud-director level of abstraction. In FIG. 9, three different physical data centers 902-904 are shown below planes representing the cloud-director layer of abstraction 906-908. Above the planes representing the cloud-director level of abstraction, multi-tenant virtual data centers 910-912 are shown. The resources of these multi-tenant virtual data centers are securely partitioned in order to provide secure virtual data centers to multiple tenants, or cloud-services-accessing organizations. For example, a cloud-services-provider virtual data center 910 is partitioned into four different tenant-associated virtual-data centers within a multi-tenant virtual data center for four different tenants 916-919. Each multi-tenant, virtual data center is managed by a cloud director comprising one or more cloud-director servers 920-922 and associated cloud-director databases 924-926. Each cloud-director server or servers runs a cloud-director virtual appliance 930 that includes a cloud-director management interface 932, a set of cloud-director services 934, and a virtual-data-center management-server interface 936. The cloud-director services include an interface and tools for provisioning multi-tenant virtual data center virtual data centers on behalf of tenants, tools and interfaces for configuring and managing tenant organizations, tools and services for organization of virtual data centers and tenant-associated virtual data centers within the multi-tenant virtual data center, services associated with template and media catalogs, and provisioning of virtualization networks from a network pool. Templates are virtual machines that each contains an OS and/or one or more virtual machines containing applications. A template may include much of the detailed contents of virtual machines and virtual appliances that are encoded within OVF packages, so that the task of configuring a virtual machine or virtual appliance is significantly simplified, requiring only deployment of one OVF package. These templates are stored in catalogs within a tenant's virtual-data center. These catalogs are used for developing and staging new virtual appliances and published catalogs are used for sharing templates in virtual appliances across organizations. Catalogs may include OS images and other information relevant to construction, distribution, and provisioning of virtual appliances.

Considering FIGS. 7 and 9, the VI management server and cloud-director layers of abstraction can be seen, as discussed above, to facilitate employment of the virtual-data-center concept within private and public clouds. However, this level of abstraction does not fully facilitate aggregation of single-tenant and multi-tenant virtual data centers into heterogeneous or homogeneous aggregations of cloud-computing facilities.

FIG. 10 illustrates virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds. VMware vCloud™ VCC servers and nodes are one example of VCC server and nodes. In FIG. 10, seven different cloud-computing facilities are illustrated 1002-1008. Cloud-computing facility 1002 is a private multi-tenant cloud with a cloud director 1010 that interfaces to a VI management server 1012 to provide a multi-tenant private cloud comprising multiple tenant-associated virtual data centers. The remaining cloud-computing facilities 1003-1008 may be either public or private cloud-computing facilities and may be single-tenant virtual data centers, such as virtual data centers 1003 and 1006, multi-tenant virtual data centers, such as multi-tenant virtual data centers 1004 and 1007-1008, or any of various different kinds of third-party cloud-services facilities, such as third-party cloud-services facility 1005. An additional component, the VCC server 1014, acting as a controller is included in the private cloud-computing facility 1002 and interfaces to a VCC node 1016 that runs as a virtual appliance within the cloud director 1010. A VCC server may also run as a virtual appliance within a VI management server that manages a single-tenant private cloud. The VCC server 1014 additionally interfaces, through the Internet, VCC node virtual appliances executing within remote VI management servers, remote cloud directors, or within the third-party cloud services 1018-1023. The VCC server provides a VCC server interface that can be displayed on a local or remote terminal, PC, or other computer system 1026 to allow a cloud-aggregation administrator or other user to access VCC-server-provided aggregate-cloud distributed services. In general, the cloud-computing facilities that together form a multiple-cloud-computing aggregation through distributed services provided by the VCC server and VCC nodes are geographically and operationally distinct.

### Neural Networks

FIG. 11 illustrates fundamental components of a feed-forward neural network. Equations 1102 mathematically represents ideal operation of a neural network as a function ƒ(x). The function receives an input vector x and outputs a corresponding output vector y 1103. For example, an input vector may be a digital image represented by a two-dimensional array of pixel values in an electronic document or may be an ordered set of numeric or alphanumeric values. Similarly, the output vector may be, for example, an altered digital image, an ordered set of one or more numeric or alphanumeric values, an electronic document, or one or more numeric values. The initial expression 1103 represents the ideal operation of the neural network. In other words, the output vectors y represent the ideal, or desired, output for corresponding input vector x. However, in actual operation, a physically implemented neural network \hat{ƒ}(x), as represented by expressions 1104, returns a physically generated output vector ŷ that may differ from the ideal or desired output vector y. As shown in the second expression 1105 within expressions 1104, an output vector produced by the physically implemented neural network is associated with an error or loss value. A common error or loss value is the square of the distance between the two points represented by the ideal output vector and the output vector produced by the neural network. To simplify back-propagation computations, discussed below, the square of the distance is often divided by 2. As further discussed below, the distance between the two points represented by the ideal output vector and the output vector produced by the neural network, with optional scaling, may also be used as the error or loss. A neural network is trained using a training dataset comprising input-vector/ideal-output-vector pairs, generally obtained by human or human-assisted assignment of ideal-output vectors to selected input vectors. The ideal-output vectors in the training dataset are often referred to as “labels.” During training, the error associated with each output vector, produced by the neural network in response to input to the neural network of a training-dataset input vector, is used to adjust internal weights within the neural network in order to minimize the error or loss. Thus, the accuracy and reliability of a trained neural network is highly dependent on the accuracy and completeness of the training dataset.

As shown in the middle portion 1106 of FIG. 11, a feed-forward neural network generally consists of layers of nodes, including an input layer 1108, an output layer 1110, and one or more hidden layers 1112 and 1114. These layers can be numerically labeled 1, 2, 3, . . . , L, as shown in FIG. 11. In general, the input layer contains a node for each element of the input vector and the output layer contains one node for each element of the output vector. The input layer and/or output layer may have one or more nodes. In the following discussion, the nodes of a first level with a numeric label lower in value than that of a second layer are referred to as being higher-level nodes with respect to the nodes of the second layer. The input-layer nodes are thus the highest-level nodes. The nodes are interconnected to form a graph.

The lower portion of FIG. 11 (1120 in FIG. 11) illustrates a feed-forward neural-network node. The neural-network node 1122 receives inputs 1124-1127 from one or more next-higher-level nodes and generates an output 1128 that is distributed to one or more next-lower-level nodes 1130-1133. The inputs and outputs are referred to as “activations,” represented by superscripted-and-subscripted symbols “a” in FIG. 11, such as the activation symbol 1134. An input component 1136 within a node collects the input activations and generates a weighted sum of these input activations to which a weighted internal activation a₀ is added. An activation component 1138 within the node is represented by a function g( ), referred to as an “activation function,” that is used in an output component 1140 of the node to generate the output activation of the node based on the input collected by the input component 1136. The neural-network node 1122 represents a generic hidden-layer node. Input-layer nodes lack the input component 1136 and each receive a single input value representing an element of an input vector. Output-component nodes output a single value representing an element of the output vector. The values of the weights used to generate the cumulative input by the input component 1136 are determined by training, as previously mentioned. In general, the input, outputs, and activation function are predetermined and constant, although, in certain types of neural networks, these may also be at least partly adjustable parameters. In FIG. 11, two different possible activation functions are indicated by expressions 1140 and 1141. The latter expression represents a sigmoidal relationship between input and output that is commonly used in neural networks and other types of machine-learning systems.

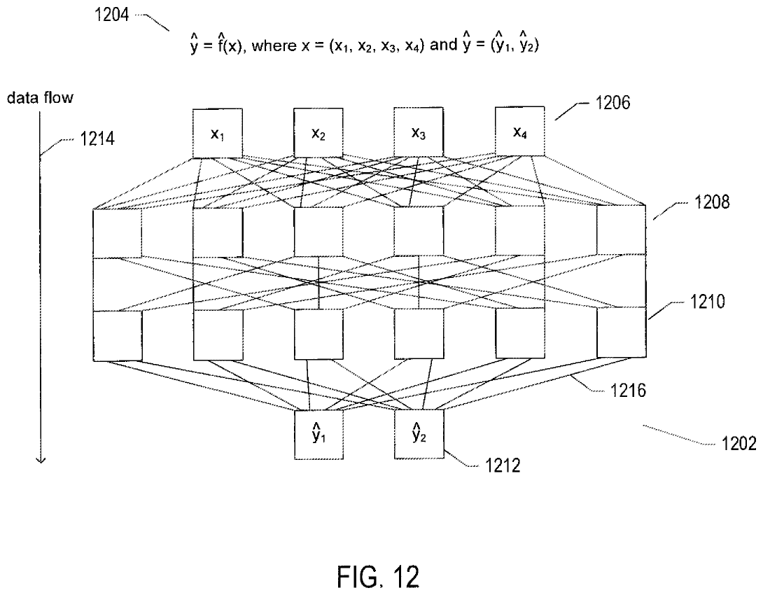

FIG. 12 illustrates a small, example feed-forward neural network, illustrates a small, example feed-forward neural network. The example neural network 1202 is mathematically represented by expression 1204. It includes an input layer of four nodes 1206, a first hidden layer 1208 of six nodes, a second hidden layer 1210 of six nodes, and an output layer 1212 of two nodes. As indicated by directed arrow 1214, data input to the input-layer nodes 1206 flows downward through the neural network to produce the final values output by the output nodes in the output layer 1212. The line segments, such as line segment 1216, interconnecting the nodes in the neural network 1202 indicate communications paths along which activations are transmitted from higher-level nodes to lower-level nodes. In the example feed-forward neural network, the nodes of the input layer 1206 are fully connected to the nodes of the first hidden layer 1208, but the nodes of the first hidden layer 1208 are only sparsely connected with the nodes of the second hidden layer 1210. Various different types of neural networks may use different numbers of layers, different numbers of nodes in each of the layers, and different patterns of connections between the nodes of each layer to the nodes in preceding and succeeding layers.

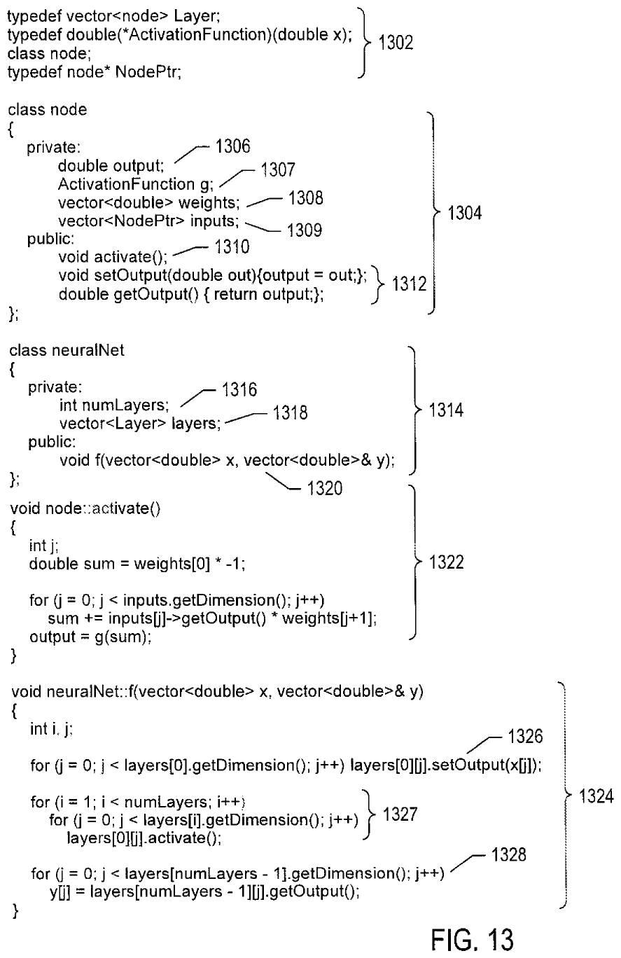

FIG. 13 provides a concise pseudocoele illustration of the implementation of a simple feed-forward neural network. Three initial type definitions 1302 provide types for layers of nodes, pointers to activation functions, and pointers to nodes. The class node 1304 represents a neural-network node. Each node includes the following data members: (1) output 1306, the output activation value for the node; (2) g 1307, a pointer to the activation function for the node; (3) weights 1308, the weights associated with the inputs; and (4) inputs 1309. pointers to the higher-level nodes from which the node receives activations. Each node provides an activate member function 1310 that generates the activation for the node, which is stored in the data member output, and a pair of member functions 1312 for setting and getting the value stored in the data member output. The class neuralNet 1314 represents an entire neural network. The neural network includes data members that store the number of layers 1316 and a vector of node-vector layers 1318, each node-vector layer representing a layer of nodes within the neural network. The single member function f 1320 of the class neuralNet generates an output vector y for an input vector x. An implementation of the member function activate for the node class is next provided 1322. This corresponds to the expression shown for the input component 1136 in FIG. 11. Finally, an implementation for the member function ƒ 1324 of the neuralNet class is provided. In a first for-loop 1326, an element of the input vector is input to each of the input-layer nodes. In a pair of nested for-loops 1327, the activate function for each hidden-layer and output-layer node in the neural network is called, starting from the highest hidden layer and proceeding layer-by-layer to the output layer. In a final for-loop 1328, the activation values of the output-layer nodes are collected into the output vector y.

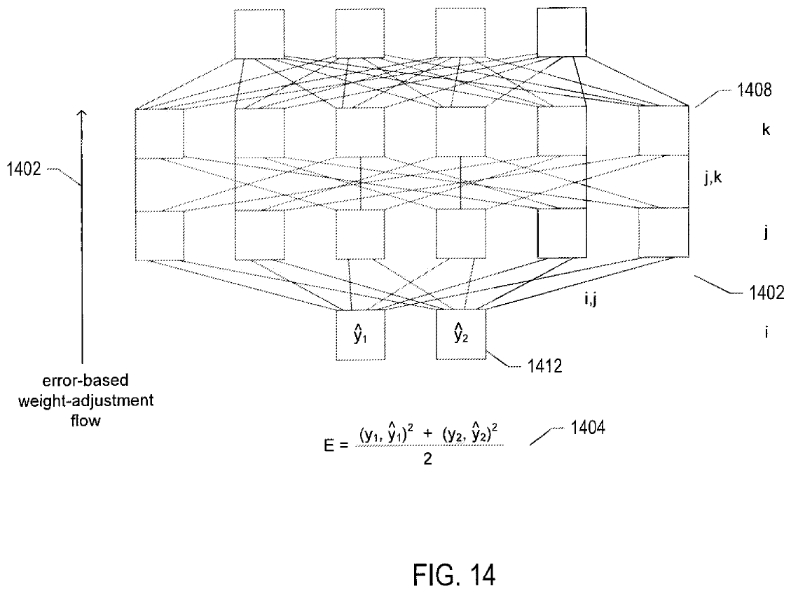

FIG. 14 illustrates back propagation of errors through the neural network during training. As indicated by directed arrow 1402, the error-based weight adjustment flows upward from the output-layer nodes 1212 to the highest-level hidden-layer nodes 1208. For the example neural network 1202, the error, or loss, is computed according to expression 1404. This loss is propagated upward through the connections between nodes in a process that proceeds in an opposite direction from the direction of activation transmission during generation of the output vector from the input vector. The back-propagation process determines, for each activation passed from one node to another, the value of the partial differential of the error, or loss, with respect to the weight associated with the activation. This value is then used to adjust the weight in order to minimize the error, or loss.

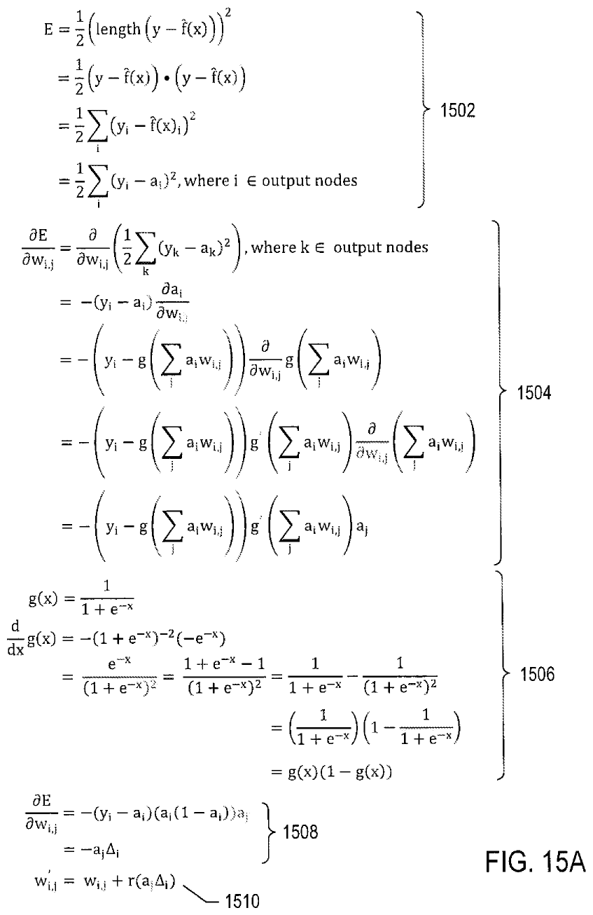

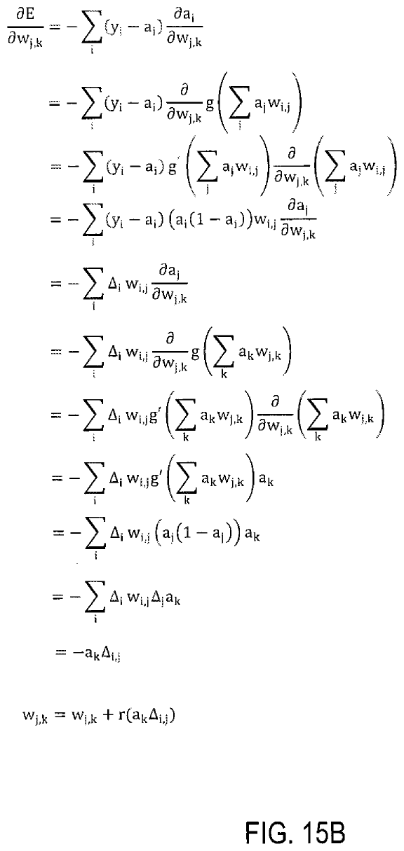

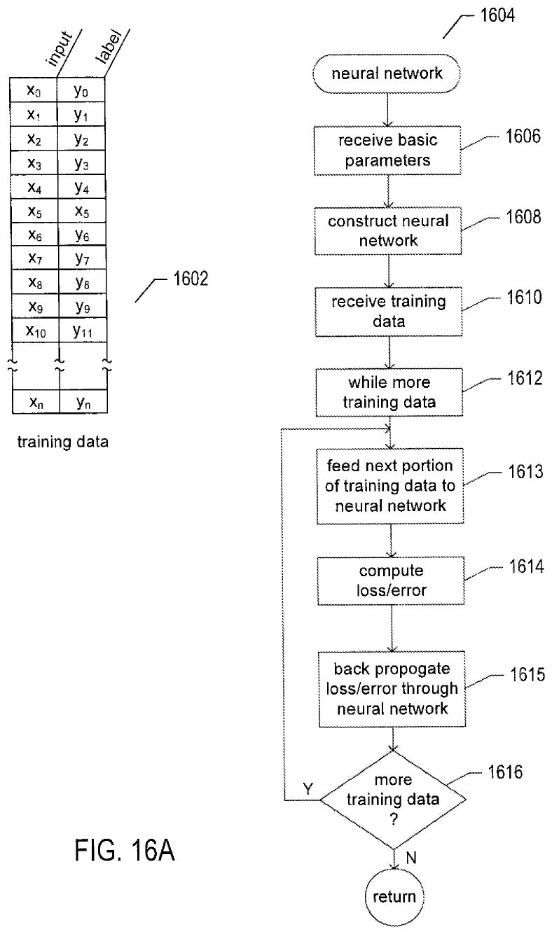

FIGS. 5A-B show the details of the weight-adjustment calculations carried out during back propagation. FIGS. 15A-B show the details of the weight-adjustment calculations carried out during back propagation. An expression for the total error, or loss, E with respect to an input-vector/label pair within a training dataset is obtained in a first set of expressions 1502, which is one half the squared distance between the points in a multidimensional space represented by the ideal output and the output vector generated by the neural network. The partial differential of the total error E with respect to a particular weight wᵢⱼ for the j^{th} input of an output node i is obtained by the set of expressions 1504. In these expressions, the partial differential operator is propagated rightward through the expression for the total error E. An expression for the derivative of the activation function with respect to the input x produced by the input component of a node is obtained by the set of expressions 1506. This allows for generation of a simplified expression for the partial derivative of the total energy E with respect to the weight associated with the j^{th} input of the i^{th} output node 1508. The weight adjustment based on the total error E is provided by expression 1510, in which r has a real value in the range [0-1] that represents a learning rate, aⱼ is the activation received through input j by node i, and Δᵢ is the product of parenthesized terms, which include aᵢ and yᵢ, in the first expression in expressions 1508 that multiplies aⱼ. FIG. 15B provides a derivation of the weight adjustment for the hidden-layer nodes above the output layer. It should be noted that the computational overhead for calculating the weights for each next highest layer of nodes increases geometrically, as indicated by the increasing number of subscripts for the δ multipliers in the weight-adjustment expressions.

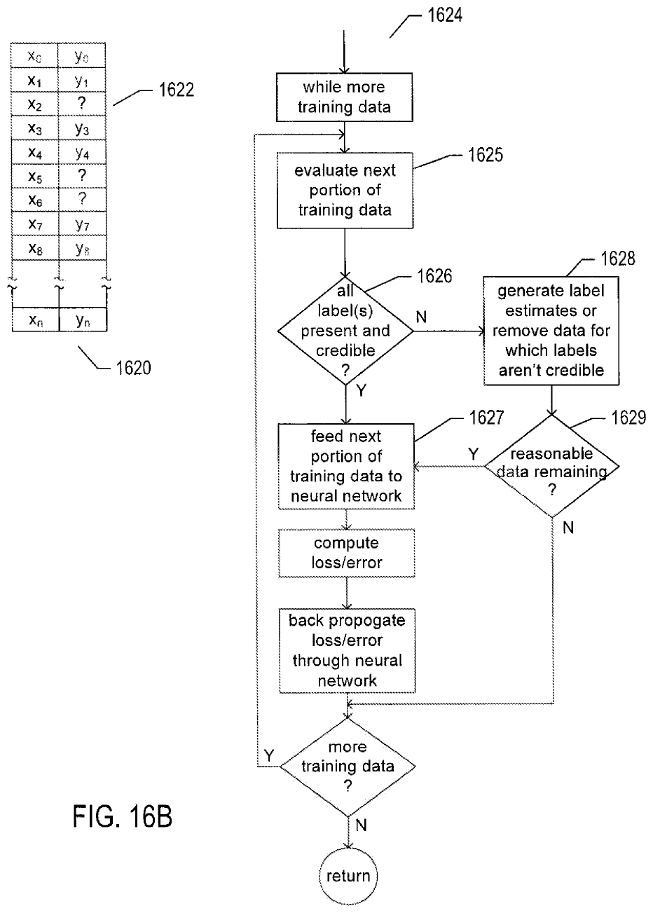

FIG. 16A-B illustrate neural-network training as an example of machine-learning-based-subsystem training. FIG. 16A illustrates the construction and training of a neural network using a complete and accurate training dataset. The training dataset is shown as a table of input-vector/label pairs 1602, in which each row represents an input-vector/label pair. The control-flow diagram 1604 illustrates construction and training of a neural network using the training dataset. In step 1606, basic parameters for the neural network are received, such as the number of layers, number of nodes in each layer, node interconnections, and activation functions. In step 1608, the specified neural network is constructed. This involves building representations of the nodes, node connections, activation functions, and other components of the neural network in one or more electronic memories and may involve, in certain cases, various types of code generation, resource allocation and scheduling, and other operations to produce a fully configured neural network that can receive input data and generate corresponding outputs. In many cases, for example, the neural network may be distributed among multiple computer systems and may employ dedicated communications and shared memory for propagation of activations and total error or loss between nodes. It should again be emphasized that a neural network is a physical system comprising one or more computer systems, communications subsystems, and often multiple instances of computer-instruction-implemented control components.

In step 1610, training data represented by table 1602 is received. Then, in the while-loop of steps 1612-1616, portions of the training data are iteratively input to the neural network, in step 1613, the loss or error is computed, in step 1614, and the computed loss or error is back-propagated through the neural network step 1615 to adjust the weights. The control-flow diagram refers to portions of the training data rather than individual input-vector/label pairs because, in certain cases, groups of input-vector/label pairs are processed together to generate a cumulative error that is back-propagated through the neural network. A portion may, of course, include only a single input-vector/label pair.

FIG. 16B illustrates one method of training a neural network using an incomplete training dataset. Table 1620 represents the incomplete training dataset. For certain of the input-vector/label pairs, the label is represented by a “?” symbol, such as in the input-vector/label pair 1622. The “?” symbol indicates that the correct value for the label is unavailable. This type of incomplete data set may arise from a variety of different factors, including inaccurate labeling by human annotators, various types of data loss incurred during collection, storage, and processing of training datasets, and other such factors. The control-flow diagram 1624 illustrates alterations in the while-loop of steps 1612-1616 in FIG. 16A that might be employed to train the neural network using the incomplete training dataset. In step 1625, a next portion of the training dataset is evaluated to determine the status of the labels in the next portion of the training data. When all of the labels are present and credible, as determined in step 1626, the next portion of the training dataset is input to the neural network, in step 1627, as in FIG. 16A. However, when certain labels are missing or lack credibility, as determined in step 1626, the input-vector/label pairs that include those labels are removed or altered to include better estimates of the label values, in step 1628. When there is reasonable training data remaining in the training-data portion following step 1628, as determined in step 1629, the remaining reasonable data is input to the neural network in step 1627. The remaining steps in the while-loop are equivalent to those in the control-flow diagram shown in FIG. 16A. Thus, in this approach, either suspect data is removed, or better labels are estimated. based on various criteria, for substitution for the suspect labels.

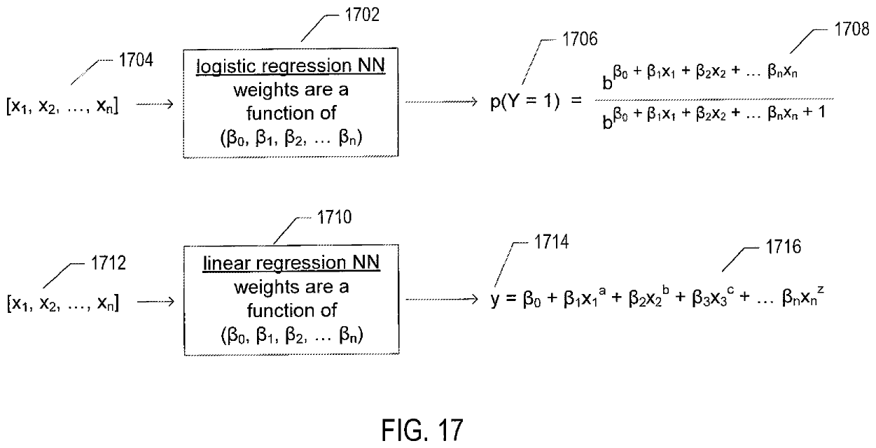

FIG. 17 illustrates two of many different types of neural networks. A neural network, as discussed above, is trained to implement a generally complex, non-linear function. The implemented function generally includes a multi-dimensional domain, or multiple input variables, and can produce either a single output value or a vector containing multiple output values. A logistic-regression neural network 1702 receives n input values 1704 and produces a single output value 1706 which is the probability that a binary variable has one of the two possible binary values “0” or “1.” which are often alternatively represented as “FALSE” and “TRUE.” In the example shown in FIG. 17, the logistic-regression neural network outputs the probability that the binary variable has the value “1” or “TRUE.” A logistic regression computes the value of the output variable from the values of the input variables according to expression 1708, and, therefore, a logistic-regression neural network can be thought of as being trained to learn the values of the coefficients flip, β₀, β₁, β₂, . . . , βₙ. In other words, the weights associated with the nodes of a logistic-regression neural network are some function of the logic regression-expression coefficients β₀, β₁, β₂, . . . , βₙ. Similarly, a linear-regression neural network 1710 receives n input values 1712 and produces a single real-valued output value 1714. A linear regression computes the output value according to the generalized expression 1716, and, therefore, a liner-regression neural network can again be thought of as being trained to learn the values of the coefficients β₀, β₁, β₂, . . . , βₙ. In traditional logistic regression and linear regression, any of various techniques, such as the least-squares technique, are employed to determine the values of the coefficients β₀, β₁, β₂, . . . , βₙ from a large set of experimentally obtained input-values/output-value pairs. The neural-network versions of logistic regression and linear regression learn a set of node weights from a training data set. The least-squares method, and other such minimization methods, involve matrix-inversion operations, which, for large number of input variables and large sets of input-values/output-value pairs, can be extremely computationally expensive. Neural networks have the advantage of incrementally learning optimal coefficient values as well as providing best-current estimates of the output values based on whatever training has already occurred.

### Reinforcement Learning

Neural networks are a commonly used and popular form of machine learning that have provided for spectacular advances in certain types of problem domains, including automated processing of digital images and automated natural-language-processing systems. However, there are many different additional types of machine-learning methods and approaches with particular utilities and advantages in various different problem domains. Reinforcement learning is a machine-learning approach that is increasingly used for various types of automated control. FIG. 18 provides an illustration of the general characteristics and operation of a reinforcement-learning control system. In FIG. 18, rectangles, such as rectangle 1802, represent the state of a system controlled by a reinforcement-learning agent at successive points in time. The agent 1804 is a controller and the environment 1806 is everything outside of the agent. As one example, an agent may be a management or control routine executing within a physical server computer that controls certain aspects of the state of the physical server computer. The agent controls the environment by issuing commands or actions to the environment. In the example shown in FIG. 18, at time t₀, the agent issues a command aₜ_{₀} to the environment, as indicated by arrow 1808. At time t₀, the environment responds to the action by implementing the action and then, at time t₁, returning to the agent the resulting state of the environment, sₜ_{₁} as represented by arrow 1810, and a reward, rₜ_{₁}, as represented by arrow 1812. The state is a representation of the current state of the environment. For a server computer, for example, the state may be a very complex set of numeric values, including the total and available capacities of various types of memory and mass-storage devices, the available bandwidth and total bandwidth capacity of the processors and networking subsystem, indications of the types of resident applications and routines, the type of virtualization system, the different types of supported guest operating systems, and many other such characteristics and parameters. The reward is a real-valued quantity, often in the range [0, 1]. It output by the environment to indicate to the agent the quality or effectiveness of the just-implemented action, with higher values indicating greater quality or effectiveness. It is an important aspect of reinforcement-learning systems that the reward-generation mechanism cannot be controlled by the agent because, otherwise, the agent could maximize returned rewards by directly controlling the reword generator to return maximally-valued rewards. In the computer-system example, rewards might be generated by an independent reward-generation routine that evaluates the current state of the computer system and returns a reward corresponding to the estimated value of the current state of the computer system. The reward-generation routine can be developed in order to provide a generally arbitrary goal or direction to the agent which, over time, learns to issue optimal or near-optimal actions for any encountered state. Thus, in FIG. 18, following reception of the new state and reward, as indicated by arrows 1810 and 1812, the agent may modify an internal policy that maps actions to states based on the returned reward and then issues a new action, as represented by arrow 1814 according to the current policy and current state of the environment, sₜ_{₁}. A new state and reward are then returned, as represented by arrows 1816 and 1818, after which a next action is issued by the agent, as represented by arrow 1820. This process continues on into the future, as indicated by arrow 1822. In certain types of reinforcement learning, time is partitioned into epochs that each span multiple action state-reward cycles, with policy updates occurring following the completion of each epoch, while, in other types of reinforcement learning, an agent updates its policy continuously, upon receiving each successive reward. One great advantage of a reinforcement-learning control system is that the agent can adapt to changing environmental conditions. For example, in the computer-system case, if the computer system is upgraded to include more memory and additional processors, the agent can learn, over time, following the upgrade of the computer system, to accept and schedule larger workloads to take advantage of the increased computer-system capabilities.

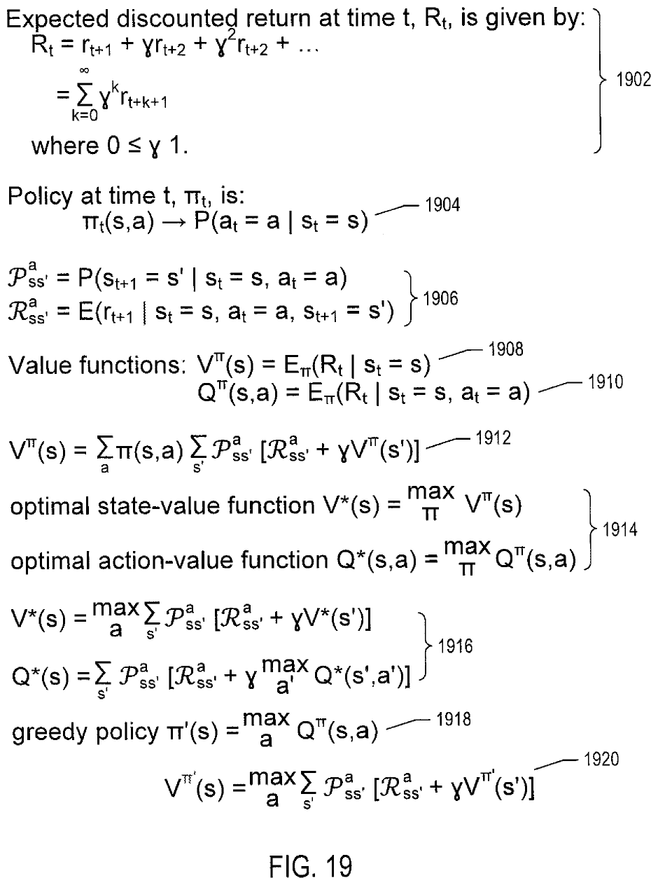

FIG. 19 illustrates certain details of one class of reinforcement-learning system. In this class of reinforcement-learning system, the values of states are based on an expected discounted return at each point in time, as represented by expressions 1902. The expected discounted return at time t, Rₜ, is the sum of the reward returned at time t+1 and increasingly discounted subsequent rewards, where the discount rate γ is a value in the range [0, 1). As indicated by expression 1904, the agent's policy at time t, π₁, is a function that receives a state s and an action a and that returns the probability that the action issued by the agent at time t, aₜ, is equal to input action a given that the current state, Sₜ, is equal to the input state s. Probabilistic policies are used to encourage an agent to continuously explore the state/action space rather than to always choose what is currently considered to be the optimal action for any particular state. It is by this type of exploration that an agent learns an optimal or near-optimal policy and is able to adjust to new environmental conditions, over time.

In many reinforcement-learning approaches, a Markov assumption is made with respect to the probabilities of state transitions and rewards. Expressions 1906 encompass the Markov assumption. The transition probability is the estimated probability that if action a is issued by the agent when the current state is s, the environment will transition to state s′. According to the Markov assumption, this transition probability can be estimated based only on the current state, rather than on a more complex history of action/state-reward cycles. The value [symbol] , is the expected reward entailed by issuing action a when the current state is s and when the state transitions to state s′.

In the described reinforcement-learning implementation, the policy followed by the agent is based on value functions. These include the value function V^{π} (s), which returns the currently estimated expected discounted return under the policy π for the state s, as indicated by expression 1908, and the value function Q^{π} (s,a), which returns the currently estimated expected discounted return under the policy It for issuing action a when the current state is s, as indicated by expression 1910. Expression 1912 illustrates one approach to estimating the value function V^{π} (s) by summing probability-weighted estimates of the values of all possible state transitions for all possible actions from a current state s. The value estimates are based on the estimated immediate reward and a discounted value for the next state to which the environment transitions. Expressions 1914 indicate that the optimal state-value and action-value functions V* (s,a) and Q* (s,a) represent the maximum values for these respective functions given for any possible policy. The optimal state-value and action-value functions can be estimated as indicated by expressions 1916. These expressions are closely related to expression 1912, discussed above. Finally, an expression 1918 for a greedy policy π′ is provided, along with a state-value function for that policy, provided in expression 1920. The greedy policy selects the action that provides the greatest action-value-function return for a given policy and the state-value function for the greedy policy is the maximum value estimated for each of all possible actions by the sums of probability-weighted value estimations for all possible state transitions following issuance of the action. In practice, a modified greedy policy is used to permit a specified amount of exploration so that an agent can continue to learn while adhering to the modified greedy policy, as mentioned above.

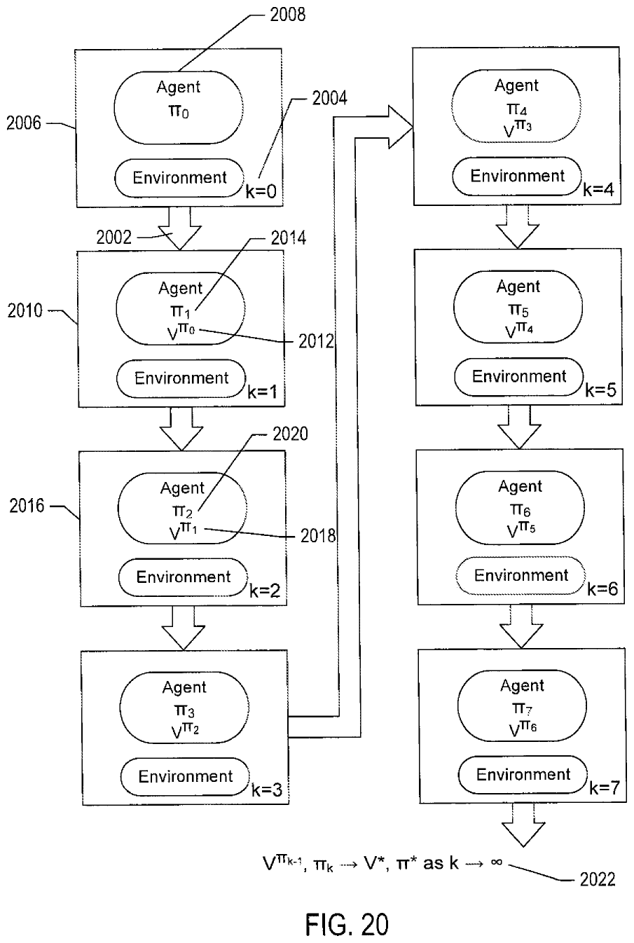

FIG. 20 illustrates learning of a near-optimal or optimal policy by a reinforcement-learning agent. FIG. 20 uses the same illustration conventions as used in FIG. 18, with the exceptions of using broad arrows, such as broad arrow 2002, rather than the thin arrows used in FIG. 18, and the inclusion of epoch indications, such as the indication “k=0” 2004. Thus, in FIGS. 20, each rectangle, such as rectangle 2006, represents a reinforcement-learning system at each successive epoch, where epochs consist of one or more action/state-reward cycles. In the 0^{th} epoch, or first epoch, represented by rectangle 2006, the agent is currently using an initial policy π₀ 2008. During the next epoch, represented by rectangle 2010, the agent is able to estimate the state-value function for the initial policy 2012 and can now employ a new policy π₁ 2014 based on the state-value function estimated for the initial policy. An obvious choice for the new policy is the above-discussed greedy policy or a modified greedy policy based on the state-value function estimated for the initial policy. During the third epoch, represented by rectangle 2016, the agent has estimated a state-value function 2018 for previously used policy π₁ 2014 and is now using policy π₂ 2020 based on state-value function 2018. For each successive epoch, as shown in FIG. 18, a new state-value-function estimate for the previously used policy is determined and a new policy is employed based on that new state-value function. Under certain basic assumptions, it can be shown that, as the number of epochs approaches infinity, the current state-value function and policy approach an optimal state-value function and an optimal policy, as indicated by expression 2022 at the bottom of 20.

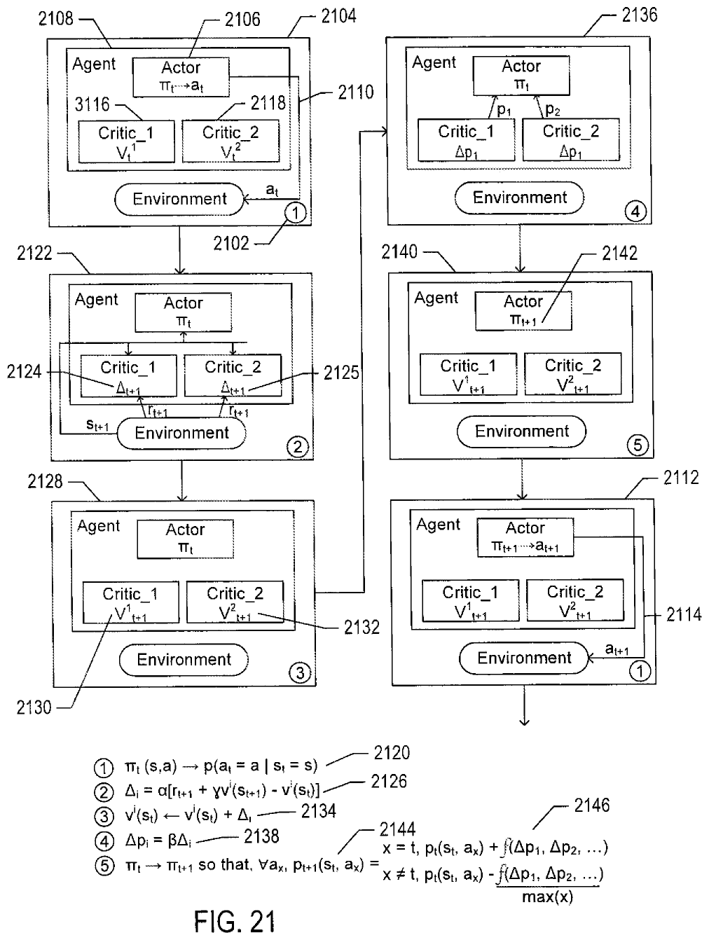

FIG. 21 illustrates one type of reinforcement-learning system the falls within a class of reinforcement-learning systems referred to as “actor-critic” systems. FIG. 21 uses similar illustration conventions as used in FIGS. 20 and 18. However, in the case of FIG. 21, the rectangles represent steps within an action/state-reward cycle. Each rectangle includes, in the lower right-hand corner, a circled number, such as circle “1” 2102 in rectangle 2104, which indicates the sequential step number. The first rectangle 2104 represents an initial step in which an actor 2106 within the agent 2108 issues an action at time t, as represented by arrow 2110. The final rectangle 2112 represents the initial step of a next action/state-reward cycle, in which the actor issues a next action at time t+1, as represented by arrow 2114. In the actor-critic system, the agent 2108 includes both an actor 2106 as well as one or more critics. In the actor-critic system illustrated in FIG. 21, the agent includes two critics 2160 and 2118. The actor maintains a current policy, πₜ, and the critics each maintain state-value functions Vₜⁱ, where i is a numerical identifier for a critic. Thus, in contrast to the previously described general reinforcement-learning system, the agent is partitioned into a policy-managing actor and one or more state-value-function-maintaining critics. As shown by expression 2120. towards the bottom of FIG. 21, the actor selects a next action according to the current policy, as in the general reinforcement-learning systems discussed above. However, in a second step represented by rectangle 2122, the environment returns the next state to both the critics and the actor, but returns the next reward only to the critics. Each critic i then computes a state-value adjustment Δᵢ 2124-2125, as indicated by expression 2126. The adjustment is positive when the sum of the reward and discounted value of the next state is greater than the value of the current state and negative when the sum of the reward and discounted value of the next state is less than the value of the current state. The computed adjustments are then used, in the third step of the cycle, represented by rectangle 2128, to update the state-value functions 2130 and 2132, as indicated by expression 2134. The state value for the current state sₜ is adjusted using the computed adjustment factor. In a fourth step, represented by rectangle 2136, the critics each compute a policy adjustment factor Δₚ_{ᵢ}, as indicated by expression 2138, and forward the policy adjustment factors to the actor. The policy adjustment factor is computed from the state-value adjustment factor via a multiplying coefficient β, or proportionality factor. In step 5, represented by rectangle 2140, the actor uses the policy adjustment factors to determine a new, improved policy 2142, as indicated by expression 2144. The policy is adjusted so that the probability of selecting action a when in state sₜ is adjusted by adding some function of the policy adjustment factors 2146 to the probability while the probabilities of selecting other actions when in state sₜ are adjusted by subtracting the function of the policy adjustment factors divided by the total number of possible actions that can be taken at state sₜ from the probabilities.

FIGS. 18-21 and the preceding paragraphs describing those figures provide an overview of reinforcement-learning systems. There are many different possibly alternative implementations and many additional details involved in implementing any particular reinforcement-learning system.

### Problems with Traditional Approaches to Distributed-Application Instantiation and Management

FIGS. 22A-G illustrate aspects of the problem domain addressed by the methods and systems disclosed in the current document. FIG. 22A shows simplistic representations of three different distributed computer systems 2202-2204, each enclosed within a dashed-line rectangle, such as dashed-line rectangle 2206. Each distributed computer system includes multiple computational resources, each represented by a solid-line rectangle. such as rectangle 2208. A computational resource may be a physical server computer, a virtual machine, a virtual appliance, or another such computational entity that can host one or more distributed-application instances. Of course, a realistic problem domain might include one or more distributed computer systems that each contain hundreds or thousands of computational resources, but such realistic problem domains would not provide for clear and effective illustration, so the small example systems are used in the currently described examples. The three distributed computer s stems 2202-2204 together comprise an aggregate distributed computer system. In FIG. 22B, a distributed application 2210 is represented by a set of distributed-application instances, each represented by a single-character-labeled rectangle, arranged in four different levels. The distributed-application instances are executables that are each deployed for execution on one of the computational resources of the aggregate distributed computer system. The distributed-application instances may, for example, each represent a microservice that needs to be hosted by a computational resource within the aggregate distributed computer system. The distributed-application instances at each level are of a single type. As an example, the single distributed-application instance 2212 at level 1 (2214) may be a centralized management routine or service, the 10 distributed-application instances 2216 at level 2 may be front-end executables or services, the two distributed-application instances 2218 at level 3 may be routing executables or services, and the five distributed-application instances 2220 at level 4 may be back-end executables or services. In this example, all of the distributed-application instances of a given level are identical. In a realistic problem domain, a large distributed application may include many tens to hundreds or thousands of distributed-application instances of a variety of different types.

FIG. 22C shows one possible instantiation of the distributed application. The centralized-management instance 2222 has been deployed on a computational resource 2223 in distributed computer system 2202. The front-end instances 2224-2232 have been distributed across the three distributed computer systems, with each of distributed computer systems 2202-2203 hosting four front-end instances and distributed computer system 2204 hosting two front-end instances. A routing instance 2234 and 2235 have been deployed to each of distributed computer systems 2202 arid 2203. Finally, the back-end instances 2236-2240 have been distributed across the three distributed computer systems, with two back-end instances in each of distributed computer systems 2202 and 2203 and one back-end instance in distributed computer system 2204. In the instantiation shown in FIG. 22C, each instance is hosted by a different computational resource. This may have allowed each instance to obtain maximal possible capacities and bandwidths of one or more types of internal components of the computational resources. In this case, obtaining maximal possible capacities and bandwidths of one or more types of internal components appears to have outweighed any networking overheads that result from communications between the different instances over local physical or virtual networks. It may be the case that each of the distributed computer systems is located in a different geographical region, as a result of which a reasonable number of front-end instances are deployed in each of the distributed computer systems in order to minimize long-haul networking overheads. In addition, each distributed computer system also includes back-end instances, perhaps to minimize long-haul communications overheads between front-end instances and back-end instances. The routing instances are distributed for similar reasons to two different distributed computer systems, but because only two routing instances are specified for the distributed application, only two of the three distributed computer systems is able to host a routing instance. No routing instance is included in the third distributed computer system perhaps because it has, or was expected to have, the smallest aggregate workload.

FIG. 22D shows a different instantiation of the distributed application 2210. In this instantiation all of the back-end instances have been deployed to distributed computer system 2204, with the front-end instances and routing instances fairly evenly distributed among distributed computer systems 2202 and 2203. In this case, it could be that the computational resources of distributed computer system 2204 have much higher processing bandwidths than those of distributed computer systems 2202-2203, and thus are more suitable for hosting compute-intensive back-end instances. Moreover, these advantages may be greater than any additional communications overheads involved in communications between front-end instances and back-end instances. In this instantiation, each instance is hosted by a different computational resource, perhaps to maximize the component resources within computational resources available to each instance. In addition, it would seem that location of front-end instances in the distributed computer system 2204 was not expected to provide any communications advantages, perhaps because distributed computer system 2204 is not located in a geographical region distinct from the geographical regions in which distributed computer systems 2202 and 2203 are located.

FIG. 22E illustrates a third instantiation of the distributed application 2210. This is a very different type of instantiation from those shown in FIGS. 22C-D. In this instantiation, three back-end instances and a routing instance are hosted by a single computational resource 2244 in distributed computer system 2202 and two back-end instances and a routing instance or hosted by a single computational resource 2246 in distributed computer system 2203. The front-end instances are distributed across all three distributed computer systems 2202-2204. In this case, it may be that the communications overheads between the routing instances and back-end instances are quite high, and minimizing those overheads by co-locating the routing instances and back-end instances within a single computational resource offsets other disadvantages, including sharing of the computational components of a single computational resource by multiple back-end instances and a routing instance. In this case, there appeared to be advantages of locating front-end instances in all three distributed computer systems, such as minimizing long-haul communications overheads. In addition, either computational resources 2244 and 2246 have much greater available component-resource capacities and bandwidths than the other computational resources and are thus able to host multiple back-end instances and a routing instance or perhaps the back-end instances are only infrequently accessed and thus do not require significant component resources within the computational resource that hosts them.

FIG. 22F shows yet a different instantiation of the distributed application 2210. In this instantiation, no instances are deployed in distributed computer system 2204. A single computational resource 2250 and 2252 in each of distributed computer systems 2202 and 2203 hosts a large number of front-end instances along with a routing instance. The back-end instances are distributed across distributed computer systems 2202-2203, with each back-an instance hosted by a different computational resource. In this case, the front-end instances appear to not consume large fractions of the component resources available within the computational resources that hosts them. Moreover, there seem to be significant communications overheads between the front-end instances and the routing instances. The back-end instances appear to require significant component resources and thus are hosted by computational resources to which other instances have not been deployed. In this case, there appears to be no advantage to locating front-end instances in distributed computer system 2204, perhaps because it is not located in a geographical region distinct from the geographical region or regions in which distributed computer systems 2202 and 2203 are located. Alternatively, it may be the case of computational resources 2250 and 2252 have far greater component resources than any of the other computational resources, and for that reason they have each ended up hosting many different instances.

FIG. 22G illustrates a management aspect of the problem domain addressed by the currently disclosed methods and systems. In this case, distributed application 2210 has been scaled up by significantly increasing the number of front-end and back-end instances. Assuming that the initial instances were deployed as shown in FIG. 22C, the scale up operation involves distributing the newly added instances, shown by dashed-lined rectangles. such as dashed-line rectangle 2254, in FIG. 22G, among the three distributed computer systems 2202-2204. In the distributed-application instantiation shown in FIG. 22G, a new routing instance 2256 has been deployed to distributed computer system 2204 and the new front-end and back-end instances have been relatively evenly distributed across the three distributed computer systems 2202-2204 to provide a reasonably balanced distribution. In this case, single computational resources either host a single instance or, in three cases 2260-2262, host a routing instance along with a back-end instance. This would suggest that there is some advantage to co-locating a routing instance with a back-end instance, perhaps to minimize local communications overheads, but that, in general, it is advantageous for each instance to have access to the entire component resources provided by the computational resources, rather than sharing them.

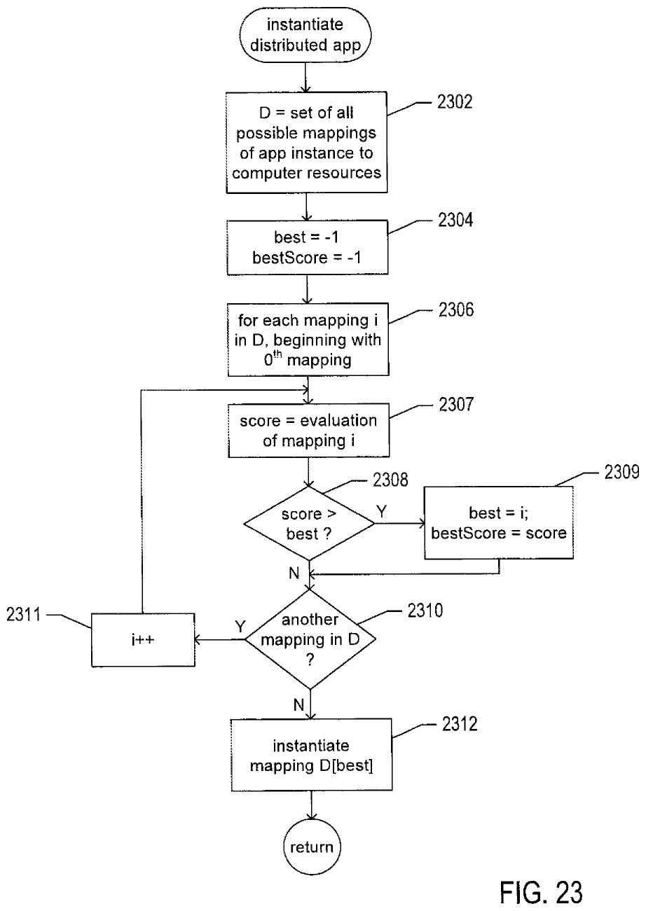

It might be imagined that the problem of distributing distributed-application instances across the computational resources provided by one or more distributed computer systems can be relatively straightforwardly solved by selecting the optimal mapping of instances to computational resources. FIG. 23 provides a control-flow diagram for a hypothetical optimal distributed-application instantiation method. In step 2302, the set variable D is initialized to contain the set of all possible mappings of distributed-application instances to computer resources for some particular distributed application and some particular aggregate distributed computer system. In step 2304, local variables best and bestScore are each set to −1. The for-loop of steps 2306-2311 considers each mapping index i in set variable D, beginning with a first mapping index i=0. In step 2307, the local variable score is set to a real value indicating a fitness or desirability evaluation of the currently considered mapping with index i. If the value contained in local variable score is greater than the value contained in local variable best, as determined in step 2308, local variable best is set to i and local variable bestScore is set to the contents of local variable score, in step 2309. Following the completion of the for-loop of steps 2306-2311, the mapping with the best score is instantiated, in step 2312.

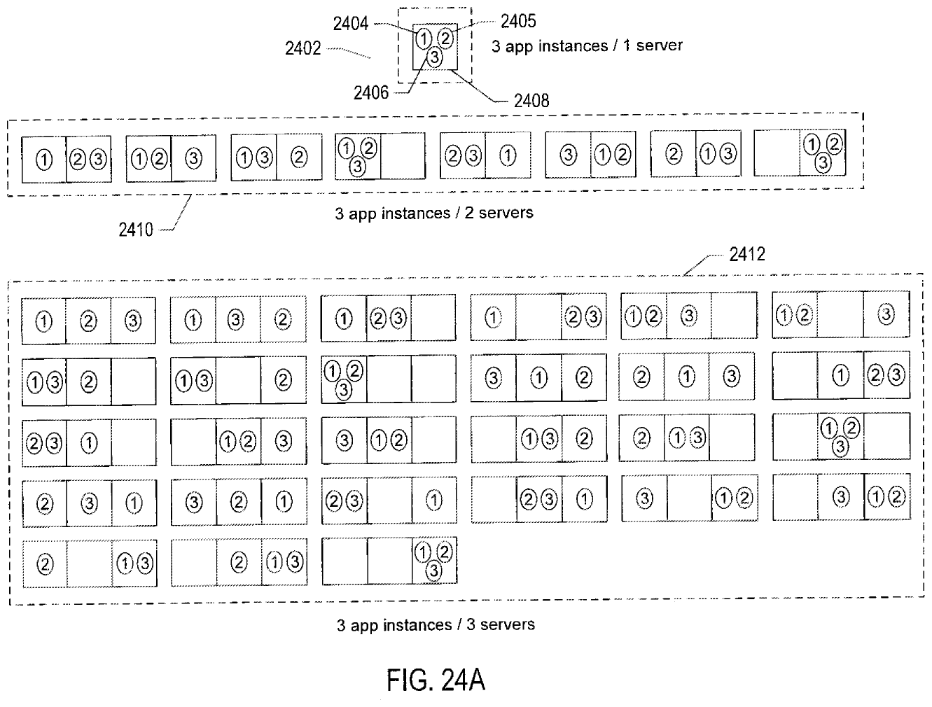

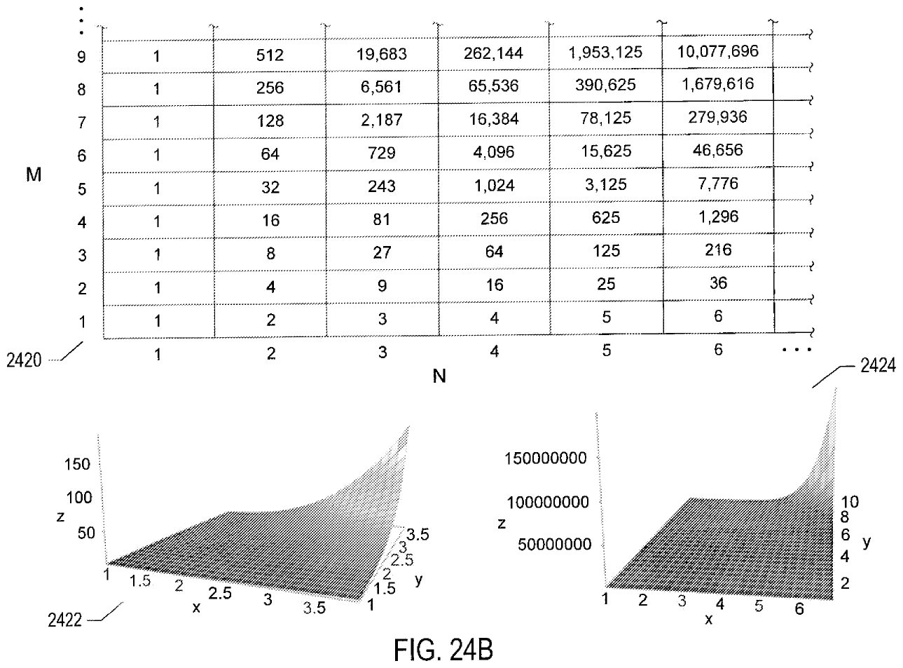

While simple, the optimal instantiation method illustrated by FIG. 23 is computationally intractable for even modestly sized distributed applications and aggregate distributed computer systems. FIGS. 24A-B illustrates the number of possible mappings of In distributed-application instances to n computational resources. FIG. 24A illustrates the number of possible mappings for m=3 and n=1, 2, and 3. In the case of instantiating a distributed application that includes three instances onto a single computational resource, such as a server, there is only one possible instantiation 2402. In this instantiation, all three instances 2404-2406 are contained within a single computational resource 2408. In the case of instantiating a distributed application that includes three instances onto two computational resources, there are eight different possible mappings, or instantiations, 2410. In the case of instantiating a distributed application that includes three instances onto three computational resources, there are 27 different possible mappings, or instantiations, 2412. The number of possible instantiations is clearly n^{m}. FIG. 24B shows a lower, left-hand portion of a table showing the number of possible instantiations of a distributed application that includes m instances across n different computational resources, with a horizontal axis corresponding to n and a vertical axis corresponding to m. Three-dimensional plot 2422 plots the surface corresponding to the number of possible instantiations above the x/y plane corresponding to the portion of table 2420 including values 1, 2, 3, and 4 for m and n and three-dimensional plot 2424 shows the surface above the x/y plane corresponding to the portion of table 2420 for which values are shown in FIG. 24B. For the modest problem domain in which a distributed application containing 9 instances needs to be deployed to 6 computational resources, the number of possible different mappings or instantiations is 10,077,696. The modest problem domain in which a distributed application containing 20 instances is to be deployed across 50 computational resources would require consideration of more than 9.5×10³³ different instances. The set variable D used in the control-flow diagram of FIG. 23 could not be stored in the memories of all of the computer systems in the world. Furthermore, the for-loop of steps 2306-2311 would take trillions of years to execute on even the fastest computer. A microservice-based application could easily employ several hundred services that would need to be distributed across an aggregate distributed-computer system containing thousands of computational resources. Thus, finding an optimal distributed-application-instantiation method by initially selecting an optimal distribution of distributed-application instances across a set of available computational resources is computationally intractable.

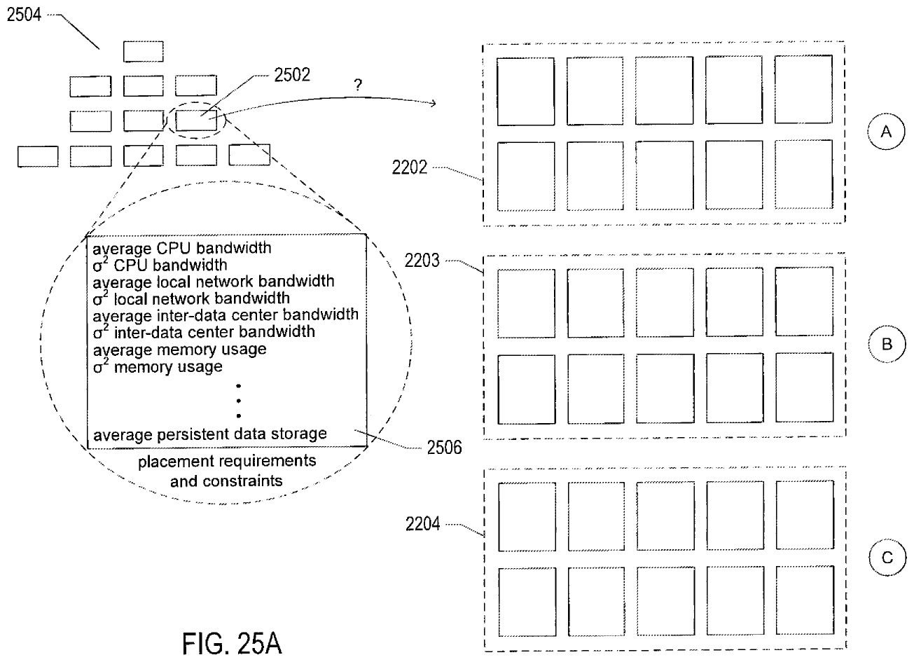

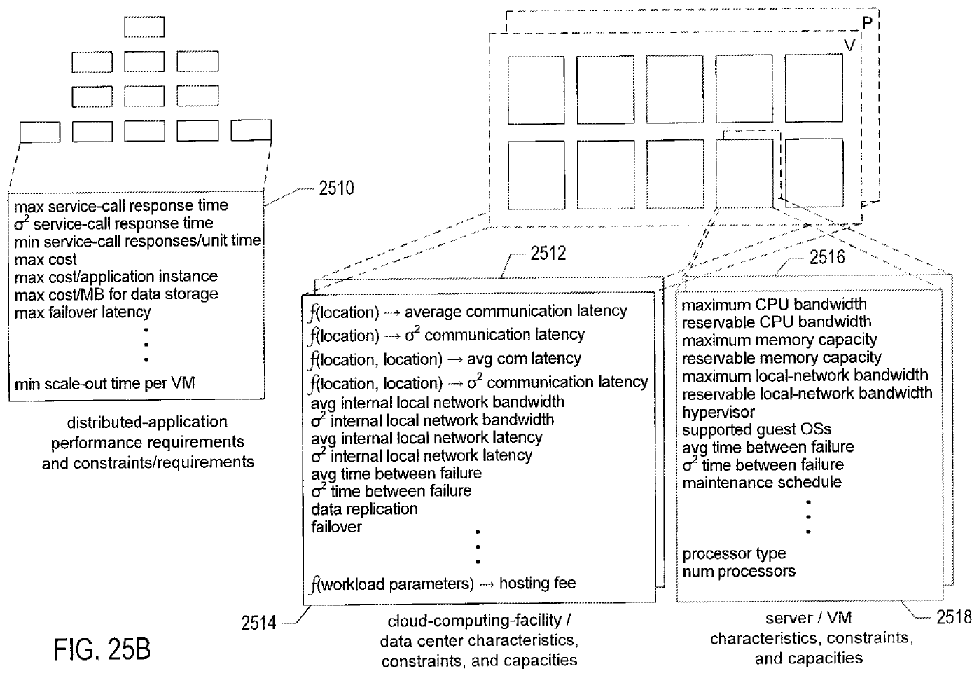

FIGS. 25A-B illustrate a few the many different parameters, characteristics, and constraints that might need to be considered when deciding to which computational resource to deploy a particular distributed-application instance. As shown in FIG. 25A, a particular instance 2502 of a distributed application 2504 is selected for placement within the three distributed computer systems 2202-2204 previously discussed with reference to FIGS. 22A-G. Certain of the characteristics and parameters associated with the selected instance are shown within rectangle 2506. These include: (1) the average processor bandwidth used by the instance; (2) the variance of the processor bandwidth used by the instance; (3) the average local network bandwidth consumed by the instance; (4) the variance of the local network bandwidth used by the instance; (5) the average inter-data-center network bandwidth consumed by the instance; (6) the variance of the inter-data-center network bandwidth consumed by the instance; (7) the average memory usage of the instance; (8) the variance in the memory usage of the instance; and (9) the average persistent-data-storage capacity consumed by the instance. These are but a few of the characteristics, constraints, and parameters that might be associated with a distributed-application instance that need to be considered when determining on which computational resource to deploy the instance. Additional considerations may involve specific virtualization layers and operating systems required for executing the instance, specific computational resources required by the instance, such as access to graphical-processor-unit bandwidth, and access to locally installed functionalities required by the instance, such as local associative memories. FIG. 25B illustrates additional characteristics, parameters, and constraints that may need to be evaluated during a distributed-application-instance deployment. For example, rectangle 2510 includes examples of requirements and constraints associated with the distributed application, as a whole. The distributed application may be associated with performance requirements, such as: (1) the maximum allowable response time for a service call; (2) the maximum allowed variance in service-call response times second (3) the maximum total hosting cost for the distributed application; (4) the maximum hosting cost per application instance; (5) the maximum cost per megabyte for data storage; (6) the maximum time required for a server or virtual-machine failover; and (7) the maximum time for scale out on the per virtual-machine basis. There may be many additional types of performance requirements and constraints associated with the distributed application, as a whole. FIG. 25B also shows examples of characteristics, constraints, and requirements associated with the aggregate physical distributed computer system 2512, with a virtual distributed computer system implemented above the physical distributed computer system 2514, with physical computational resources, such as servers 2516, and with virtual computational resources, such as virtual machines 2518. There may be literally hundreds of different parameters, constraints, requirements, and characteristics associated with a particular distributed-application instance, a particular distributed application, and various levels within an aggregate distributed computer system on which the distributed application is to be instantiated that may need to be considered during, or that may influence, the decision with respect to selecting a host for a particular distributed-application instance. The large number of considerations with respect to each distributor-application-instance deployment would vastly add to the computational complexity of step 2307 in FIG. 23.

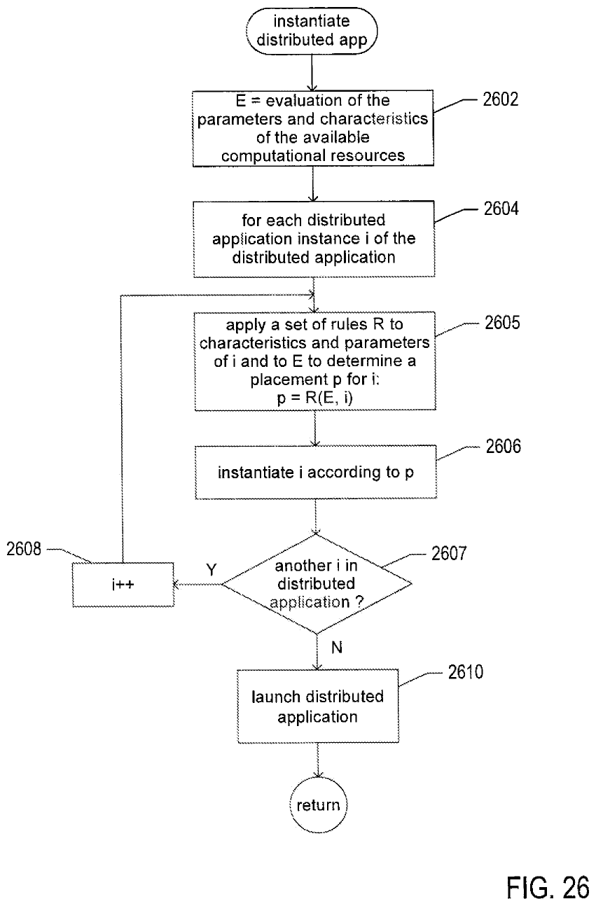

Given that the naïve approach illustrated in FIG. 23 for distributor-application instantiation is computationally intractable, perhaps a different, rule-based approach might produce an optimal or near-optimal instantiation. FIG. 26 provides a control-flow diagram that illustrates a rule-based approach to distributed-applications instantiation. In step 2602, variable E is set to contain the results of an evaluation of the various parameters, characteristics, constraints, and requirements associated with the available computational resources. Then, in the for-loop of steps 2604-2608, each distributed-application instance i is evaluated with respect to the results stored in variable E in order to select a computational-resource host for instance i. In step 2605, a set of rules R is applied to characteristics, requirements, constraints, and parameters associated with the currently considered instance i as well as to the contents of variable E in order to determine a placement for instance i. In step 2606, distributed-application instance i is deployed according to the determined placement. Following completion of the for-loop of steps 2604-2608, the distributed application is launched, in step 2610. In this case, it is not necessary to initially select an optimal instantiation of the distributed application, as a whole. Instead, each distributor-application instance is independently deployed to a selected host. The number of possible deployments of a single instance is proportional to the number of computational resources n, rather than to some large power of n, and thus the approach represented by the method illustrated in FIG. 26 might appear to be computationally tractable and certainly potentially far more efficient than the initially considered approach illustrated in FIG. 23. Unfortunately, this second approach is also computationally intractable, for a variety of different reasons. One reason is that it is very difficult to design large rule sets. Rule sets tend to be quite fragile, with the fragility exponentially increasing with respect to the size of the rule set. Later-added rules often conflict with existing rules of a rule set, and may do so in ways that are difficult to predict. Furthermore, it would be essentially impossible to guarantee that any particular rule set devised for placement of individual distributed-application instances would lead to an optimal or near-optimal distributed-application instantiation. But there is a more fundamental problem associated with this approach.

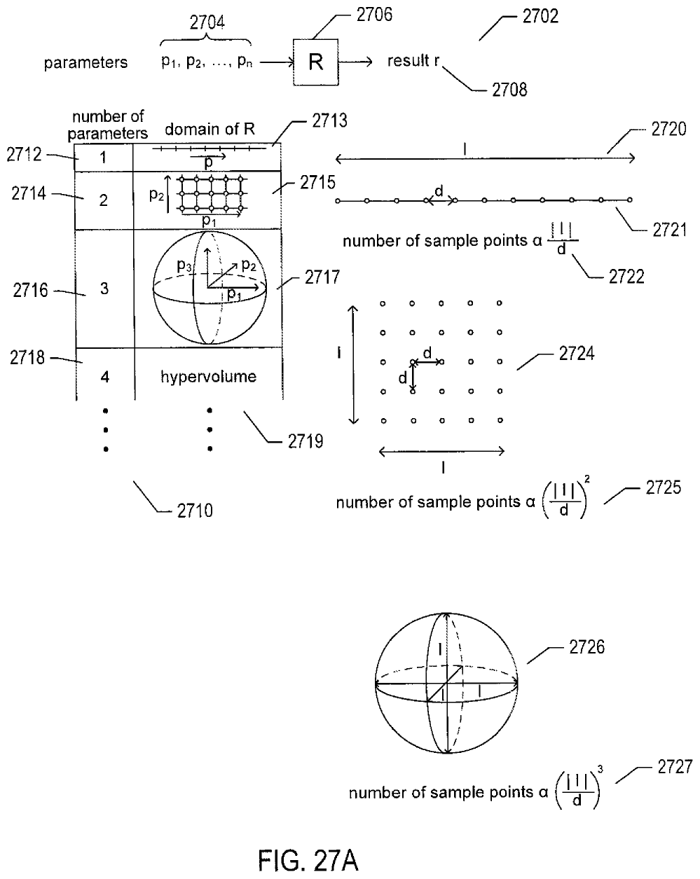

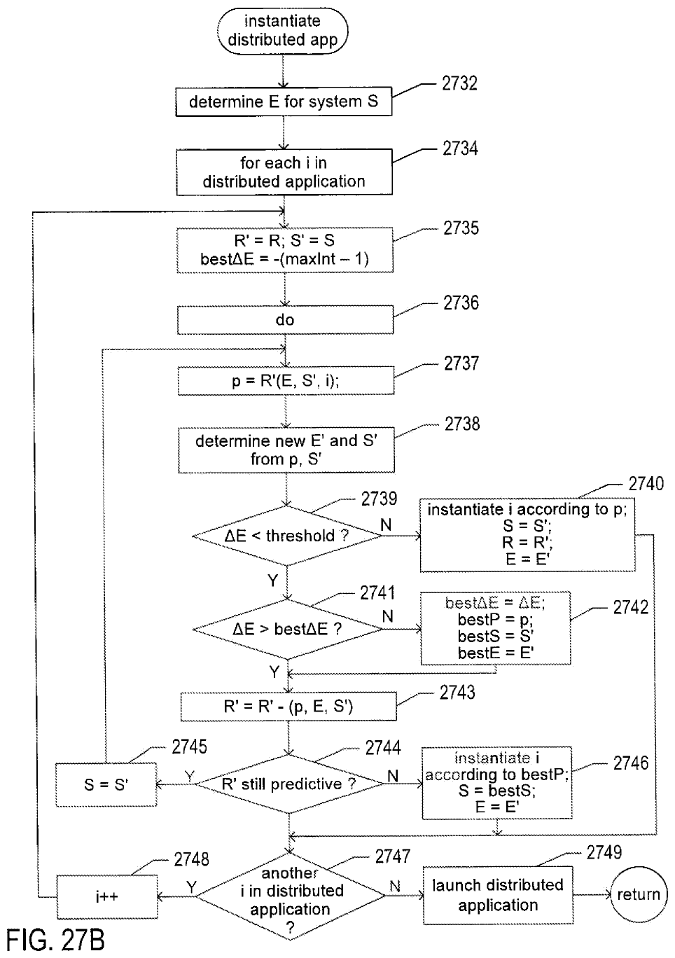

FIGS. 27A-B illustrates fundamental problems with the rule-based approach to distributed-application instantiation. A rule-based approach 2702 is summarized at the top of FIG. 27A. A set of n parameters 2704 is input to a set of rules R 2706, and evaluation of the parameters with respect to the set of rules produces a result r 2708. This diagram is similar to the diagrams of various types of neural networks discussed above with reference to FIG. 17. In essence, a set of rules is simply an implementation of a very complex function, with each of the parameters pᵢ corresponding to a dimension in the domain of the function. In order evaluate a function, whether implemented by a neural network or by a set of logic rules, it is necessary to evaluate input of a sample of different sets of input values in order to determine whether or not the results produced by the function are consistent with expected or desired results. In general, there are far too many combinations of possible input values to comprehensively evaluate the function. Instead, one generally tries to select well-spaced sample points from the parameter-space representing the function domain in order to evaluate a kind of grid of sample points.

Table 2710 illustrates a progression of function domains with increasing numbers of parameters. When the function takes a single input parameter 2712, the domain of the function is a line segment 2713. When the function takes two parameters 2714, the domain of the function is a two-dimensional area 2750. When the function takes three parameters 2716, the domain of the function is a three-dimensional volume 2717. For a number of parameters 2718 equal to, or greater than, 4, the function domains are hyper volumes 2719 of increasing dimension.

When the domain of the function is a line segment, such as line segment 2720. and one wants to select a set of samples spaced apart in the domain by a distance d, as indicated by the points along the line segment 2721, the number of sample points required is proportional to the length of the line segment divided by d, as indicated by expression 2722. In the case of a two-parameter area domain 2724, the number of sample points required is proportional to the square of the length of the edges of the area divided by d 2725. For the case of a three-parameter volume domain 2726, the required number of sample points is proportional to the cube of the length of the radius of the volume divided by d 2727. Thus, the number of required sample points increases exponentially in the number of parameters or dimensions. Consider a case in which there are 50 dimensions, and one wishes to select sample points that include at least four different values along each dimension. The number of sample points that would be required would be 4⁵⁰ which is equal to a number greater than 10³⁰. This is a different type of combinatorial explosion than that discuss with reference to the approach illustrated by FIG. 23, but one that is no less debilitating to the proposed distributed-application instantiation method. There is simply no way to evaluate the quality or effectiveness of a large rule set intended to evaluate even relatively modest numbers of input parameters. This also demonstrates why it is so difficult to construct such rule sets, since the same combinatorial explosion applies to the considerations that would need to accompany the addition of each successive rule to a rule set. The approach illustrated in FIG. 26 is computationally intractable.

FIG. 27B provides a control-flow diagram that illustrates yet another attempt at a method for optimally instantiating a distributed application. This next method is based on understanding that it is not possible to construct an optimal rule set for placing a sequence of distributed-application instances in order to optimize instantiation of the distributed application. Therefore, a rule set that is assumed to be only potentially empirically useful is employed and, for a given instance, the method repeatedly modifies the rule set in order to attempt to generate a reasonable placement if the placement initially output by the original rule set is deemed to be insufficiently advantageous. The control-flow diagram shown in FIG. 27B uses steps similar to certain of those discussed above with respect to FIG. 26. In step 2732, the method evaluates parameters and characteristics of the system, as in step 2602 of FIG. 26. Then, in the for-loop of steps 2734-2748, the method considers each instance i in a distributed application to be instantiated. In step 2735, the method makes copies R′ and S′ of the original rule set and system description and sets a local variable bestΔE to a large negative number. Then, in an inner do-while-loop of steps 2736-2745, the method iteratively determines a new placement for the currently considered instance, evaluates the placement, and, if the placement results in a greater-than-threshold decrease in the system evaluation, modifies the rule set in order to prepare for a next iteration of the do-while-loop. In step 2737, the rule set R′ is applied to the current evaluation E, the system description S′, and a description of the instance i to generate a placement p for instance i. In step 2738, a new system description and system evaluation are determined based on the placement p. When ΔE=E−E′ is less than a threshold value, indicating a greater-than-threshold decrease in the desirability or fitness of the new system state, then ΔE is saved, in step 2742, when it is greater than any other observed for putative placements for instance i, as determined in step 2741. The rule set is modified, in step 2743, by, for example, removing a rule deemed most responsible for the current placement p so that the modified rule set might generate a better placement in the next iteration of the do-while-loop, due to relaxation of the constraints embodied in the rule set. This process continues until an acceptable placement is found or until further modification of the rule set leads to a rule set without sufficient predictive power, such as a rule set with less than a minimum number of rules or a rule set that considers less than some minimum threshold number of different parameters or characteristics.

However, as with the other attempts to create optimal distributed-application instantiation methods, the method described by FIG. 27B also fails. In general, the order of rules within the rule set is significant. Thus, there are R different possible rule sets that are one rule smaller than an original rule set R. The number of different rule sets that can be generated by successively removing rules from an original rule set, Rₜₒₜₐₗ, is then:

$${R}_{total} = ( \begin{matrix}\vert R \vert \\ \vert R \vert - 1\end{matrix} ) + ( \begin{matrix}\vert R \vert \\ \vert R \vert - 2\end{matrix} ) + … + ( \begin{matrix}\vert R \vert \\ \vert R \vert - ( \vert R \vert - 1 )\end{matrix} )$$

This is the sum of interior entries for a row in a Pascal triangle with first interior entry equal to |R|, the number of rules in the original rule set R, and increases sharply as |R| increases. Thus, the do-while-loop of steps 2737-2745 in FIG. 27B might iterate billions of times for an even modestly sized rule set. Step 2738 may be quite computationally expensive, as a result of which the method shown in FIG. 27B may well be computationally infeasible. Worse, there is no guarantee, at any step, that the original or modified rule set produces anything close to an optimal or near-optimal placement for any given distributed-application instance. Simply randomly selecting a computational resource on which to deploy successively selected instances of a distributed application might well provide a better approach than the approach illustrated in FIG. 27B, but such a random approach, of course, is accompanied by no guarantees or even possible assumptions of optimality or even an approach to optimality.

The three methods for optimally or near optimally instantiating a distributed application proposed and rejected, in the preceding paragraphs, can be thought of as following in the category of centralized distributed-application-instantiation methods, in that a centralized management server with full knowledge of the available computational resources and a specification for instantiation of the distributed application could attempt to generate and implement such methods. Centralized approaches assume that an optimal or near-optimal distribution can be initially generated or obtained b)y optimal or near-optimal placement of each successive instance. However, due to the complexity of the problem, including the number of possible different instantiations and the large number of different considerations involved in selecting a host for each distributed-application instance, there is simply no centralized approach that could be shown to be capable of generating near-optimal or optimal distributed-application instantiations even if the method were computationally feasible. Instead, such centralized methods would necessarily be empirical, heuristic-based methods that might be, over time, improved, by trial and error, but which could never be shown to be near-optimal or optimal or even evaluated for optimality. However, the problem domain of instantiation and management of distributed applications is increasingly important in modern computing technologies. More and more computation-based services and functionalities are provided by large distributed applications running within extremely large and complex distributed computer systems. Even slightly inefficient instantiations of a distributed application can have enormous deleterious consequences with respect to the hosting costs associated with the distributed application, performance of the distributed application, and the maintainability of the distributed application, let alone even more basic consequences such as excessive electric-power consumption by distributed computer systems running distributed applications. There is a critical need for practical, computationally tractable, and efficient methods, and systems that incorporate these methods, for instantiating and managing distributed applications, and this critical need will become increasingly critical with every passing year.

### Currently Disclosed Methods and Subsystems

The currently disclosed methods and system employs a distributed approach to instantiation and management of distributed applications. Rather than attempting to solve or approximate a centralized approach to optimal distributed-application instantiation and management, the currently disclosed methods and systems rely on reinforcement-learning-based agents installed within computational resources to each locally optimize the set of distributed-application instances running within the computational resource in which the agent is installed. Over time, by continuously exchanging instances among themselves, the agents learn to achieve local optimization within their computational resources. The phrase “'local optimization,” in the preceding statements, means that each agent manages its set of distributed-application instances in a way that approaches an optimal or near optimal state, as defined by reinforcement-learning reward-generation components of the currently disclosed distributed-application instantiation and management system. The phrase “near-optimal” does not have a relative meaning, in this document, but instead means the result of approaching an optimal state by incremental improvements. By achieving local optimization within their computational resources, the agents control the system, as a whole, towards an at least locally optimal control of the aggregate computational resources and instantiated distributed applications hosted by the aggregate computational resources. In a sense, the currently disclosed methods and systems, by employing distributed agents within computational resources, partition the very complex and computationally intractable problem of optimally or near-optimally instantiating and managing distributed applications into many less complex local optimization problems within each computational resource and, in addition, spread out the local problems temporally, allowing each agent to learn, over time, how to achieve an optimal set of hosted distributed-application instances and also to adapt to changing environmental conditions. Rather than needing to initially determine an optimal or near-optimal set of hosted distributed-application instances, the agent takes incremental steps, while learning, in order to achieve near-optimal or optimal allocation of internal computational-resource components of a computational resource among a selected set of hosted distributed-application instances. Thus, the computationally intractable problem of instantiating a distributed application is partitioned not only spatially, over many computational resources, but also temporally, over many incremental steps, in which the instance distribution is incrementally adjusted.

FIGS. 28A-G illustrates the general characteristics and operation of the currently disclosed distributed-application instantiation and management subsystem and methods incorporated within that system. FIG. 28A shows a set of 20 computational resources that represent the computational resources of a distributed computer system. These computational resources are each represented by a rectangle, such as rectangle 2802. As discussed above, a computational resource is a computational entity that can host a distributed-application instance. Examples include physical servers, virtual servers, virtual machines, virtual applications, and other computational entities that provide execution environments for distributed-application instances. A computational resource may include multiple physical servers, virtual servers, virtual machines, virtual applications, and other such computational entities. The boundary that defines a computational resource can thus be adjusted to differently partition aggregate computational resources of a distributed computer system into multiple computational resources. As discussed above, a distributed computer system may include multiple different smaller distributed computer systems, as, for example, a cloud-computing facility that includes multiple geographically dispersed data centers, each including hundreds, thousands, tens of thousands, or more computational resources. Distributed applications are becoming increasingly complex and may include many different types of executables, many different instances of which need to be deployed on the computational resources of a distributed computer system. An initial instantiation of a distributed application may involve distributing and launching tens, hundreds, or thousands of distributed-application instances.

The first component of the currently disclosed distributed-application instantiation and management subsystem that is installed within the distributed computer system is an agent supervisor 2804, shown in FIG. 28B. The agent supervisor may be implemented within one or more virtual machines or virtual appliances, running within an execution environment provided by a virtualization layer that itself executes within one or more physical computational resources, or as an executable running within a physical server in an execution environment provided by an operating system. The agent supervisor is responsible for general management of a set of computational resources allocated to the agent supervisor for supporting execution of one or more distributed applications. The agent supervisor is also responsible for initial deployment of distributed applications and various types of management operations, including scaling operations during which the number of instances may be increased or decreased to respond to changing workloads. Next, as shown in FIG. 28C, the agent supervisor 2804 distributes and launches additional system components across the available computational resources, including a latent server 2806 and multiple agents 2808-2811. Eventually, as shown in FIG. 28D, the currently disclosed distributed-application instantiation and management subsystem includes the agent supervisor 2804, the latent server 2806, and an agent running within each computational resource allocated to the agent supervisor for instantiation of one or more distributed applications, such as agent 2808 in computational resource 2812. The agent supervisor provides sufficient, initial information to each agent to allow the agent to begin accepting distributed-application instances for hosting and to join a local peer group of agents in which the agent cooperates with its peer agents to exchange distributed-application instances in order to optimize the agent's set of locally hosted and managed distributed-application instances. Two of the computational resources 2814 and 2816 in FIG. 28D do not contain agents, and represent those computational resources of the distributed computer system that have not been allocated to the agent supervisor for supporting execution of distributed applications.

As shown in FIG. 28E, a specification or blueprint for a distributed application 2820 may be input, in one implementation, to the agent supervisor 2804 for instantiation within the computational resources allocated to the agent supervisor. Each small rectangle, such as rectangle 2822, represents a different distributed-application instance that needs to be deployed within the distributed computer system. During the deployment, the agent supervisor stores various types of information about the distributed application 2824, transmits an executable or reference to an executable, for each instance of the distributed application, to one of the agents, as represented by curved arrows pointing to the distributed instances, such as curved arrow 2826, and transmits information about the distributed application and the initial deployment to the latent server 2806, as represented by arrow 2828, which stores the information in data structures to be described in greater detail below 2830. In addition, as shown in FIG. 28F, the agent supervisor provides, to each agent initially selected by the agent supervisor for supporting the input distributed application, certain initial information about the distributed application and provides, to those agents which received one or more initial insistence deployments, information about the instances. This distributed information, further discussed below, is stored by the agents, as represented by curved arrows and smaller rectangles, such as curved arrow 2832 and small rectangle 2834 within agent 2808. In certain implementations, the agent supervisor may launch execution of instances while, in other implementations, the agents are responsible for launching execution of instances distributed to them by the agent supervisor.

Once the distributed application is initially instantiated by the agent supervisor, management of the distributed application continues, in a distributed fashion, by continuous monitoring of each computational resource by the agent installed within the computational resource and by exchange of instances between agents as each agent seeks to locally optimize the set of instances hosted on the computational resource controlled by the agent. For example, as shown in FIG. 28G, agent 2808 decides to a evict instance 2840 and negotiates with agent 2842 to transfer instance 2840 to the computational resource controlled by agent 2842, as represented by arrow 2844. Similarly agent 2046 decides to evict instance 2848 and negotiates with agent 2850, as represented by arrow 2852, to transfer instance 2048 to the computational resource managed by agent 2850, as represented by arrow 2854.

Once an instance transfer has been carried out, the latent server 2806 is eventually informed of the transfers and updates the latent server's data representation of the current state of the distributed application. The agents employ reinforcement learning to steadily learn how best to optimize their local computational resources with respect to hosted instances, receiving rewards for actions, such as successful eviction of instances and acceptance of instances from other agents. Subsequent up-scaling and down-scaling operations, following initial instantiation of a distributed application, are initially handled by the agent supervisor, which distributes additional instances across the computational resources, in the case of up-scale operations, terminates or directs termination of various already executing instances, in the case of down-scale operations, and manages updates to the distributed-application-instance executables. It is important to note that the agent supervisor and latency supervisor are not continuously relied on by the agents as the agents manage their locally resident distributed-application instance. In fact, the agents are deliberately designed to be able to manage their sets of distributed-application instances independently from the agent supervisor and latent server for a period of time up to a threshold period of time without system degradation. When the period of time of independent agent management passes the threshold period of time, the system may temporarily delay certain operations and learning activity, but they system will not experience cascading failures while one or both of the agent supervisor and latent server are unavailable. The agent supervisor is mostly concerned by initial distribution of distributed-application instances and bootstrapping newly launched agents to a state in which they can function relatively independently, as part of their local peer-to-peer network. The latent server functions as a repository for global state information and for providing updated reinforcement-learning reward-generation functions to agents, as further discussed below.

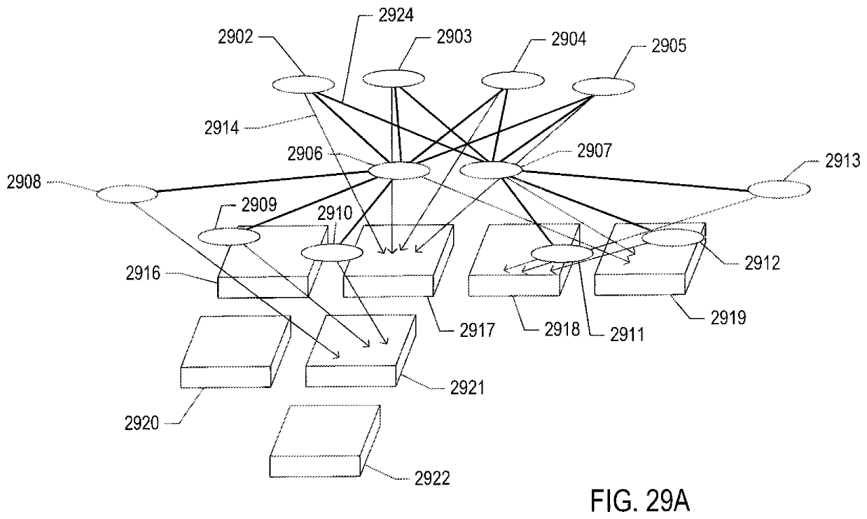

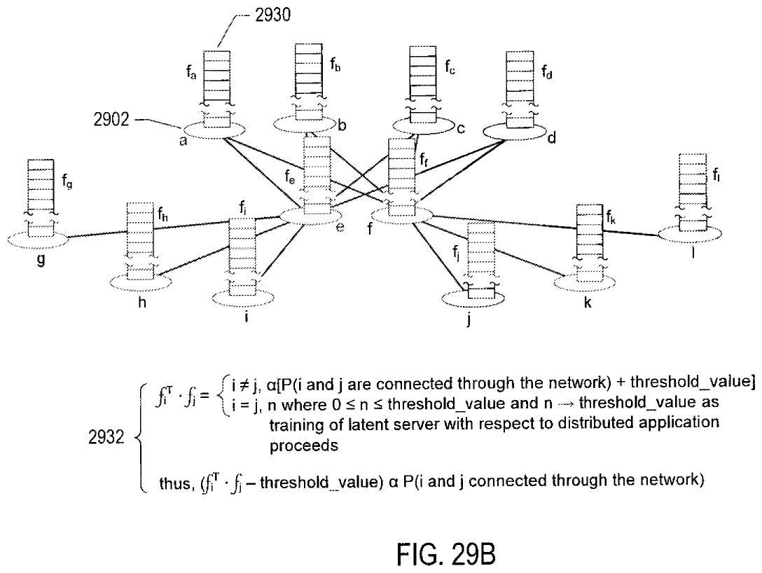

FIGS. 29A-B illustrate certain of the information maintained by the latent server with regard to an instantiated distributed application. FIG. 29A illustrates a graph-like mapping of distributed-application instances to computational resources. In FIG. 29A, the instances are represented by discs, or nodes, 2902-2913. Thin arrows, such as thin arrow 2914, indicate mappings between distributed-application instances to computational resources, each represented by lower-level rectangular volumes 2916-2922. Bold arrows, such as arrow 2924, represent sufficient virtual and/or physical network traffic between instances to consider the instances connected to one another. FIG. 29A provides a logical, visual representation of the type of information maintained by the latent server to represent an instantiated distributed graph, referred to as a “virtual graph.” The virtual graph need not, of course, comprise a visual representation of a graph, as in FIG. 29A, but does include a data representation from which a graph, such as that shown in FIG. 29A, can be logically constructed. As shown in FIG. 29B, a component of the virtual-graph information maintained by the latent server is a set of feature vectors, each node, or distributor-application instance, i associated with a feature vector fᵢ, such as feature vector fₐ 2930 associated with instance a 2902. A feature vector is a vector of numeric values generated from parameters and operational characteristics of distributed-application instances and parameters and operational characteristics of the computational resources on which they currently execute. The particular set of values encoded into feature vectors may differ from implementation to implementation, but often includes values indicating, for example, network ports and addresses associated with distributed-application instances, indications of the rate of incoming and outgoing network traffic associated with the network ports and addresses, general characteristics of the types of instances, and other such information. The values in feature vectors are generated so that the dot product of two feature vectors fᵢ and fⱼ provides a scalar value proportional to the extent that the two nodes, or instances i and j with which the two feature vectors are associated, communicate with one another. The dot product, along with a threshold value, can provide a measure or probability that the two nodes communicate with one another to the extent that they can be considered to be network connected, as indicated by expressions 2932 in the lower portion of FIG. 29B. Feature vectors allow agents to quickly ascertain the connectivity between instances which they currently manage and instances offered for transfer to them, as one example. They can be considered to be a component of the state information associated with a distributed-application instance.

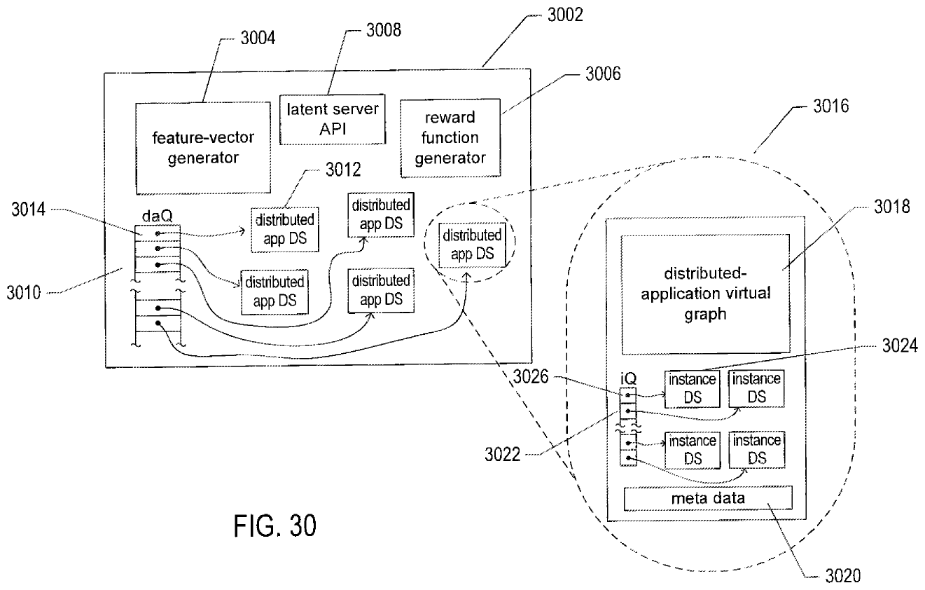

FIG. 30 provides an indication of one implementation of the latent-server component of the currently disclosed distributed-application instantiation and management subsystem. The latent server 3002 includes a feature-vector generator 3004, a reward-function generator 3000, support for a latent-server application programming interface (“API”) 3008, and stored information about each of the distributed applications that are currently instantiated and managed by the distributed-application instantiation in management system. The reward-function generator 3006 generates, for each distributed application, reinforcement-learning reward-generating functions that are provided to agents that host, or that may, in the future, host distributed-application instances for the distributed application. Each agent uses the reinforcement-learning reward-generating functions locally, to avoid network overheads that would otherwise be incurred were the rewards to be requested from the latent server, but can periodically request updated reward-generating functions from the latent server or the latent server can update reward-generating functions when updates are warranted. In the described implementation, the latent server includes a distributed-application queue daQ 3010 with entries that each contains a reference to a distributed-application data structure, such as distributed-application data structure 3012 referenced from the first entry 3014 within the daQ. Each distributor-application data structure, as shown in inset 3016, includes an encoding of the virtual graph that represents the current state of an instantiated distributed application 3018. discussed above with reference to FIGS. 29A-B, stored metadata that characterizes the distributed application 30A, and an instance queue iQ 3022, each entry of which contains a reference to an instance data structure, such as instance data structure 3024 reference from the first entry 3026 in the iQ. The instance data structure contains any additional information about instances needed by the distributed-application instantiation and management system that is not included in the virtual graph. The structure and data fields of distributed-application data structures and instance data structures vary from implementation to implementation. The generalized implementation shown in FIG. 30 is used to describe latent-server functionality in a series of control-flow diagrams, discussed below. While the agent supervisor is largely concerned with gross management of a set of computational resources allocated to the agent supervisor for hosting distributor-application instances, with initial deployment of distributed applications, and with management operations such as scaling operations, distributed-application-instance executable updating, and distributed-application status-reporting services, the latent server is primarily concerned with facilitating agent-based distributed management of the instantiated distributed applications. The latent server is primarily concerned with maintaining a virtual graph and other information for each distributed application, providing reinforcement-learning-reward functions, and updating feature vectors used by agents during monitoring and management operations are the primary responsibilities of the latent server.

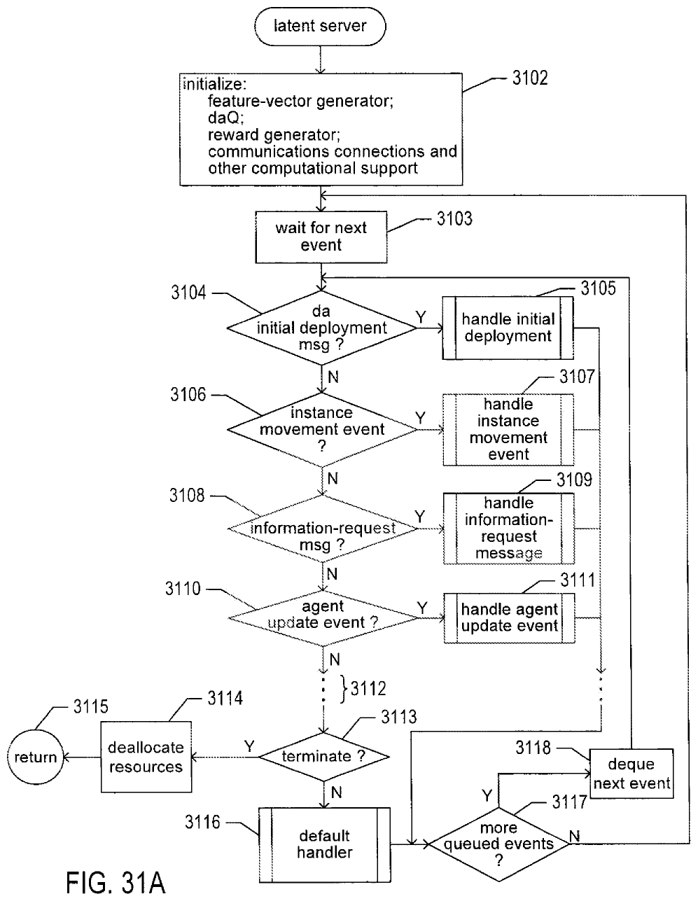

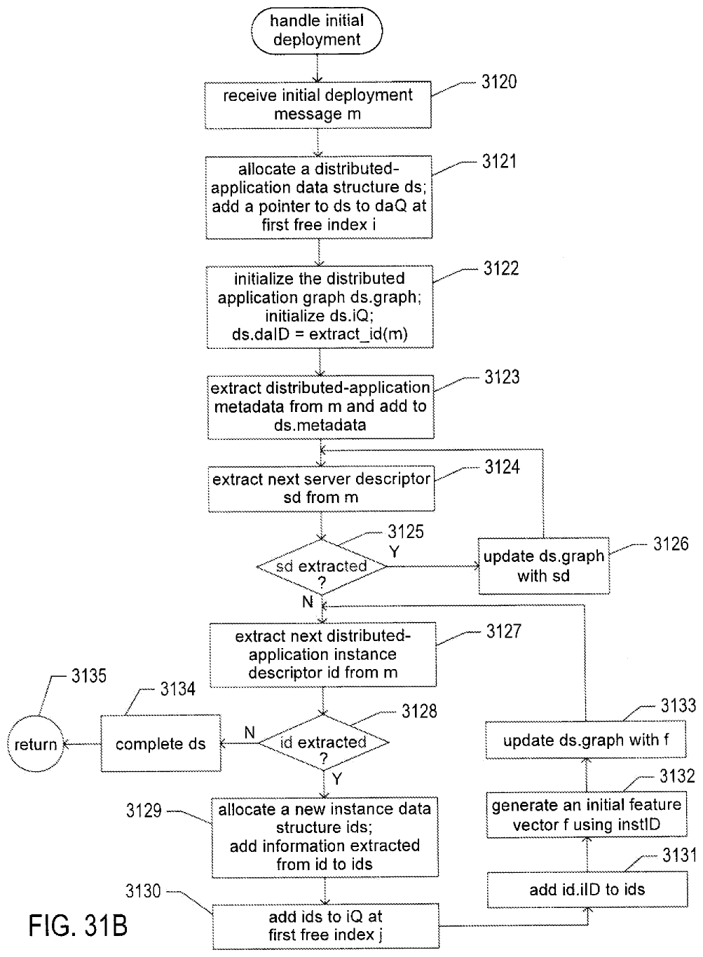

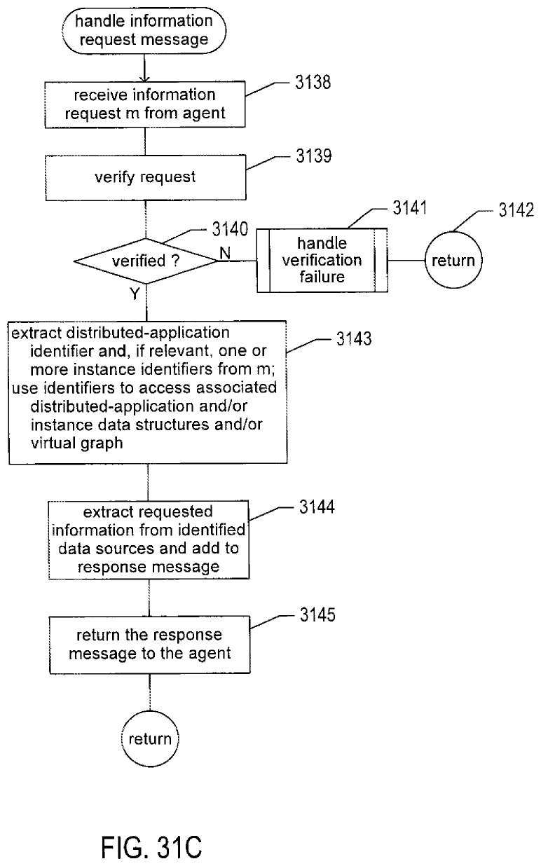

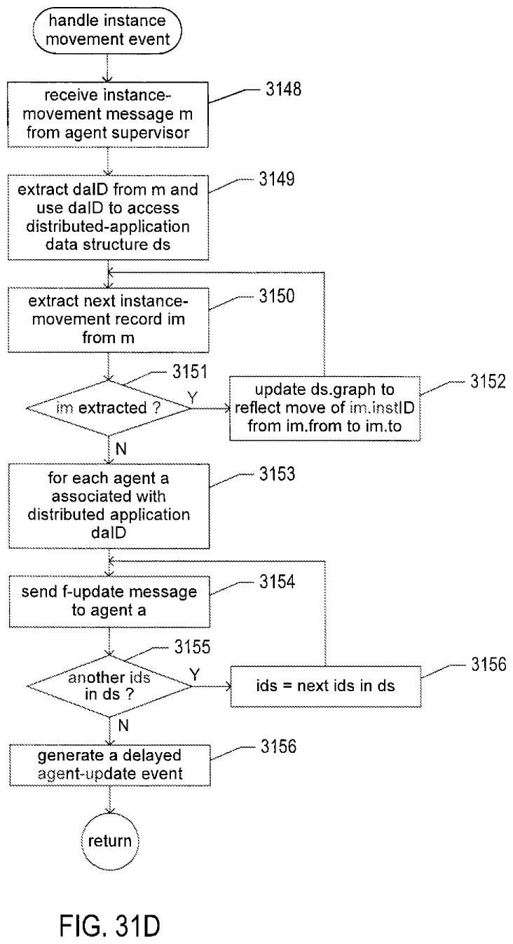

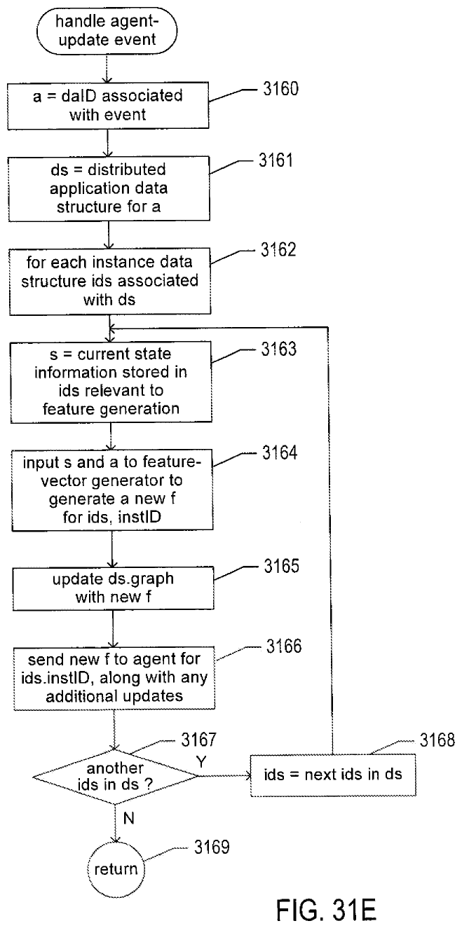

FIGS. 31A-E provide control-flow diagrams that illustrate operational characteristics of the latent server. FIG. 31 a provides a control-flow diagram for an event loop that represents a foundation for one implementation of the latent server. In step 3102, the latent server, upon launching, initializes the feature-vector generator, the daQ, the reward generator, various communications connections, and other computational support for latent-server operation. In step 3103, following initialization, the latent server waits for the occurrence of a next event. When a next event occurs, the latent server handles the event and eventually returns to step 3103 to wait for the occurrence of a subsequent event. Upon occurrence of a next event, the latent server determines, in step 3104, whether the event represents reception of an initial-deployment message from the agent supervisor, instructing the latent server of a recent transfer of one or more instances between agents. If so, then a handler routine that handles initial deployment messages is called, in step 3105. Otherwise, in step 3106, the latent server determines whether or not the event represents an instance-movement event. If so, then, in step 3107, a handler for the instance-movement event is called. Otherwise, in step 3108, the latent server determines whether or not the event represents reception of an information-request message from an agent. If so, then a handler for reception of an information-request message is called, in step 3109. Otherwise, in step 3110, the latent server determines whether or not an update-agent event has occurred. If so, then a handler for update-alarm expirations is called, in step 3111. Ellipsis 3112 indicates that many additional different types of events are handled by the event loop of the latent server. For the sake of conciseness and clarity, only a few of the events are illustrated in FIG. 31A and described, in detail, below. Additional events include reception and handling of various additional types of information-request and information-transmission messages. Agents and the agent supervisor may transmit various types of state information to the latent server in response to state changes initiated and/or detected by the agents and the agent supervisor. When the event represents reception of a termination indication, as determined in step 3113, then, in step 3114, the latent server deallocates any allocated resources and carries out additional termination-related tasks, after which the event loop terminates, in step 3115. A default handler 3116 handles any rare or unexpected events. Following execution of any handler called from the event loop, the latent server determines whether or not there are any additional events that have been queued for handling while previous events were being handled, in step 3117. If so, then a next event is dequeued, in step 3118, and control flows back to step 3104. Otherwise, control flows back to step 3103, where the latent server waits for a next event to occur.

FIG. 31B provides a control-flow diagram for the routine “handle initial deployment,” called in step 3105 of FIG. 31A. In step 3120, the routine “handle initial deployment” receives an initial-deployment message m sent by the agent supervisor. In step 3121, the routine “handle initial deployment” allocates a distributed-application data structure ds and adds a pointer to ds to a first free entry in the daQ. In step 3122, the routine “handle initial deployment” initializes the virtual graph ds.graph in ds and sets a field ds,daID in ds to a distributed-application identifier extracted from message m. In step 3123, the routine “handle initial deployment” extracts metadata related to the distributed application from message m and adds it to the metadata field ds.metadata. In step 3124, the routine “handle initial deployment” attempts to extract a next server descriptor sd from message m. When a next server descriptor is successfully extracted, as determined in step 3125, the extracted server descriptor is used to update the virtual graph in step 3126. Note that the term “server” is often used interchangeably with the term “computational resource” in this discussion, and has the broader meaning of “computational resource,” discussed above. Control returns to step 3124 in which the routine “handle initial deployment” attempts to extract yet another server descriptor from message m. When no further server descriptors can be extracted, the routine “handle initial deployment” attempts to extract a next distributed-application-instance descriptor id from message m in step 3127. When a next instance descriptor is extracted, as determined in step 3128, the routine “handle initial deployment” allocates a new instance data structure ids and adds information contained in the extracted instance descriptor id to ids, in step 3129. Then, in step 3130, the routine “handle initial deployment” adds a reference to ids to the first free entry in iQ. The routine “handle initial deployment” adds an instance identifier extracted from message m to ids in step 3131, in the case that it was not already added in the previous step. In step 3132, the routine “handle initial deployment” generates an initial feature vector f for the instance represented by ids and, in step 3133, updates the virtual graph with the new feature vector. When no further instance descriptors can be extracted from message m, as determined in step 3128, the routine “handle initial deployment” completes initializing the allocated distributed-application data structure ds in step 3134 and terminates in step 3135.

FIG. 31C provides a control-flow diagram for the routine “handle information-request message,” called in step 3109 of FIG. 31A. In step 3138, the routine “handle information-request message” receives an information-request message m sent to the latent server by an agent. In step 3139, the routine “handle information-request message” attempts to verify the information-request message is having been received from a legitimate and authorized agent. When the request is not verified, as determined in step 3140, a verification-failure handler is called, in step 3141, and the routine “handle information-request message” terminates, in step 3142. Otherwise, in step 3143, the routine “handle information-request message” extracts a distributed-application identifier and, if relevant to the information request, one or more instance identifiers from the received message m and uses the extracted identifier to access associated distributed-application and/or instance data structures as well as the associated virtual graph, if relevant to the information request. In step 3144, the routine “handle information-request message” extracts the requested information from the identified and accessed data sources and adds information to the response message. In step 3145, the routine “handle information-request message” returns the response message to the requesting agent. Agents, for example, cannot request updated feature vectors and reinforcement-learning reward-generation functions from the latent server.

FIG. 31D provides a control-flow diagram for the routine “handle instance movement,” called in step 3107 of FIG. 31A. In step 3148, the routine “handle instance movement” receives an instance-movement message m from the agent supervisor. In step 3149, the routine “handle instance movement” extracts a distributed-application identifier from the received message m and uses the extracted identifier to access the distributed-application data structure ds associated with the extracted identifier. In step 3150, the routine “handle instance movement” extracts a next instance-movement record im from the received message m. When a next instance-movement record was successfully extracted, as determined in step 3151, the routine “handle instance movement” updates the virtual graph ds.graph to reflect movement of a distributed-application instance from agent im.from to agent im.to, in step 3152. Control then flows back to step 3150, where the routine “handle instance movement” attempts to extract an additional instance-movement record from the message m. Then, in the for-loop of steps 3153-3156, the routine “handle instance movement” sends an f-update request message to each agent providing hosting support for one or more instances of the distributed application. An f-update request message requests that an agent provide updated status information so that the latent server can then send information updates to each agent with respect to the distributed application identified by the distributor-application identifier extracted from message m. Finally, in step 3156, the routine “handle instance movement” generates a delayed agent-updated event to invoke the agent-update-event handler, as discussed above with reference to step 3111 of FIG. 31A. Generation of the agent-update event, as discussed below, signals the latent server to provide updated information, such as updated feature vectors and/or updated reward-generation functions, to the agents, or a subset of the agents, that are currently, or that have previously, managed instances of the distributed applications for which instances have been moved during the most recently completed instance-movement event. Generation of the agent-updated is delayed to provide sufficient time for agents to respond to the f_update message sent in step 3154.

FIG. 31E provides a control-flow diagram for the routine “handle agent-update event,” called in step 3111 of FIG. 31A. In step 3116, the routine “handle update alarm expiration” determines the distributed-application identifier a associated with the expired update alarm. In step 3161, the routine “handle update alarm expiration” identifies the distributed-application data structure ds for the distributed application associated with identifier a. In the far-loop of steps 3162-3168, the routine “handle update alarm expiration” considers each instance data structure ids referenced by entries in ds.daQ. In step 3163, the routine “handle update alarm expiration” extracts current state information s from the currently considered ids and from ds.graph that is relevant to feature-vector generation. In step 3164, the routine “handle update alarm expiration” inputs s and the distributed-application identifier a to the feature-vector generator to generate a new feature vector f for the instance associated with the currently considered ids. In step 3165, the routine “handle update alarm expiration” updates the virtual graph dx.graph with the new feature vector f and, in step 3166, sends the new feature vector f, and any other relevant updates, such as a new reinforcement-learning reward-generation function, to the agent within the computational resource hosting the instance represented by the currently considered ids. When there is another ids referenced from ds.iQ, as determined in step 3167, ids is set to the next ids referenced from ds.iQ, in step 3168, for a subsequent iteration of the, for-loop of steps 3162-3168. Otherwise, the routine “handle update alarm expiration” returns, in step 3169.

As discussed above, with reference to FIG. 31A, the event loop considers many additional types of events. One of these additional types of events is reception of a response message to a previously transmitted f_update message, from the agent that received the f_update message. The handler for this type of event updates state information stored by the latent server with respect to the distributed-application instances currently managed by the agent. The latent-server API may provide many additional types of latent-server services, including requests for various types of information, large-scale updates requested by the agent supervisor when distributed applications are terminated, and other such services related to instantiation and management of distributed applications.

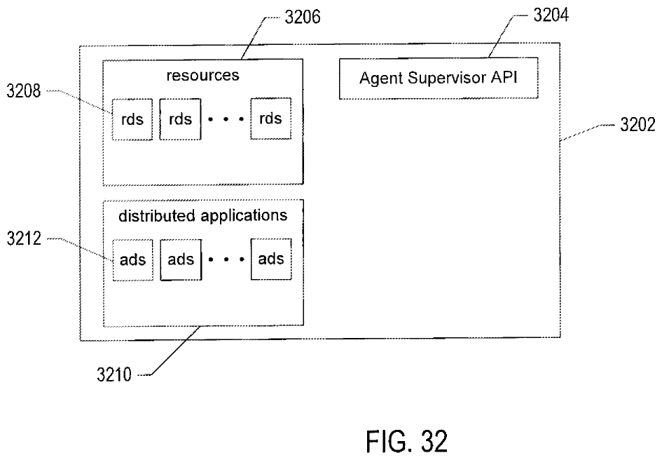

FIG. 32 illustrates certain components of the agent supervisor. The agent supervisor 3202 includes support for an agent-supervisor API 3204, an aggregate computational-resources data structure 3206 that includes a resource data structure rds, such as rds 3208, for each computational resource allocated to the agent supervisor for supporting execution of distributed applications, and an aggregate distributed-applications data structure 3210 that includes a distributed-application data structure ads, such as ads 3212, for each distributed application instantiated by the agent supervisor. As in the case of the data structures employed by the latent server, discussed above, the specific fields and contents for the rds and ads data structures vary from implementation to implementation. In general, they include information, such as the information discussed in FIGS. 25A-B, needed for determining to which computational resources to deploy distributed-application instances.

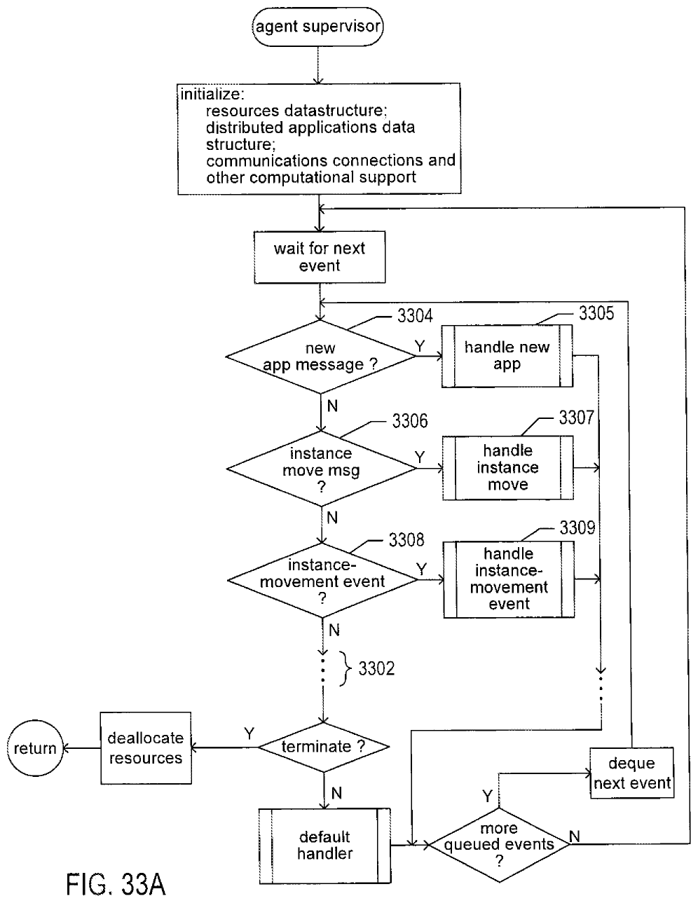

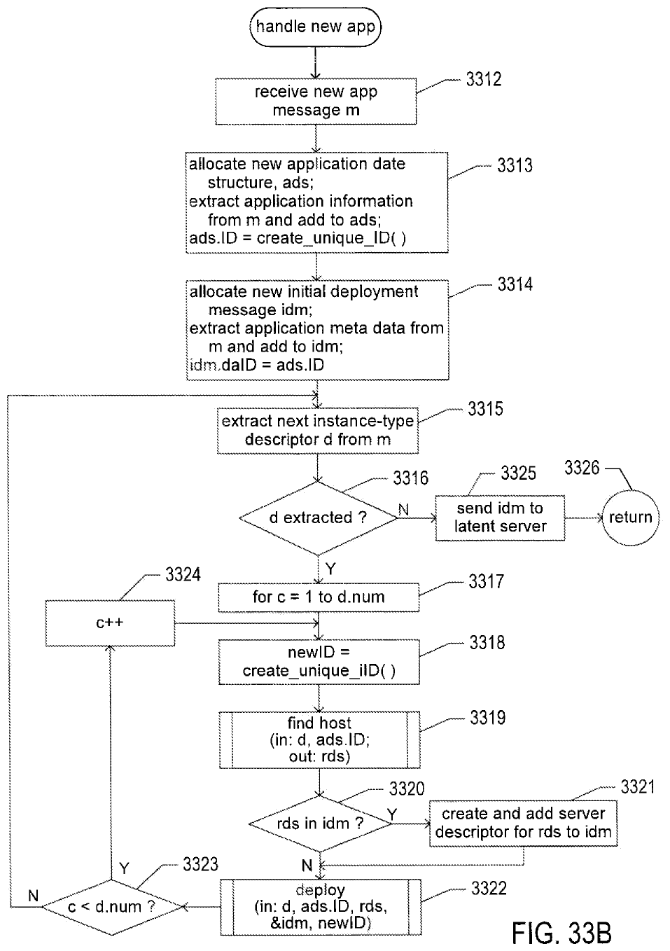

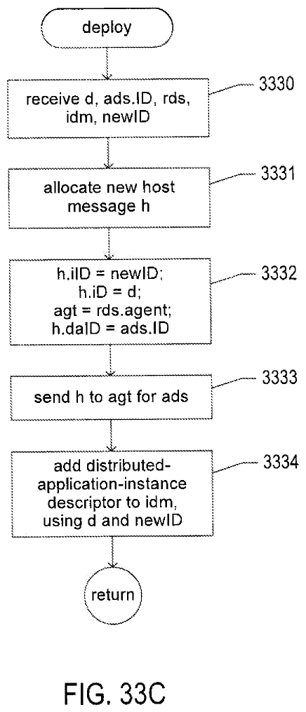

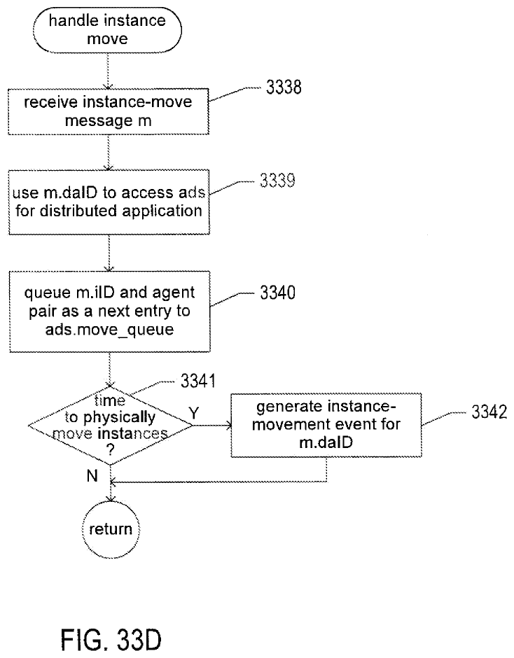

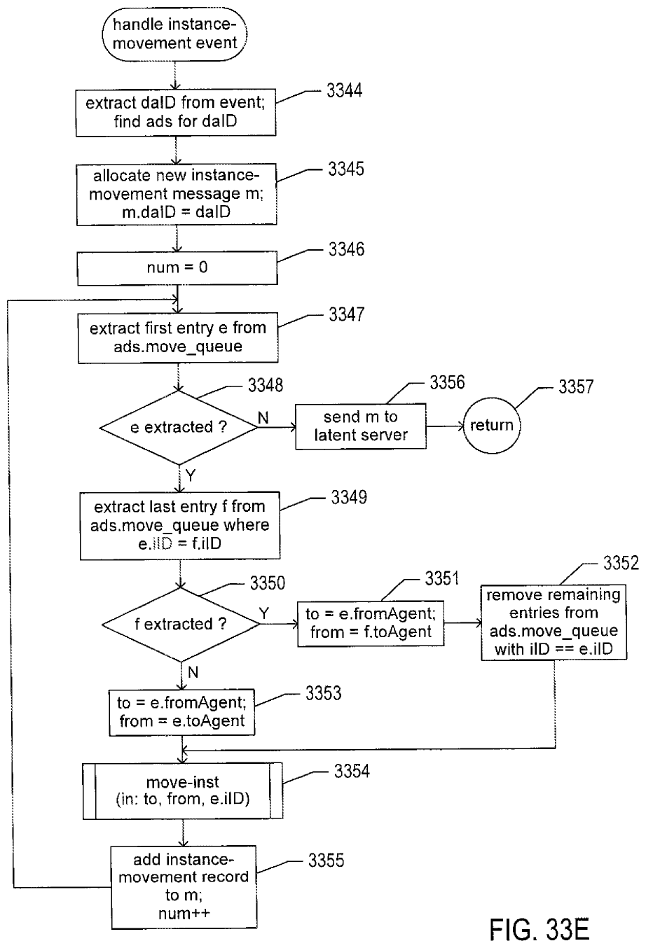

FIGS. 33A-E provide control-flow diagrams that illustrate one implementation of the agent supervisor and operation of the agent supervisor. FIG. 33A illustrates an agent-supervisor event-handling loop that underlies one implementation of the agent supervisor. The agent-supervisor event-handling loop shown in FIG. 33A is similar to the latent-server event-handling loop, shown in FIG. 31A. As with the latent-server event-handling loop, only a few example events and corresponding handlers are shown in FIG. 33A, with ellipsis 3302 indicating that many additional types of events may be handled by the agent supervisor, depending on the particular implementation. When the agent supervisor receives a new-application message, as determined in step 3304, a corresponding handler “handle new app” is called in step 3305. When the agent supervisor receives an instance-move message from an agent, as determined in step 3306, a corresponding handler “handle instance movement” is called in step 3307. When the agent supervisor detects occurrence of an instance-movement event generated by the latent server. in step 3144 of FIG. 31C, as determined in step 3308. the handler “handle instance-movement event” is called, in step 3309. The agent-supervisor API provides many types of services and functionality that, when called, result in many additional types of messages handled by the agent-supervisor event loop, including support for scale-up and scale-down management operations and various types of failure-detection and failure-amelioration events.

FIG. 33B provides a control-flow diagram for the handler “handle new app,” called in step 3305 of FIG. 33A. In step 3312, a new-application message m is received through the agent-supervisor API. In step 3313, a new application data structure ads is allocated, application information contained in message m is extracted from the message and added to ads, and a new unique distributed-application ID is created and added to ads. In step 3314, the routine “handle new app” allocates a new initial-deployment message idm, extracts application metadata from message m and adds the extracted application metadata to idm, and adds the distributed-application ID to idm. In step 3315, the routine “handle new app” attempts to extract a next distributed-application-instance-type descriptor d from message m. When a next descriptor d is successfully extracted, as determined in step 3316, control continues to the for-loop of steps 3317-3324. The for-loop of steps 3317-3324 instantiates d.num instances of the distributed-application-instance-type described in descriptor d. In step 3318, a new instance identifier is created for the next instance. In step 3319, the routine “handle new app” finds a host computational resource rds to host the next instance. This determination is made by matching initial know ledge of the parameters, constraints, and requirements associated with the next instance and those associated with each available computational resource. In certain cases, a candidate host may be immediately rejected when the match score falls below a threshold value, as when one or more characteristics of the candidate host represent anti-affinity characteristics with respect to the instance for which a host is sought. When a description of rds has not yet been added to the message idm, as determined in step 3320, a server descriptor describing rds is created and added to the message idm, in step 3321. In step 3322, the new instance is deployed for execution by the selected computational resource rds. When the loop variable c is less than d.num, as determined in step 3323, the loop variable c is incremented, in step 3324, and control returns to step 3318 for a next iteration of the for-loop of steps 3317-3324. Otherwise, control returns to step 3315, in which the routine “handle new app” attempts to extract another distributed-application-instance-type descriptor from message m. When no further distributed-application-instance-type descriptors can be extracted from message m, the message idm is sent to the latent server, in step 3325, and the routine “handle new app” terminates in step 3326.

FIG. 33C provides a control-flow diagram for the handler “deploy,” called in step 3322 of FIG. 3313. In step 3330, the routine “deploy” receives a distributed-application-instance-type descriptor d, a distributed-application identifier, a computational-resource data structure rds, a reference to an initial-deployment message idm, and a new instance identifier newID. In step 3331, the routine “deploy” allocates a new host message h. In step 3332, the routine “deploy” enters information with regard to the new instance into host message h and, in step 3333, sends the host message to the agent installed within the computational resource described by rds. Finally, in step 3334, the routine “deploy” adds a descriptor for the new instance to the initial-deployment message idm.

FIG. 33D provides a control-flow diagram for the handler “handle instance move,” called in step 3307 of FIG. 33A. In step 3338, the routine “handle instance move” receives an instance-move message m from an agent. In step 3339, the routine “handle instance move” extracts a distributed-application identifier from message m and uses the identifier to access a distributed-application data structure ads maintained for the distributed application by the agent supervisor. Finally, in step 3340, the routine “handle instance move” queues an entry to a move queue within, or referenced by, ads, which stores indications of all of the instance moves for the distributed application represented by ads that need to be carried out at a next point in time indicated by an instance-movement event. In step 3341, the routine “handle instance move” determines whether or not the time has come for stored instance moves for the distributed application to be carried out. When this is the case, an instance-movement event is generated in step 3342. This determination is shown as being made by the agent supervisor, in the currently described implementation. However, this determination may, in alternative implementations, be made collectively by agents, by a subset of agents, or by either agents or a subset of agents cooperating with the agent supervisor and/or latent server. For example, the reward history for the distributed application may be carried out to determine whether or not an appropriate point has been reached to physically relocate instances between agents that have been successfully evicted and accepted. Thus, successful evictions are not immediately carried out, since it is often the case that a given distributed-application instance may be evicted and accepted multiple times in a short period before reaching a next stable hosting, and since physical movement of instances from one computational resource to another can be somewhat computationally expensive, it is desirable to physically move instances only at selected points in time.

FIG. 33E provides a control-flow diagram for the handler “handle instance-movement event,” called in step 3309 of FIG. 33A. In step 3344, the routine “handle instance-movement event” obtains the distributed-application identifier associated with the event and identifies the ads describing the distributed application identified by the extracted distributed-application identifier. In step 3345, the routine “handle instance-movement event” allocates a new instance-movement message m and enters the distributed-application identifier into the new message m. In step 3346, local variable nuns is set to 0. In step 3347, the routine “handle instance-movement event” attempts to extract a next first entry e from the move queue within, or referenced by, ads. If a first entry is successfully extracted, as determined in step 3348, then, in step 3349, the routine “handle instance-movement event” attempts to extract the last entry f from the move queue, where the last entry is the final entry in the move queue that contains an instance identifier equal to the instance identifier contained in the most recently extracted first entry e. When a last entry is successfully extracted, as determined in step 3350, the routine “handle instance-movement event” sets local variable to to the source agent for the instance move included in the first entry e and the local variable from to the destination agent in the last entry f, in step 3351, and removes any intervening entries in the move queue that also include indications of the instance identifier contained in entry e, in step 3352. Otherwise, in step 3353, the local variables to and from are set to the source and destination agent encoded in the extracted entry e. In other words, each iteration of the loop of steps 3347-3355 removes a next sequence of one or more moves for a particular instance. In step 3354, the routine “handle instance-movement event” carries out the transfer of the instance identified by the instance identifier in moved-queue entry e from the source agent to the destination agent. Then, in step 3355, an instance-movement record is added to instance-movement message m for the instance move carried out in the preceding step and the local variable num is incremented. Control then returns to step 3347, where the routine “handle instance-movement event” attempts to extract another first entry from the move queue within, or referenced by, ads. When the attempt to extract an entry fails, then the instance-movement message m is updated, using the local variable num, and then sent to the latent server in step 3356. The routine “handle instance-movement event” terminates, in step 3357.

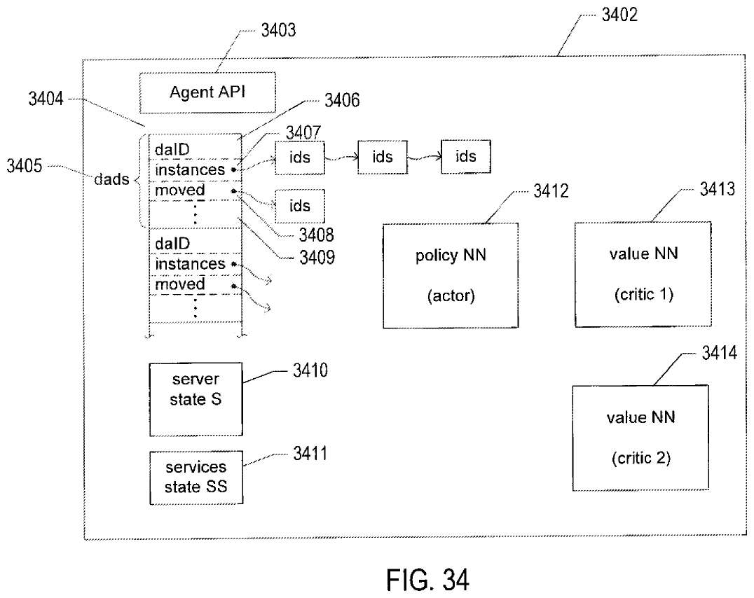

FIG. 34 illustrates certain of the components of an agent. An agent 3402 includes support for an agent API 3403 and a data structure daQ 3404 that contains distributed-application data structures dads, such as dads 3405, each dads including a distributed-application-identifier field 3406, a reference 3407 to a list of instance identifiers ids representing instances resident within the computational resource associated with the agent and currently managed by the agent, a reference 3408 to a list of instance identifiers corresponding to instances that have been evicted from the computational resource associated with the agent but not yet physically transferred by the agent supervisor to another computational resource. and additional fields 3409, including a reference to a current reinforcement-learning reward-generation functions for the distributed application represented by the dads. In addition, an agent maintains a server state S 3410, a services state SS 3411, a logistic-regression neural network 3412 that represents the actor policy for the agent, and two linear-regression neural networks 3413 and 3414 that represents the value functions for a first and second critic. The value function maintained by the first critic is related to the value of a set of distributed-application instances with respect to utilization of the capacities of the computational resource in which they reside and the value function maintained by the second critic is related to the value of a set of distributed-application instances with respect to inter-computational-resource and intra-computational resource communications between distributed-application instances. However, the two value functions may, in alternative implementations, be related to different partitionings of the entire state space and, in additional alternative implementations, different numbers of critics may be used. The server state S includes state information related to the computational resource managed, in part, by the agent. The services state SS includes state information related to the set of current instances managed by the agent. As discussed above, the agents of the currently disclosed distributed-application-instantiation-and-management system are reinforcement-learning-based agents implemented based on the actor/critic reinforcement-learning approach discussed above with reference to FIG. 21.

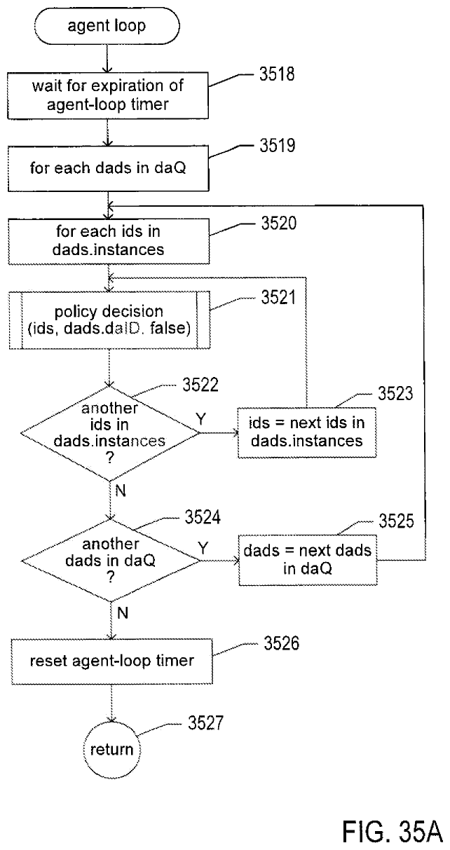

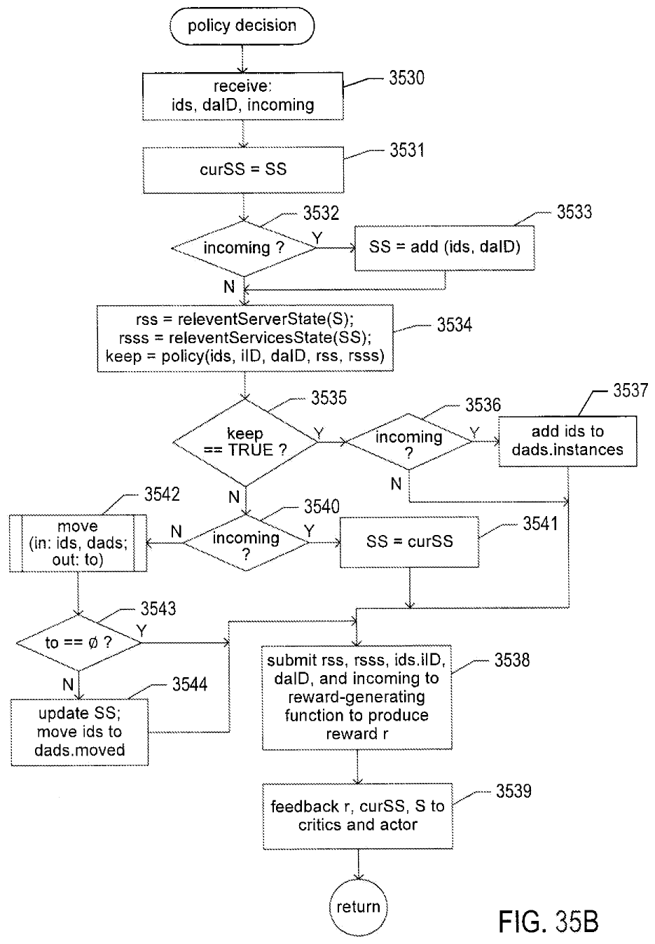

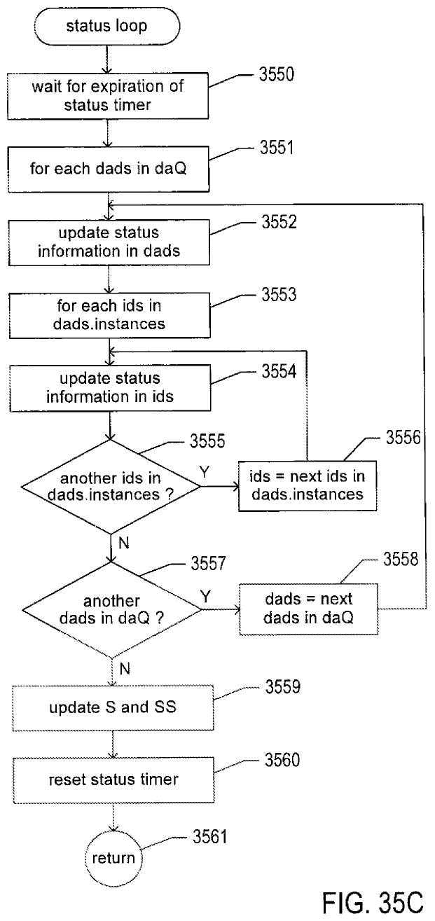

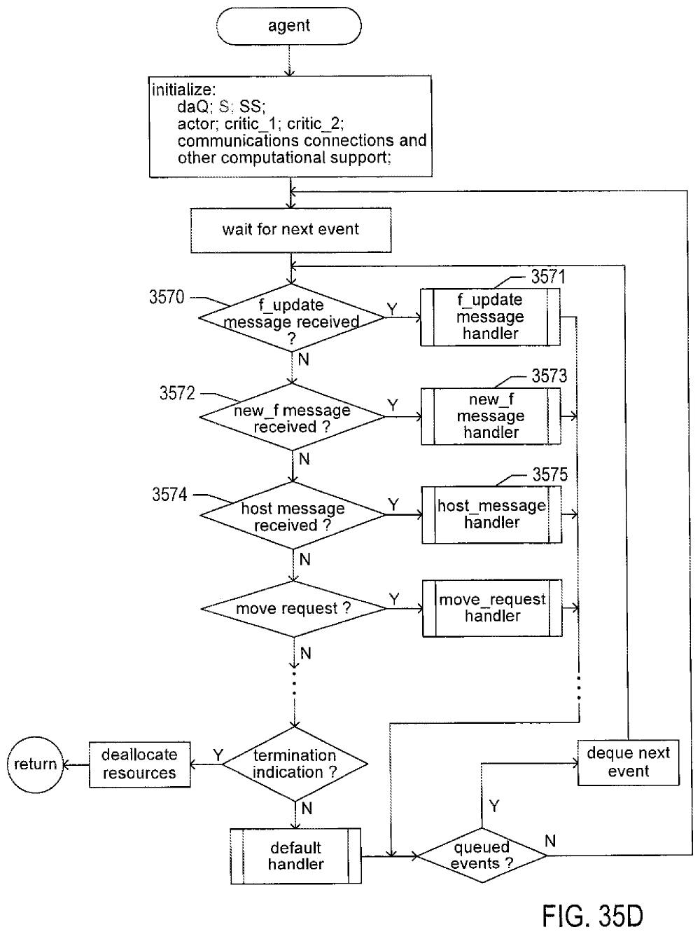

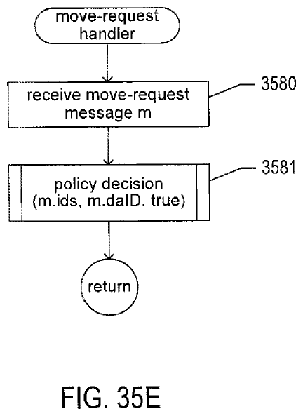

FIGS. 35A-F, provide control-flow diagrams that illustrate the implementation and operation of agents. FIG. 35A provides a control-flow diagram of an asynchronous routine “agent loop,” which implements the reinforcement-learning component of the agent. In step 3518, the routine “agent loop” waits for expiration of an agent-loop timer. When the agent-loop timer expires, then, in the nested for-loops of steps 3519-3525, the routine “agent loop” calls the routine “policy decision,” in step 3521, for each currently managed instance of each currently managed distributed application, traversing the daQ data structure in the outer for-loop of steps 3519-3525 and traversing the instances list referenced from a current dads within the daQ in the inner, for-loop of steps 3520-3523. Following completion of the nested for-loops of steps 3519-3525, the routine “agent loop” resets the agent-loop timer, in step 3526. The routine “agent loop” terminates in step 3527.

FIG. 35B provides a control-flow diagram for the routine “policy decision,” called in step 3521 of FIG. 35A. In step 3530, the routine “policy decision” receives an instance data structure ids, a distributed-application identifier daID, and a Boolean indication that, when TRUE, indicates that the routine “policy decision” is being called from the routine “agent loop,” as discussed above, and that, when FALSE, indicates that the routine “policy decision” is being called from the routine “move-request handler,” discussed below. In step 3531, the routine “policy decision” sets a local variable curSS to the value of the services state SS maintained by the agent (3411 and FIG. 34). When the routine “policy decision” is being called by the routine “move-request handler,” as determined in step 3532, the routine “policy decision” adds information about the instance represented by ids to the services state SS maintained by the agent, in step 3533. In step 3534, the routine “policy decision” extracts server-state information relevant to action determination from the server state S and to local variable rss and information relevant to action determination from the services state SS into local variable rsss and then supplies this information, along with the received ids and distributed-application identifier, as input to the policy neural network (3412 in FIG. 34). In one implementation, the policy neural network returns a Boolean indication, stored in local variable keep, indicating whether or not the instance represented by ids should be retained, or kept, by the agent or, instead, evicted by the agent from the computational resource managed, in part, by the agent. In other implementations, the policy neural network can be thought of as generating, for currently resident instances, one of the two values {keep, evict} and, for instances proposed for acceptance, one of the two values {accept, reject}. When the value in local variable keep is TRUE, as determined in step 3535, and when the routine “policy decision” was called by the routine “move-request handler,” as determined in step 3536, the received ids is added to the instances list within, or referenced by, the currently considered distributed-application data structure in step 3537. This represents accepting a request, from another agent, to assume responsibility for an instance that the other agent wishes to evict. Control then flows to step 3538, as it does when it is determined that the routine “policy decision” was called by the routine “agent loop,” in step 3536. In step 3538, the routine “policy decision” submits input information to the locally store reinforcement-learning reward-generation function, which produces a reward r. Then, in step 3539, the reward r is fed back to the critics and actor, or, in other words, to the three neural networks, along with the services state information contained in the local variable curSS and the services state SS (3411 in FIG. 34). When the value in local variable keep is FALSE, as determined in step 3535, and when the input value incoming is TRUE, as determined in step 3540, the services state SS is set to the contents of curSS, in step 3541, and control flows to step 3538, discussed above. When the input value incoming is FALSE, as determined in step 3540, a routine “move” is called, in step 3542, to query each of a set of other agents as to whether or not the agent would wish to have the instance represented by ids transferred the agent. Depending on the implementation, the routine “move” continues to request a transfer of the instance to other agents until the request is accepted, and an identifier for the accepting agent is returned, or up to some threshold number of requests, after which the routine “move” terminates by returning a null output value. When another agent accepts the offer for transfer of the instance, the routine “move” sends an instance-move message to the agent supervisor. When the output value returned by the routine “move” contains an agent identifier, as determined in step 3543, control flows to step 3538, previously discussed above. Otherwise, control flows to step 3544, in which the routine “policy decision” updates the services state SS and moves ids to the moved list in the dads corresponding to the received distributed-application identifier, and then flows to step 3538, previously described.

FIG. 35C provides a control-flow diagram for a routine “status loop,” which runs asynchronously within the agent to update the status information maintained by the agent. In step 3550, the routine “status loop” waits for expiration of a status timer. When the status timer expires, control flows to the nested for-loops of steps 3551-3558. The outer for-loop of steps 3551-3558 considers each dads in the daQ data structure. In step 3552, the routine “status loop” accesses the computational resource and other sources of information to update the currently considered dads. Then, in the inner for-loop of steps 3553-3556, each instance data structure ids in the list dads.instances is processed. In step 3554, the routine “status loop” accesses the computational resource managed by the agent and any other sources of information in order to update the currently considered ids. Following completion of the nested for-loops of steps 3551-3556, the routine “status loop” updates the server status S and the services status SS using information obtained from the computational resource and other information sources, in step 3559. In step 3560, the routine “status loop” resets the status timer before terminating, in step 3561.

FIG. 35D provides a control-flow diagram for a routine “agent,” which is an event loop for the agent similar to the agent-supervisor event loop, shown in FIG. 35A, and the latent server event loop, shown in 31A. Examples of the types of events handled by the agent event loop shown in FIG. 35D. When an f_update message is received by the agent from the latent server, as determined in step 3570, the routine “f_update message handler” is called, in step 3571 to process the received f_update message. This involves collecting the status information requested by the latent server and returning the requested status information in a response message. When a new_f message is received by the agent from the latent server, as determined in step 3572, a routine “new_f message handler” is called in step 3573. This message handler extracts a new feature vector from the new_f message and stores the feature vector as part of the services state S. When the agent receives a host message from another agent, as determined in step 3574, the routine “host-message handler” is called, in step 3575. FIG. 35E provides a control flow diagram for the routine “move-request handler.” In step 3580, the routine “move-request handler” receives the host message m. In step 3581 the routine “move-request handler” calls the routine “policy decision,” to determine whether or not to accept the message, as discussed above with reference to FIG. 35B.

The present invention has been described in terms of particular embodiments, it is not intended that the invention be limited to these embodiments. Modifications within the spirit of the invention will be apparent to those skilled in the art. For example, any of many different implementations of the automated distributed-application instantiation and management system can be obtained by varying various design and implementation parameters, including modular organization, control structures, data structures, hardware, operating system, and virtualization layers, and other such design and implementation parameters. Certain of the functionalities resident within the agent supervisor, latent server. and agents may, in different implementations, reside within other of these entities then the entities described above. In other words, there is some flexibility as to where the functionalities are implemented. These entities may also, in different implementations, store various different types of data structures containing different types of information. However, in general, the latent server is responsible for returning rewards to agents and for maintaining a virtual graph for each distributed application managed by the automated distributed-application instantiation in management system. In addition, the latent server is responsible for generating and distributing feature vectors to the agents. The agent supervisor is primarily responsible for initial instantiation of distributed applications as well as for various types of management operations, such as scaling operations. The agents are responsible for distributed management of instantiated distributed applications, primarily by a reinforcement-learning-based optimization of the set of distributed-application instances managed by each agent.

1. A distributed-application instantiation and management system, within a distributed computer system having multiple computational resources that each are capable of hosting one or more distributed-application instances, the distributed-application instantiation and management system comprising:
an agent supervisor that initially instantiates a distributed application by deploying instances of the distributed application on one or more computational resources selected from the multiple computational resources within the distributed computer system;
multiple reinforcement-learning-based agents, each computational resource that hosts a distributed-application instance of a distributed application that is instantiated and managed by the distributed-application instantiation and management system including one of the multiple reinforcement-learning-based agents, each agent managing a set of distributed-application instances hosted on the computational resource in which the agent resides, the agents learning to exchange distributed applications in order to attempt to locally optimize the sets of distributed-application instances that they manage; and
a latent server that stores, for each instantiated distributed application, a virtual graph that represents a mapping of the instances of the distributed application to computational resources, and that provides reinforcement-learning reward functions to agents.

2. The distributed-application instantiation and management system of claim 1 wherein the multiple reinforcement-learning-based agents manage their sets of distributed-application instances independently from the agent supervisor and latent server for a period of time up to a threshold period of time.

3. The distributed-application instantiation and management system of claim 1
wherein a computational resource provides an execution environment to programs, routines, services, distributed-application instances, and other executables; and
wherein a computational resource may include one or more
physical computer systems, including servers,
virtual computer systems.
virtual machines,
containers, and
virtual appliances.

4. The distributed-application instantiation and management system of claim 1
wherein the agent supervisor is implemented on one or more computational resources; and
wherein the agent supervisor provides an agent-supervisor interface through which the agent supervisor provides multiple instantiation and management services, including
a distributed-application instantiation service,
a distributed-application upscaling service,
a distributed-application downscaling service,
a distributed-application termination service, and
a distributed-application status-reporting service.

5. The distributed-application instantiation and management system of claim 1
wherein the latent server is implemented on one or more computational resources; and
wherein the latent server provides a latent-server interface through which the latent server provides multiple services, including
a reinforcement-learning-reward-function provision service, and
a feature-vector-provision service.

6. The distributed-application instantiation and management system of claim 5 wherein the latent server comprises:
a feature-vector generator;
a reinforcement-learning-reward-function generator; and
stored information, including a virtual graph, for each instantiated distributed application.

7. The distributed-application instantiation and management system of claim 6 wherein the feature-vector generator receives, as input, selected state information with regard to one or more computational resources and a distributed-application instance and returns a feature vector for the distributed-application instance, the feature vector input to a vector-dot-product operation along with a feature vector associated with a different distributed-application instance to generate a scalar indication of the extent of communications connectivity between the distributed-application instance and the different distributed-application instance.

8. The distributed-application instantiation and management system of claim 6 wherein a reward function generated by the reinforcement-learning-reward-function generator receives reward-related state information for one or more computational resources and for a set of distributed-application instances along with an indication of an action taken by the agent and returns a reinforcement-learning reward indicative of how the action has contributed towards achieving a goal encompassed in the reward function.

9. The distributed-application instantiation and management system of claim 6 wherein the virtual graph is a data presentation of a mapping of distributed-application instances to computational resources as well as a mapping of communications connectivity between the distributed-application instances.

10. The distributed-application instantiation and management system of claim 1 wherein each agent is implemented within a computational resource to include:
stored state information for the computational resource;
stored state information for a set of distributed-application instances currently managed by the agent;
a reinforcement-learning actor; and
one or more reinforcement-learning critics.

11. The distributed-application instantiation and management system of claim 10 wherein each reinforcement-learning actor includes a logistic-regression policy neural network that receives selected state information related to a particular distributed-application instance and returns a Boolean indication of whether or not to retain the particular distributed-application instance.

12. The distributed-application instantiation and management system of claim 11 wherein, following an action carried out by the agent in response to receiving a Boolean indication from the logistic-regression policy neural network, the agent receives a policy adjustment from each critic of the one or more reinforcement-learning critics and feeds the adjustment back to the logistic-regression policy neural network in order to adjust a policy encoded in the logistic-regression policy neural network towards an optimal policy.

13. The distributed-application instantiation and management system of claim 10 wherein each agent includes a first linear-regression state-value reinforcement-learning neural network that represents a state-to-value mapping with respect to the set of distributed-application instances currently managed by the agent and the computational resource within which the agent resides, the first linear-regression state-value reinforcement-learning neural network receiving selected state information and a reinforcement learning reward and returning an indication of a value adjustment that is fed back to the first linear-regression state-value reinforcement-learning neural network to improve the state-to-value mapping.

14. The distributed-application instantiation and management system of claim 10 wherein each agent includes a second linear-regression state-value reinforcement-learning neural network that represents a state-to-value mapping with respect to communications between the distributed-application instances in the set of distributed-application instances currently managed by the agent, the second linear-regression state-value reinforcement-learning neural network receiving selected state information and a reinforcement learning reward and returning an indication of a value adjustment that is fed back to the second linear-regression state-value reinforcement-learning neural network to improve the state-to-value mapping.

15. The distributed-application instantiation and management system of claim 10 wherein each critic of the one or more reinforcement-learning critics forwards a policy adjustment determined from the value adjustment to the actor.

16. The distributed-application instantiation and management system of claim 10 wherein each agent continuously evaluates each currently managed distributed-application instance and each proposal to accept a distributed-application from another agent, requesting that the actor provide one of two actions with respect to an evaluated distributed-application instance that include keeping the distributed application instance and evicting the distributed application instance.

17. The distributed-application instantiation and management system of claim 16 wherein, following reception of an action from the actor, the agent carries out the action by:
when the action is evict and the evaluated distributed-application instance has been proposed to the agent for acceptance, rejecting the proposal;
when the action is keep and the evaluated distributed-application instance has been proposed to the agent for acceptance, accepting the proposal;
when the action is evict and the evaluated distributed-application instance is currently being managed by the agent, proposing to transfer the distributed-application instance to other agents;
when the action is keep and the evaluated distributed-application instance is currently being managed by the agent, doing nothing.

18. The distributed-application instantiation and management system of claim 17 wherein, following carrying out an action, the agent
uses the reinforcement-learning reward function to generate a reward; and
forwards the reward and selected state information to each of the one or more critics.

19. A method that attempts to optimize instantiation of a distributed application, the method comprising:
installing, in a distributed computer system having multiple computational resources that each are capable of hosting one or more distributed-application instances, a distributed-application instantiation and management system that includes
an agent supervisor that initially instantiates a distributed application by deploying instances of the distributed application on one or more computational resources selected from the multiple computational resources within the distributed computer system.
multiple reinforcement-learning-based agents, each computational resource that hosts a distributed-application instance of a distributed application instantiated and managed by the distributed-application instantiation and management system including one of the multiple reinforcement-learning-based agents, each agent managing a set of distributed-application instances hosted on the computational resource in which the agent resides, the agents learning to exchange distributed applications in order to attempt to locally optimize the sets of distributed-application instances that they manage, and
a latent server that stores, for each instantiated distributed application, a virtual graph that represents a mapping of the instances of the distributed application to computational resources, and that returns a reinforcement-learning reward function to requesting agents;
invoking an application-instantiation service provided by the distributed-application instantiation and management system through a distributed-application-instantiation-and-management system application programming interface and
exchanging, by agents, distributed-application instances while learning computational-resource management policies in order to optimally or near-optimally map distributed-application instances to computational resources.

20. A physical data-storage device encoded with computer instructions that, when executed by computational resources of a distributed computer system that provide execution environments for components of a distributed-application instantiation and management system, control the computational resources to:
install the distributed-application instantiation and management system that includes
an agent supervisor that initially instantiates a distributed application by deploying instances of the distributed application on one or more computational resources selected from the multiple computational resources within the distributed computer system,
multiple reinforcement-learning-based agents, each computational resource that hosts a distributed-application instance of a distributed application instantiated and managed by the distributed-application instantiation and management system including one of the multiple reinforcement-learning-based agents, each agent managing a set of distributed-application instances hosted on the computational resource in which the agent resides, the agents learning to exchange distributed applications in order to attempt to locally optimize the sets of distributed-application instances that they manage, and
a latent server that stores, for each instantiated distributed application, a virtual graph that represents a mapping of the instances of the distributed application to computational resources and that returns a reinforcement-learning reward function to requesting agents;
initially instantiate, by the distributed-application instantiation and management system, a distributed application; and
optimally or near-optimally map distributed-application instances to computational resources by agents of the distributed-application instantiation and management system by exchanging distributed-application instances while learning computational-resource management policies.
